(19) United States
(12) Patent Application Publication
(10) Pub. No.: US 2024/0019174 A1
(43) Pub. Date: Jan. 18, 2024

(54) ELECTRONIC SWITCH SYSTEM FOR A WATER HEATER

(71) Applicant: Bradford White Corporation, Ambler, PA (US)

(72) Inventors: Bruce Hill, Middleville, MI (US); John T. Adams, Clayton, MO (US); Mehran Seyed Ahmadi, Holt, MI (US)

(73) Assignee: Bradford White Corporation, Ambler, PA (US)

(21) Appl. No.: 18/036,832

(22) PCT Filed: Nov. 12, 2021
(86) PCT No.: PCT/US2021/059202

§ 371 Date: May 12, 2023

Related U.S. Application Data
(60) Provisional application No. 63/113,500, filed on Nov. 13, 2020.

(51) Int. Cl. F24H 15/225; F24H 1/20; F24H 15/176

(52) U.S. Cl. CPC F24H 15/225; F24H 1/202; F24H 15/176

(57) ABSTRACT

A water heater including a tank having a wall with an external surface and an internal surface defining an interior, and a circuit board mounted to the external surface of the tank. The circuit board including a thermal path for conducting heat through the circuit board, where the thermal path of the circuit board is thermally coupled to the external surface of the tank. An electronic switch is mounted to the circuit board and electronically coupled to a heating element, where the electronic switch is thermally coupled to the thermal path of the circuit board so that heat generated by the electronic switch is transferred along the thermal path. A temperature sensor is thermally coupled to the circuit board to sense a temperature of the thermal path relating to a temperature of the electronic switch and relating to a temperature of water stored in the tank.

### CROSS REFERENCE TO RELATED APPLICATION

This application claims benefit of priority from U.S. Provisional Application No. 63/113,500, filed Nov. 13, 2020. The content of this application is incorporated herein by reference in its entirety and for all purposes.

### FIELD OF THE INVENTION

This disclosure relates to an electronic switch system, such as a solid-state switch system, for controlling the operation of resistive heating elements of water heaters.

### BACKGROUND OF THE INVENTION

Conventional commercial and residential electric water heaters include resistive heating elements solely controlled using mechanical switches referred to as snap-disc thermostats. These snap-disc thermostats include a bimetallic disc that snaps between a convex and concave shape in response to thermal expansion and contraction. The convex and concave shapes of the disc mechanically switch on and off the electrical power delivered to the resistive heating elements of a water heater, thereby controlling the temperature of water within the water heater tank.

These conventional mechanical switches, however, can be limited in their control of water heaters. Once such limitation is that snap-disc thermostats are binary. That is they turn the heating elements 100% ON or 100% OFF, because they cannot modulate the power to the electric heating elements. Another limitation is that snap-disc thermostats must be manually adjusted to a desired set-point temperature.

### SUMMARY OF THE INVENTION

The following description is directed to a water heater. The water heater includes a tank configured to store water to be heated. The tank includes a wall defining an interior. The water heater also includes a circuit board mounted to the wall of the tank. The circuit board includes a thermal path for conducting heat through the circuit board. The thermal path of the circuit board is thermally coupled to the wall of the tank such that primary heat from the water in the tank is transferred from the wall of the tank to the thermal path. The water heater also includes a heating element mounted to the wall of the tank and extending into the interior of the tank. An electronic switch is mounted to the circuit board and electronically coupled to the heating element. The electronic switch is also thermally coupled to the thermal path of the circuit board such that secondary heat generated by the electronic switch is transferred from the electronic switch to the thermal path and such that the secondary heat is transferred along the thermal path from the electronic switch, through the thermal path of the circuit board, and to the wall of the tank. The water heater also includes a temperature sensor thermally coupled to the thermal path of the circuit board. The temperature sensor is positioned to sense a temperature of the thermal path including the primary heat and the secondary heat. The water heater also includes a controller electronically coupled to the temperature sensor. The controller is configured to receive the temperature of the thermal path from the temperature sensor and to differentiate the secondary heat from the primary heat.

The use of one or more electronic switches and the differentiation of the secondary heat allows the controller to perform algorithms to accurately control the water heater performance and to perform diagnostic algorithms on water heater components. These algorithms include, but are not limited to, machine learning to determine and refine the secondary heat over the life of the water heater, dry-fire detection; quick, efficient and accurate recovery of a tank to set-point after a draw; power scaling the power applied to the heating element; detecting and correcting for convection stirring; ensuring non-simultaneous switch operation; switch protection; faulty switch detection; faulty heating element detection; and faulty thermal path detection.

### BRIEF DESCRIPTION OF THE DRAWINGS

The drawing figures depict one or more implementations, by way of example only, not by way of limitation. In the figures, like reference numerals refer to the same or similar elements.

FIG. 1A is a perspective view of an embodiment of a water heater with a solid-state switch control system, according to an aspect of the disclosure.

FIG. 1B is a perspective view of the water heater in FIG. 1A without the outer shell, according to an aspect of the disclosure.

FIG. 2A is a perspective view of the upper control assembly in FIG. 1B, according to an aspect of the disclosure.

FIG. 2B is a perspective view of the upper control assembly in FIG. 2A without the protective cover, according to an aspect of the disclosure.

FIG. 2C is another perspective view of the upper control assembly in FIG. 2B, according to an aspect of the disclosure.

FIG. 3A is an isolated perspective view of the lower control assembly, according to an aspect of the disclosure.

FIG. 3B is another isolated perspective view of the lower control assembly in FIG. 3A, according to an aspect of the disclosure.

FIG. 4A is a perspective view of a protective housing of the lower control assembly, according to an aspect of the disclosure.

FIG. 4B is another perspective view of the protective housing in FIG. 4A, according to an aspect of the disclosure.

FIG. 4C is yet another perspective view of the protective housing in FIG. 4A, according to an aspect of the disclosure.

FIG. 5A is an isolated perspective view of a spring clip for securing the protective housing in FIG. 4A to the water heater, according to an aspect of the disclosure.

FIG. 5B is another isolated perspective view of the spring clip in FIG. 5A, according to an aspect of the disclosure.

FIG. 5C is an isolated side view of the spring clip in FIG. 5A, according to an aspect of the disclosure.

FIG. 5D is yet another isolated perspective view of the spring clip in FIG. 5A, according to an aspect of the disclosure.

FIG. 6 is a schematic side view of the lower portion of the water heater showing an embodiment of a thermal path, according to an aspect of the disclosure.

FIG. 7 is a flowchart of an embodiment of the thermal coupling procedure of the power switching module, according to an aspect of the disclosure.

FIG. 8 is a circuit diagram of an embodiment of the overall water heater control system, according to an aspect of the disclosure.

FIG. 9 is a flowchart of the overall operation of the water heater, according to an aspect of the disclosure.

FIG. 10 is a flowchart of a dry-fire procedure, according to an aspect of the disclosure.

FIG. 11A is a time/temp plot of the dry-fire procedure, according to an aspect of the disclosure.

FIG. 11B is another time/temp plot of the dry-fire procedure of FIG. 10, according to an aspect of the disclosure.

FIG. 12A is a flowchart of a procedure for determining secondary heat contributions to the LTS reading, according to an aspect of the disclosure.

FIG. 12B is time/temp plot of determining secondary heat, according to an aspect of the disclosure.

FIG. 13A is a flowchart of a process for full recovery, according to an aspect of the disclosure.

FIG. 13B is a flowchart of another process for full recovery, according to an aspect of the disclosure.

FIG. 13C is a time/temp plot of full recovery from a shallow draw, according to an aspect of the disclosure.

FIG. 13D is a time/temp plot of full recovery from a deep draw, according to an aspect of the disclosure.

FIG. 14A is flowchart for detecting convection stirring, according to an aspect of the disclosure.

FIG. 14B is a cycler solution relating to control of convection stirring, according to an aspect of the disclosure.

FIG. 14C is a flowchart for power scaling, according to an aspect of the disclosure.

FIG. 15A is a circuit diagram for non-simultaneous switch operation, according to an aspect of the disclosure.

FIG. 15B is a duty cycle plot for non-simultaneous switch operation, according to an aspect of the disclosure.

FIG. 15C are flowcharts for non-simultaneous switch operation, according to an aspect of the disclosure.

FIG. 15D is a flowchart for another non-simultaneous switch operation, according to an aspect of the disclosure.

FIG. 15E is a time/temp plot for non-simultaneous switch operation during a recovery from a shallow draw, according to an aspect of the disclosure.

FIG. 15F is a time/temp plot for non-simultaneous switch operation during a recovery from a deep draw, according to an aspect of the disclosure.

FIG. 16 is a flowchart for machine learning, according to an aspect of the disclosure.

FIG. 17 is a flowchart for switch protection, according to an aspect of the disclosure.

FIG. 18A is a flowchart for detecting faulty heating elements, according to an aspect of the disclosure.

FIG. 18B is a time/temp plot relating to detecting faulty heating elements, according to an aspect of the disclosure.

FIG. 19 is a flowchart for detecting one or more faulty switches, according to an aspect of the disclosure.

FIG. 20A is a flowchart for detecting a faulty thermal path or electrical connections, according to an aspect of the disclosure.

FIG. 20B is time/temp plot relating to detecting a faulty thermal path or electrical connections, according to an aspect of the disclosure.

### DETAILED DESCRIPTION OF EMBODIMENTS OF THE INVENTION

Water heaters controlled solely by conventional snap-discs lack the ability to: 1) modulate the power to the resistive heating elements during a heating cycle, 2) determine diagnostic information for identifying faulty devices, and 3) deliver this information to the water heater owner, manager, or maintainer.

Electronic switches, such as solid-state switches, offer a solution for achieving this functionality. However, solid-state components presents multiple challenges. First and foremost, solid-state components such as power switches can generate significant heat. A water heater thereby should manage the heat generated by its solid-state components.

One solution is to attempt to do this by installing heat sinks on the solid-state components, such as by mounting an electronic switch to a heat sink. However, heat sinks are often large by design to maximize their surface area to improve heat dissipation. This can make the profile of an attached water heater bulkier. This puts any solid-state components attached to the heat sink at increased risk of damage, as they are relatively far from the center of mass of the water heater, and exposed. These digital components are therefore unduly exposed to shock damage, such as that caused by installers installing the water heater. Heat sinks are also expensive, and water heaters as a consumer good exist in a market with low margins, with many customers being extremely price sensitive; therefore, any increased cost to a water heater should be scrutinized.

The change from sole snap-disc control to solid-state control, however, can be seen to have some disadvantages. First, monetary expenses are increased: tasks that used to be achieved by a simple snap-disc thermostat, are achieved instead by solid-state temperature sensors, solid-state switches and a microprocessor. These costs can either be prohibitively expensive, or they can merely increase the cost of the entire water heater enough to dissuade consumers. Therefore, many water heater providers have generally avoided the costs associated with solid-state control systems.

Second, simpler snap-disc thermostat control systems are well-understood and trusted in the industry. For example, safety certification companies such as Underwriters Laboratory (UL) can be hesitant to certify systems that depart from conventional technologies. Water heaters that are not safety certified are all but impossible to sell, and atypical safety certifications can take a long time to be granted, and can be expensive.

One aim of the present disclosure is to implement the solid-state control of an electric water heater while addressing the complexities associates with such an implementation. Although specific examples are described throughout the disclosure, it is noted here that the disclosure is not limited to these specific examples.

Referring generally to the figures, and according to a first aspect of the disclosure, a water heater 100 is provided including a tank 108 configured to store water to be heated, the tank 108 having a wall with an external surface and an internal surface defining an interior. The water heater 100 also includes a circuit board 402 mounted to the external surface of the tank 108, the circuit board 402 including a thermal path for conducting heat through the circuit board 402, the thermal path of the circuit board 402 being thermally coupled to the external surface of the tank 108. A lower heating element 400 is mounted to the wall of the tank 108 and extends into the interior of the tank 108. It is noted that lower heating element 400 can be embodied in a high temperature resistive wire, which produces heat when electricity passes through the wire. This heat then is transferred to the water through conduction and convection, by having the wire, coated in electrical insulation, enclosed in water tank 108 and immersed in the water (not shown). An electronic switch 816/818 is mounted to the circuit board 402 and electronically coupled to lower heating element 400, the electronic switch 816/818 being thermally coupled to the thermal path of the circuit board 402 so that heat generated by the electronic switch 816/818 is transferred along the thermal path from the electronic switch 816/818, through the thermal path of the circuit board 402, and to the wall of the tank 108. A temperature sensor 606 is mounted to the circuit board 402, wherein the temperature sensor 606 is positioned to sense a temperature of the thermal path relating to a temperature of the electronic switch 816/818 and relating to a temperature of water stored in the tank 108.

According to an embodiment of the water heater 100, the circuit board 402 can be a thermally conductive circuit board 402 releasably mounted to the external surface of the tank 108. The water heater 100 can include a biased retainer positioned to releasably mount the circuit board 402 to the external surface of the tank 108. The water heater 100 can include plural heating elements 218/400 and plural electronic switches 816/818, where each of the electronic switches 816/818 is electronically coupled to a respective one of the heating elements 218/400, one of the heating elements 218 being mounted to an upper portion of the wall of the tank 108, and another one of the heating elements 400 being mounted to a lower portion of the wall of the tank 108.

The water heater 100 can also include a controller 820 electrically coupled to the electronic switch 816/818 and the temperature sensor 606, the controller being configured to control the electronic switch 816/818 based on temperature signals received from the temperature sensor 606. The temperature signals received from the temperature sensor 606 can correspond to a sensed temperature of the thermal path, and the temperature signals received from the temperature sensor 606 can correspond to a sensed temperature of the electronic switch 816/818. The water heater 100 can also include a second temperature sensor 610 thermally coupled to the wall of the tank 108 and configured to sense a temperature corresponding to a temperature of the wall of the tank 108 and relating to a temperature of water stored in the tank 108.

The temperature sensor 606 can be mounted to the circuit board 402, thermally coupled to the electronic switch 816/818, and configured to sense a temperature corresponding to a temperature of the electronic switch 816/818. Also, the temperature sensor 606 can be a dual purpose temperature sensor 606 thermally coupled to the wall of the tank 108 to sense a temperature corresponding to a temperature of the wall of the tank 108 and relating to a temperature of water stored in the tank 108, and thermally coupled to the electronic switch 816/818 to sense a temperature corresponding to a temperature of the electronic switch 816/818.

The circuit board 402 can include a thermally conductive support layer, a circuit layer, and a dielectric layer interposed between the thermally conductive support layer and the circuit layer. The thermal path of the circuit board 402 can extend through the thermally conductive support layer, the circuit layer, and the dielectric layer.

A thermal interface can be provided between the circuit board 402 and the wall of the tank 108 to maintain thermal coupling between thermal path of the circuit board 402 and the wall of the tank 108. The thermal interface being selected from the group consisting of thermal grease, heat paste, thermal gel, thermal tape, thermal putty, thermal gap filler, thermal polymer, and thermal adhesive.

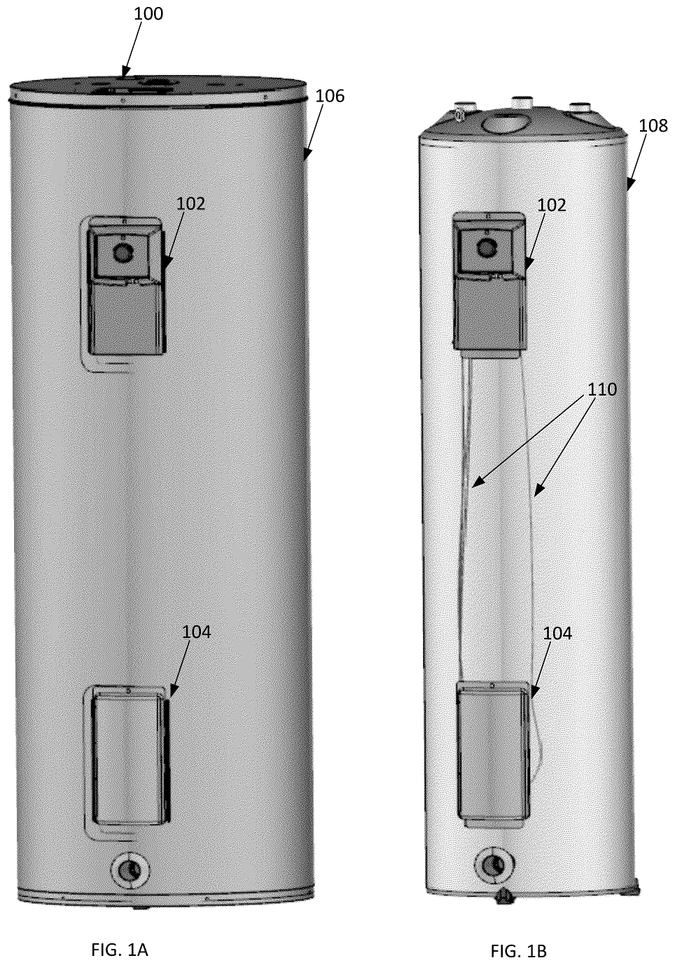

Referring now to specific figures illustrating various embodiments of the disclosure relating to exemplary structural features of a water heater, FIGS. 1A and 1B show water heater 100 with solid-state controls that are described in detail below. Referring to FIG. 1A, water heater 100 generally includes heater shell including a jacket 106, an upper cover 102, and a lower cover 104. Jacket 106 is generally filled with insulation (e.g. fiberglass, foam, etc.) that forms an insulating layer around the interior contents (e.g. the tank) of the water heater, primarily keeping heat inside water heater 100, as well as protecting these interior components from kinetic shocks. To complete the insulation effect, two covers, an upper cover 102 and a lower cover 104, are placed over cut-outs cut in water heater jacket 106. These cut-outs exist to expose control components, to facilitate use and configuration of water heater 100, as well as to increase efficiency in performing maintenance on water heater 100.

FIG. 1B shows water heater 100 in FIG. 1A without jacket 106. Specifically, water tank 108 and wiring harness 110 are exposed. Water tank 108 is a metallic tank that holds the water to be heated. Wiring harness 110 may include various stranded or solid wires that interconnect electrical components from an upper control assembly (not shown in this view), a lower control assembly (not shown in this view), an upper heating element (not shown in this view), and a lower heating element (not shown in this view). Details of these electrical connections are described in more detail with respect to later figures. Water tank 108 can be figuratively divided into an upper half and a lower half. This is because water heater 100 has two heating elements (not shown in this view) referred to as an upper heating element (UE) and a lower heating element (LE), which are located in the upper half of the tank in the region of upper cover 102, and the lower half of the tank in the region of lower cover 104, respectively. Details of the upper control assembly, the lower control assembly, the UE and the LE are now described with reference to the figures.

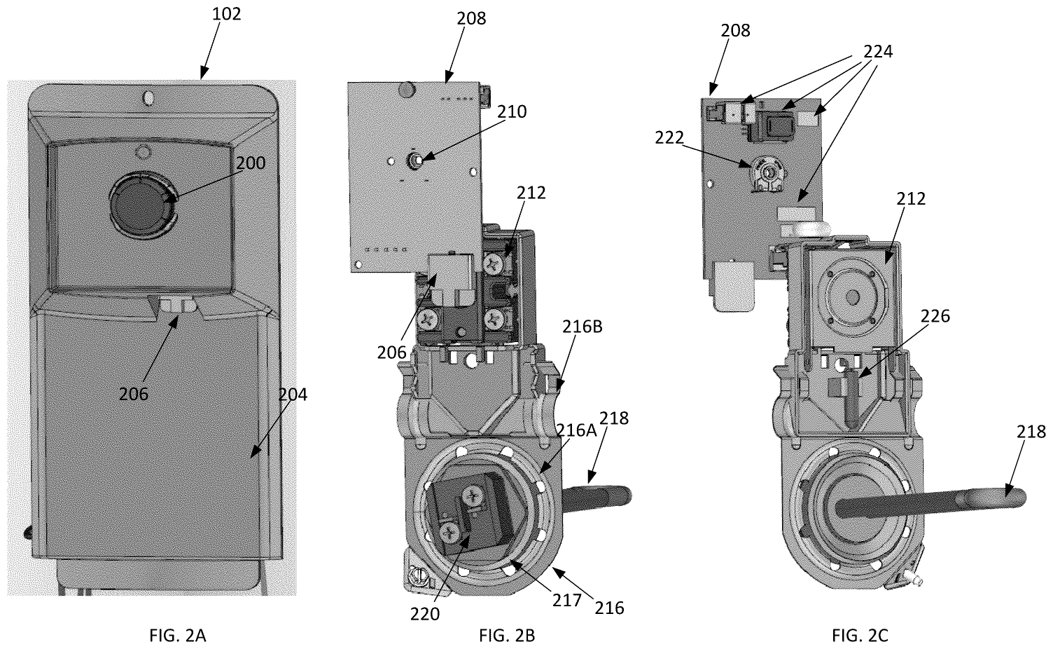

Regarding exemplary features of an upper control assembly of a water heater, FIGS. 2A-2C depict upper cover 102, as well as the components of the upper control assembly located beneath the upper cover 102. In FIG. 2A, for example, upper cover 102 includes set-point temperature knob 200 for setting the desired set-point (SP) temperature of the water. In addition to the knob, upper cover 102 may include a flat mounting portion 204 for mounting a communication transceiver (not shown) to link water heater 100 to remote computers/servers (not shown) and to other water heaters (not shown). In one example, the communication receiver would mount to mounting portion 204 and be plugged into data port 206 to actively communicate with the controller (e.g. processor) of water heater 100.

In FIG. 2B, upper cover 102 has been removed, thereby exposing the mechanical and electrical components of the upper control assembly hidden beneath. These components include a printed circuit board (PCB) 208 mounted to cover 102, aperture 210 for receiving knob 200, snap-disc limit switch 212, temperature sensor 226 for measuring upper tank wall temperature, UE 218 with UE electrical terminals 220, and spring clip 216 for mounting limit switch 212 to a spud on water tank 108. In one example, the spud may be a metal cylindrical portion that is formed into the tank wall or welded to the tank wall. The spud may have female treads for receiving and mounting the heating element.

FIG. 2C shows the rear view of the components in FIG. 2B. As is shown, PCB 208 includes various electrical components 224 (e.g. microprocessor, power regulators, analog I/O, digital I/O, etc.) that form the controller for water heater 100. PCB 208 also includes potentiometer 222 for receiving the shaft of knob 200 and outputting a distinct resistance based on knob rotational angle which is then translated by the controller into a desired SP temperature. Each of the components in FIGS. 2B and 2C will now be described in more detail.

The controller on PCB 208 generally detects the desired SP temperature from potentiometer 222, monitors upper temperature sensor (UTS) 226 and lower temperature sensor (LTS) (not shown) in order to control (e.g. modulate) the power applied to UE 218 and the LE (not shown) to regulate the temperature of the water in the tank. Although not shown, UTS 226 (e.g. a thermistor) is thermally coupled to (e.g. physically contacting) the upper wall portion of the water tank 108 in order to detect tank wall temperature. In general, the controller controls solid-state switches in a power switching module (not shown) to modulate the power applied to UE 218 and the LE (not shown) during a heating cycle (typically a time period during which the heating elements are turned ON to heat the water to reach the SP). For example, solid-state switches may be controlled to switch ON/OFF at a certain duty cycle during a heating cycle to vary the power output to the heating elements (e.g. 0%-100% power). Further details of this feature will be described with respect to later figures.

Limit switch 212 shown in FIGS. 2B and 2C is a snap-disc implemented for safety purposes in this embodiment. Although not shown, limit switch 212 is thermally coupled to (e.g. physically contacting) the upper wall of the water tank 108 in order to detect tank wall temperature. Limit switch 212 includes upper line power electrical terminals L1ᵤₚₚₑᵣ and L2ᵤₚₚₑᵣ that receive the line power (e.g. 240 VAC) from a power source (e.g. dual pole circuit breaker in a circuit breaker panel), and lower line power terminals L1_{lower} and L2_{lower} that distribute the line power to a power switch module located in the lower control assembly (not shown) that supplies power to both the UE and LE. When the limit switch “snaps closed,” electricity is free to flow between the L1ᵤₚₚₑᵣ and L1_{lower} terminals, as well as between the L2ᵤₚₚₑᵣ and L2_{lower} terminals. When the limit switch 212 “snaps open,” the connections between L1ᵤₚₚₑᵣ and L1_{lower} and between L2ᵤₚₚₑᵣ and L2_{lower} are broken such that electricity is not distributed to the power switch module. This break occurs when the limit switch 212 detects a tank wall temperature in excess of a predetermined safe operating limit temperature (e.g. factory set temperature) of the water heater.

It is noted that UE 218 can be embodied in a high temperature resistive wire, which produces heat when electricity passes through the wire. This heat then is transferred to the water through conduction and convection, by having the wire, coated in electrical insulation, enclosed in water tank 108 and immersed in the water (not shown).

Spring clip 216 is a mechanism by which limit switch 212 is physically attached to water heater tank 108. In this example, spring clip 216 includes circular mounting portion 216A that is forced onto the outer circumference of spud 217 of the water tank. Spring loaded flanges of circular mounting portion 216A fix to the outer circumference of the spud 217, thereby holding spring clip 216 firmly in place against the upper wall of tank 108. Spring clip 216 also includes spring legs 216B that snap onto and firmly press limit switch 212 against the wall of water heater tank 108. Spud 217 is also used for holding UE 218 in place. Specifically, spud 217 may have female threads, whereas UE 218 may have male threads. During assembly, the UE 218 is threaded into spud 217. A similar mounting procedure is performed with another spud (not shown) and LE 400.

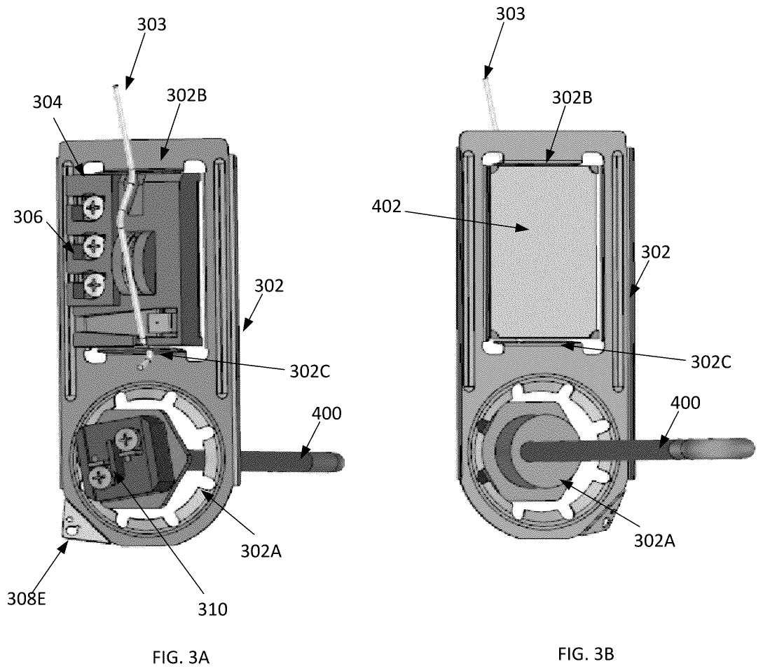

Regarding exemplary features of a lower control assembly of a water heater, FIGS. 3A and 3B show an isolated view (isolated from the water heater) of the lower control assembly components. In these views, it is shown that the water heater includes a LE 400 and a thermally conductive (e.g. metal) power switching circuit board 402. LE 400 performs substantially the same tasks as UE 218, and typically has the same or similar physical configuration. Similar to the UE, LE 400 also can have its power cut by the limit switch 212 if unsafe temperatures are detected by the limit switch 212.

Power switching circuit board 402 is electrically connected to both UE and LE 218 and 400 as well as to limit switch 212. Generally, power switching circuit board 402 is a thermally conductive circuit board (e.g. aluminum) that includes, among others, power switching elements (not shown) and a temperature sensor (not shown). The water heater controller on PCB 208 monitors the detected temperature of the temperature sensor. This temperature is associated with the temperature of at least one of the lower tank wall, the circuit board, the power switching elements and the electrical connections to the power switching module. The controller uses this detected temperature to modulate (e.g. vary duty cycle) and apply the modulated power to the heating elements 218 and 400 during the heating cycle in an attempt to reach the SP temperature, and to detect possible faults in the system (e.g. faulty electrical components, faulty electrical connections, sensor drift, etc.). The electrical and control aspects of the controller, power switching module, heating elements and fault detection are described in more detail with respect to later figures.

Terminals 306 of the power switching module, may be screw terminals for securing wiring that connects lower control assembly components to upper control assembly components. Other connection methods, however, such as welding or fusing are possible, though screw-clamping is preferred in order to preserve the modularity of the components of the water heater 100. In this example, there are three terminals. A first one of the terminals receives a wire from limit switch 212 that feeds L1 to the power switching module. A second one of the terminals receives a wire to feed L1 to the LE. A third one of the terminals receives a wire to feed L1 to the UE.

The lower control assembly components also include power switching module housing 304, which houses a power switching module (not shown) and electrical terminals 306, LE terminals 310 and spring clip base 302 including a circular mounting portion 302A that is forced onto a spud (similar to spud 217 but not shown) of the water tank. Spring loaded flanges of circular mounting portion 302A fix to the outer circumference of the spud, thereby holding spring clip 302 firmly in place against the lower wall of water heater tank 108. Spring clip base 302 also includes brackets 302B and 302C that engage with portions of housing 304 and spring wire 303 that firmly presses housing 304 and a metal power switching circuit board (not shown) against the lower wall of water heater tank 108. A ground screw may also be fixed to ground terminal 308E for mounting a ground wire to spring clip 302.

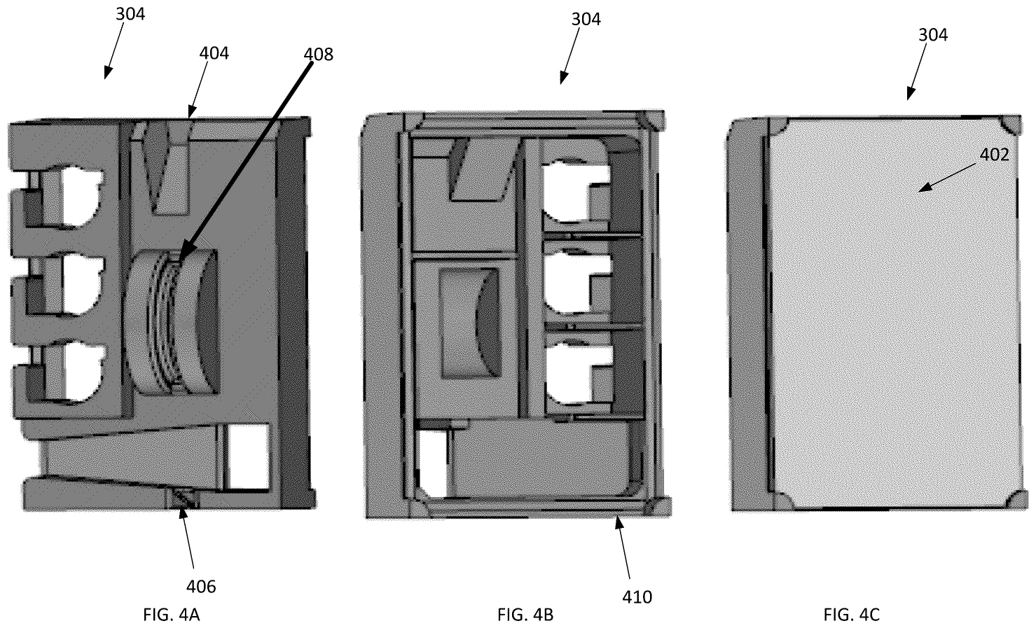

FIGS. 4A-4C show further isolated views of power switch housing 304 and power switching circuit board 402. Shown in these figures are the details of upper section 404, lower section 406 and middle section 408. These sections are the portions of housing 304 that are positioned between brackets 3026/302C of spring clip 302 and engaged by spring wire 303 which is tensioned to hold housing 304 in place. For example, during installation, housing 304 may be inserted between brackets 3026/302C. One end of spring wire 303 is inserted into bracket 302C through lower section 406, and then the other end of spring wire 303 is tensioned, inserted into bracket 302B through upper section 404. The spring tension in spring wire 303 presses against middle section 408 and holds the backside of power switch circuit board 402 flush to the tank wall, thereby completing the thermal path between the power switch electronics and the tank wall. As mentioned above, thermal paste or other thermally conductive material may also be applied to the backside of power switch circuit board 402 to enhance the thermal path.

Also shown in these figures are the details of groove 410. Groove 410 is a groove cut in housing 304 to accept and firmly hold power switch circuit board 402 in place. Generally, groove 410 has a perimeter that is identical to the perimeter of power switch circuit board 402. During assembly, adhesive may be injected into groove 410 and then power switch circuit board 402 is fitted into groove 410. Once the adhesive cures, power switch circuit board 402 is secured in housing 304. Conversely, power switch circuit board 402 may be snapped into the groove 410 without the use of adhesive.

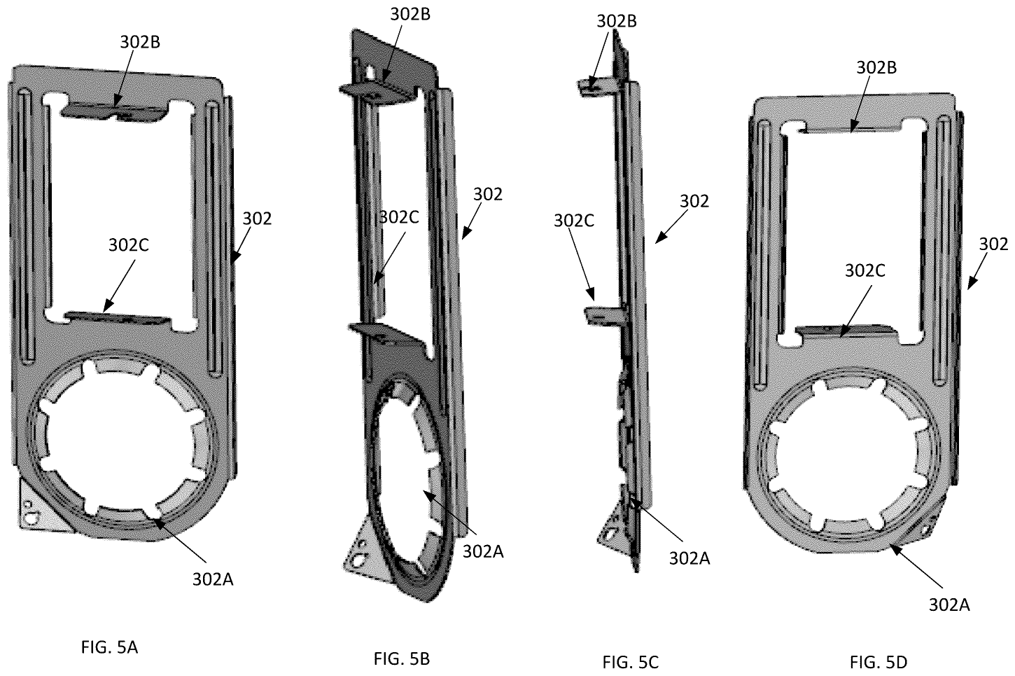

As described above, spring clip 302 secures power switch housing 304 to the tank wall. FIGS. 5A-5D show isolated views of spring clip 302, which includes brackets 3026/302C and circular mounting portion 302A. In order to affix spring clip 302 to the water heater, circular mounting portion 302A is pounded or otherwise forced onto the spud of the water tank. Spring loaded flanges of circular mounting portion 302A fix to the outer circumference of the spud, thereby holding spring clip 302 firmly in place against the wall of water heater tank 108. Due to its stiffness, spring clip 302 remains rigid and resists movement.

Regarding exemplary features of a thermal path, and as described above, power switching circuit board 402 is made of or includes thermally conductive material such as metal. This allows power switching circuit board 402 to conduct heat. Although not shown in FIGS. 3A, 3B, 4A and 4B, power switching circuit board 402 is held firmly to the tank wall by spring clip 303 and optional thermal paste. This creates a thermal bond between the backside of power switching circuit board 402 and the tank wall thereby creating a thermal path that includes or is thermally coupled to the solid-state switches and other electronics of the power switching module, electrical connections, power switching circuit board, the lower tank wall and the water in the tank.

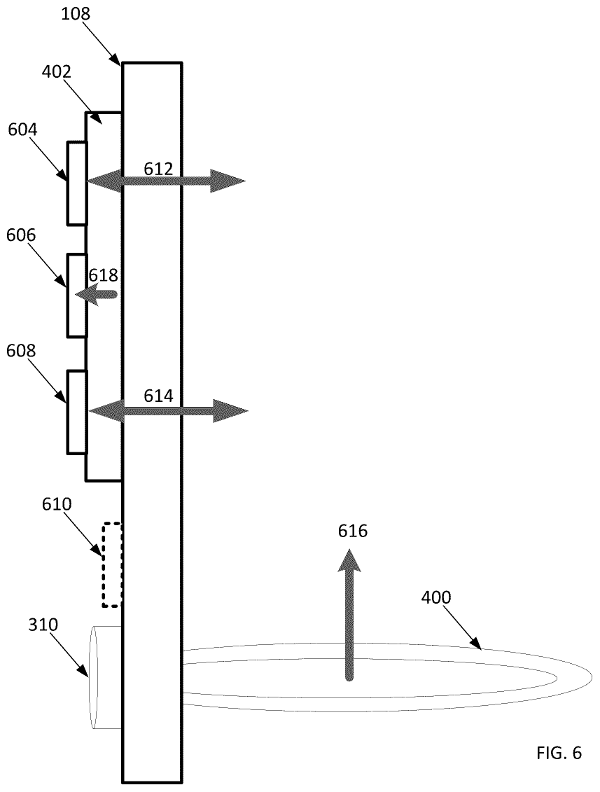

An example, of the thermal path is shown as a side view of the lower portion of the water heater in FIG. 6, where the heat contributions of the various components are bi-directionally conducted through the thermal path. For example, heat 612/614 produced by electronics 604 (e.g. power TRIACS, OPTO-TRIACS, resistors, etc.) and electrical connections 608 (e.g. one or more screw terminals) is conducted through thermally conductive power switching circuit board 402 to tank wall 108 and into the water. Likewise, heat from the water is conducted through the water to tank wall 108, to the thermally conductive power switching circuit board 402 and to the electronics 604 and electrical connections 608. Therefore, the overall heat in the thermal path includes combined heat contributions from various sources. This thermal path is beneficial for increased efficiency by introducing the heat produced by the electronic switches back into the tank, rather than being wasted, and allowing a measurement point for a temperature sensor to accurately measure a single temperature that includes the combined heat of the water and the heat produced by the electronic/electrical components (e.g. switches).

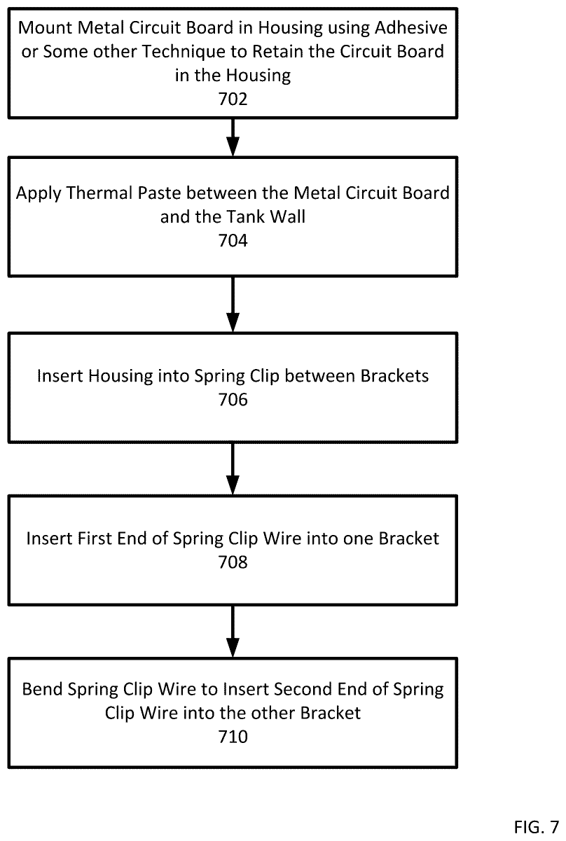

For example, in order to monitor the temperature of the thermal path, LTS 606 is mounted to thermally conductive power switching circuit board 402. The heat absorbed by thermally conductive power switching circuit board 402, and detected by LTS 606 is a sum of the heat contributions of the water and the electronic/electrical components such as electronics 604 (described in more detail with reference to FIGS. 7-10) and electrical connections 608.

In general, the thermal path heat absorbed by thermally conductive power switching circuit board 402 and detected by LTS 606 is then processed by the controller. In one example, the controller processes the detected LTS temperature to determine the temperature (e.g. heat contributions) of the individual components including the temperature of electronics 604, the temperature of circuit board 402, the temperature of electrical connections 608, the temperature of tank wall 108 and the temperature of the water in the tank. This is performed based on experimental and/or theoretical temperature correlations between the detected temperature and the associated temperatures of the individual components. Such a correlation is affected by various factors that include but are not limited to physical layout of the circuit board (e.g. power switch placement, LTS placement, etc.), physical properties of the circuit board (e.g. the type of metal, thickness of metal, type of dielectric, thickness of dielectric, etc.), power rating of the power switches, thermal connection between the circuit board and the tank wall, size of the water tank, and temperature of water in the tank.

In one example, the overall temperature and the rate of change of the temperature may both be analyzed to determine heat contributions of the individual components during cycling ON/OFF of the water heater. Since electronics 604 and electrical connections 608 rapidly heat up and cool off (e.g. short time constant) during cycling ON/OFF of the water heater, and are directly attached to metal circuit board 402, they contribute significantly to the rate of change of the thermal path temperature detected by LTS 606. In contrast, since UE 218 and LE 400 are immersed in the water, the temperature of the water and therefore the temperature of the tank wall remains fairly constant during cycling ON/OFF of the water heater such that the water temperature slowly rises (e.g. long time constant) and contributes significantly to the steady state level of the thermal path temperature. In addition, there may be a known temperature offset between various components. For example, if the temperature sensor 606 detects a temperature Temp 1 during operation of the water heater, the controller may be able to determine the temperature of electronics 604 as Temp 1+TempOffset 1, and determine the temperature of electrical connections 608 as Temp 1+TempOffset 2.

In this way, the controller can distinguish between what is herein referred to as “secondary heat” versus what is herein referred to as the “primary heat” based on conditions such as rate of change of the detected temperature, the steady state level of the detected temperature and temperature offsets. In this context, “primary heat” is heat attributable to the heat absorbed by the water and conducting through the tank wall. It therefore generally corresponds to or relates to the temperature of the water in the tank. In contrast, “secondary heat” is heat attributable to, generated by, or otherwise associated with electrical/electronic components of the water heater, including but not limited to the resistive losses of the power switches (e.g. TRIACS TR1, TR2, TR3, etc.) and electrical connections. For example, secondary heat is produced by resistive losses of electronics 604 and electrical connections 608 when driving the heating elements. This secondary heat conducts through the metal circuit board to the LTS. The secondary heat described above inflates the heat detected by the LTS. In general, when either the LE or UE is driven, LTS Reading=Primary Heat (water heat)+Secondary Heat (Heat Generated by the Electrical/Electronic Components). It is noted that the secondary heat is generally present when the heating elements are being driven. Once the heating elements are shut off, the secondary heat dissipates and the LTS readings are equal to or approach the Primary Heat (water heat).

Secondary heat can generally be determined by a rate of change of the temperature (e.g. how fast/slow the temperature is increasing/decreasing) or by a temperature difference taken between different time points (e.g. Temp1@Time1−Temp2@Time2). The sensed temperature of the thermal path (e.g., the temperature sensed by LTS 606) is the sum of primary heat and secondary heat because the thermal path is thermally coupled, directly or indirectly, to the electronic components of the water heater and to the tank wall, which will have a temperature corresponding to or relating to the temperature of water stored within the water tank.

This disclosure, according to exemplary embodiments, therefore makes it possible to use a temperature, such as the temperature detected by LTS 606, to parse between, separately determine, compensate for, and/or otherwise differentiate between primary heat and secondary heat. Thus, according to exemplary embodiments, this disclosure makes it possible to monitor for or determine the presence, absence, change, or degree of secondary heat and to monitor or control operation of the water heater according to the presence, absence, change, or degree of secondary heat. As described herein in connection with various embodiments of the disclosure, this capability to parse between, separately determine, compensate for, and/or otherwise differentiate between primary heat and secondary heat, and to monitor for or determine the presence, absence, change, or degree of secondary heat, facilitates a variety of beneficial control functions and features.

For example, the controller can perform the various control methods disclosed herein by using the UTS signals along with either the uncompensated (e.g. raw or raw filtered) LTS signals that include primary heat+secondary heat, or the compensated LTS signals where the secondary heat is cancelled out (e.g. subtracted out) or by using a combination of uncompensated and compensated LTS signals. These uncompensated/compensated LTS signals may generally be smoothed by filtering (e.g. low pass filtering) to produce less erratic values. Therefore, it is noted that figures and their corresponding descriptions that discuss the use of uncompensated values, could instead use compensated values, whereas figures and their corresponding descriptions that discuss the use of compensated values, could instead use uncompensated values.

Secondary heat generally also has a lower thermal resistance path to the temperature sensor than the primary heat, because the secondary heat sources and LTS are located on the same electronic board assembly. This allows for rapid and accurate detections and determinations of secondary heat values produced by the secondary heat sources and to distinguish them from the slower heat that is produced by the heating elements and heated water. Specifically, the time constant for the secondary heat sources to heat up the electronic board assembly to steady state temperature is much shorter than the time constant for the heating elements to heat water in the tank to steady state temperature. Thus, relatively rapid increases and decreases in temperature measured by the LTS are generally attributable to the secondary heat sources, whereas slower increases and decreases in temperature measured by the LTS are generally attributable to the primary heat sources (e.g. the heating elements). In this way, primary heat can be detected and used by the controller to represent or correlate to the temperature of water in the tank, and secondary heat can be detected and used by the controller to represent or correlate to the temperature of the electronic switch or switches.

Accordingly, secondary heat differentiation is made possible by aspects of this disclosure. For example, one common thermal path of a circuit board can be thermally coupled to electronics including one or more electronic switches, to a temperature sensor, and to a water tank, which allows for easy interconnection of these components and for heat sensing and heat transfer to, from, and/or among these components. This configuration permits heat transfer from the electronics, especially the electronic switch(es), to the temperature sensor (to facilitate sensing the temperature or temperature changes of the electronics) and to the water tank (for dissipation). It also permits heat transfer from the water tank to the temperature sensor (for sensing the temperature of the water tank, generally corresponding to the temperature of water in the tank). Despite these advantages, such a configuration also combines secondary heat generated by and transferred from the electronics (including the electronic switch(es) and perhaps other sources) with primary heat generated in and transferred from the water tank, thus making the raw temperature signal from the temperature sensor undifferentiated as between the secondary heat and the primary heat. In order to parse or differentiate or segment or otherwise derive functional or operational meaning or information about the secondary heat or the primary heat, this disclosure makes it possible to (1) reliably and accurately detect secondary heat or changes in secondary heat, or otherwise differentiate between secondary heat and primary heat in electric water heaters; and (2) use that detected or differentiated secondary heat strategically to enable various electric water heating control functions described herein, such as but not limited to dry fire detection, non-simultaneous heating element or electronic switch operation, detection of switch failure or degradation, etc.

In another example, an optional second temperature sensor 610 may also be implemented in the lower control assembly. For example, the system could have LTS 606 positioned on the thermally conductive circuit board as described above, and have a second temperature sensor 610 fixed to the tank wall 108 in proximity to the thermally conductive circuit board. Such a configuration allows the controller to directly detect tank wall temperature and therefore water temperature via the second temperature sensor 610, while determining temperature of electronics 604 and electrical connections 608 via LTS 606.

Prior to operation of the water heater, power switch housing 304 should be properly installed on the tank wall. Accordingly, exemplary features of a water heater include a circuit board retainer housing and thermal coupling procedure. For example, as described in the flowchart of FIG. 7, in step 702, power switch circuit board 402 is mounted into power switch housing 304 using adhesive. Other examples of mating switch circuit board 402 to power switch housing 304 include, but are not limited to over-molding power switch housing 304 directly onto switch circuit board 402, heat-staking housing 304 to board 402, using screws to hold board 402 to housing 304 and snap-fitting board 402 to housing 304.

Once switch circuit board 402 is retained in power switch housing 304, there are various alternative means for mounting switch circuit board 402 to the tank wall to ensure proper thermal coupling between switch circuit board 402 and the tank wall. In one example, in step 704, a thermal paste is applied between the power switch circuit board 402 and the tank wall. When installing power switch housing 304 (including the thermally conductive circuit board) in the embodiment shown in FIGS. 3A and 3B, power switch housing 304 is then inserted between spring clip brackets 302B and 302C in step 706, and in step 708, one end of spring clip wire 303 is then inserted into bracket 302C via lower section 406. In step 710, spring clip wire 303 is bent such that the other end of spring clip wire 303 is inserted into bracket 302B via upper section 404. The tension in spring clip wire 303 holds the back of power switch circuit board 402 in direct contact with the tank wall thereby completing the thermal path between the thermally conductive circuit board and the tank wall.

In another example, a stud may be welded to the outer tank wall. Switch circuit board 402 may include a hole that accepts the stud. In one configuration, the stud may be flush with the surface of switch circuit board 402 or just below the surface of switch circuit board 402, and may be configured to have female threads to accept a screw. The screw is passed through the hole and accepted by the stud. Tightening the screw applies pressure to switch circuit board 402 pressing it firmly against the tank wall. In another configuration, the stud may protrude through switch circuit board 402 and may be configured to have male threads to accept a nut. The nut is threaded onto the stud to apply pressure to switch circuit board 402 pressing it against the tank wall. A washer may also be used.

In yet another configuration, the stud may be smooth and protrude through switch circuit board 402. A speed nut (e.g. Tinnerman clip or the like) may be pressed onto the stud with a pressure to hold switch circuit board 402 against the tank wall. In yet another configuration, a flat metal surface may be affixed to the tank wall. This flat metal surface could be a plug (e.g. a conductive material such as brass) screwed into a tank spud, or could be a metal plate welded to the tank wall. One or more threaded holes would be included in the flat metal surface to receive one or more screws. The switch circuit board 402 would mount flat against the metal surface mounted to the tank. A screw(s) would retain the circuit board to the plate. In either scenario, switch circuit board 402 is pressed against the tank wall or another metal surface to ensure proper thermal coupling between switch circuit board 402 and the tank wall, thereby completing the thermal path.

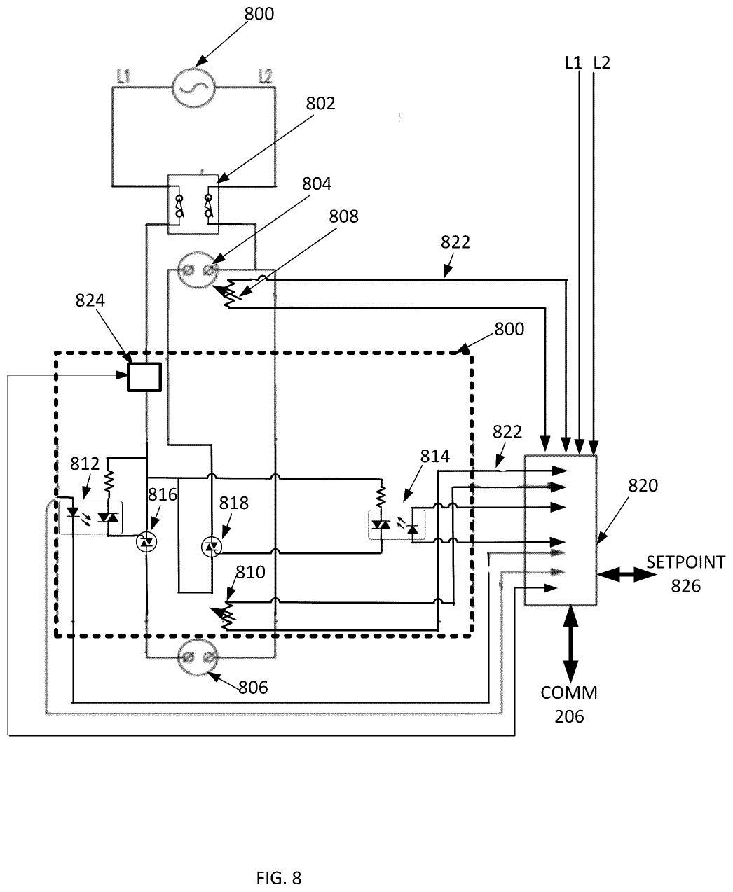

The electrical connections and functionality of the water heater control system are now described in more detail. For example, FIG. 8 is a circuit diagram of the water heater circuit Line voltage (e.g. 240 VAC) enters the system from an external power supply 800 (e.g. circuit breaker panel) via an L1 line and an L2 line (e.g. 10 awg solid conductors). Both these lines are connected to the input terminals of limit switch 802 to feed electrical current through limit switch 802, where it is then output and fed to the other components of the water heater circuit. On the L2 side, L2 connects directly to both the UE 804, as well as the LE 806. On the L1 side, however, L1 is fed through power switching module 800 before being fed to the heating elements. Power switching module 800 generally includes electronics 604, LTS 606 and electrical connections 608 mounted to power switching circuit board 402. Electronics 604 generally include OPTO-TRIACs 812/814, power TRIACs 816/818, and resistors. In this example, power TRIAC 816, herein referred to as TR1, is connected between L1 and the LE 806. Likewise, power TRIAC 818, herein referred to as TR2, is connected between L1 and the UE 804. Power TRIACs 816 and 818 are triggered ON/OFF by signals received from OPTO-TRIACs 812 and 814 respectively, which are controlled by controller 820 based on temperature readings from UTS 808 (e.g. thermistor) and LTS 810 (e.g. thermistor). Controller 820 is powered by L1 and L2, includes SP port 826 for receiving the SP temperature from the potentiometer, and may include a communication port 206 for communicating with remote computers and other water heaters.

In order to ensure safe operation of power switching module circuit 800, and maintain compliance with UL standards, power switching module circuit 800 may require a shutoff mechanism to disconnect power switching module circuit 800 in the event of a failure (e.g. if one of the power TRIACs 816/818 is stuck in the conducting mode). This shutoff mechanism may be required by UL standards to also be independent of limit switch 212. One example of a shutoff mechanism is shown as switching device 824 controlled by controller 820 to enable/disable power to TR1 and TR2. During normal operation, controller 820 turns ON switching device 824 thereby allowing TR1 or TR2 to power the UE and/or LE. However, if controller 820 determines that TR1 and/or TR2 have failed in the ON (e.g. conducting) position, controller 820 turns OFF switching device 824, thereby turning OFF the UE and the LE. In practice, switching device 824 may be a third TRIAC included in the power switching module 800 installed on circuit board 402, herein referred to as TR3, for example, for cutting power to TR1 and TR2.

In general, controller 820 in FIG. 8 includes devices such as a microprocessor, memory devices, analog input/output (I/O), digital I/O, power regulation, etc. (not shown), which serve to perform various operations. For example, such operations may include operations related to collecting and recording temperatures from sensors 808 and 810 and acting upon those temperatures to control OPTO-TRIACs 812 and 814 as well as switching mechanism 824.

The memory generally stores the programming for the controller 820. Specifically, it stores the temperature recording programming and the temperature indicator programming. To facilitate these programs, the memory also stores temperature records comprising the time, temperature, and the thermistor that recorded the temperature. The memory further stores additional diagnostic records, for example, the last time the controller received signal data from the upper OPTO-TRIACs, to assist a technician in determining whether there is a problem with the heating elements.

Detailed operation of the circuit shown in FIG. 8 will now be described. During operation, controller 820 monitors the temperature of the upper tank wall temperature sensor UTS 808 and the lower tank wall temperature sensor LTS 810 via I/O lines 822 and compares these temperatures to a SP temperature received by the knob potentiometer via input 826. Based on this comparison, controller 820 initiates the heating cycle by controlling power supplied to one or more of heating elements 804 and 806 by modulating the switching (e.g. controlling the duty cycle) of power TRIACs 816/818 via OPTO-TRIACs 812/814 during the heating cycle.

For example, if controller 820 determines that the upper tank wall temperature UTS and/or the lower tank wall temperature LTS is below the SP temperature, controller 820 outputs a signal via lines 822 to trigger one of OPTO-TRIACs 812 or 814 to begin conducting at a certain duty cycle. Upon receiving the control signals, one of OPTO-TRIACs 812 or 814 conduct current from L1 to the control gates of one of power TRIACS 816 or 818. This triggers one of power TRIACS 816 or 818 to conduct electrical current from L1 to one of heating elements 804 or 806 which then convert the electrical current into heat to begin heating the water in the tank. The current being conducted is dictated by the duty cycle chosen by the controller. This allows the controller to turn the heating elements fully OFF, fully ON or partially ON. This is described in more detail below.

While heating elements 804/806 are heating the water in the tank, controller 820 continues to monitor the temperature of the upper tank wall temperature sensor UTS 808 and/or the lower tank wall temperature sensor LTS 810 and compare these temperatures to the SP temperature plus or minus thresholds, and a “differential” which is a predetermined temperature below SP at which the heating element is turned ON. The differential is a threshold at which heating power begins to be applied. This differential may be adjusted by the controller based on various factors including but not limited to the time it takes the tank to recover. These thresholds will be described in more detail with reference to other figures. Based on these comparisons, controller 820 may then control by power TRIACS 816/818 to continue, increase, reduce or to stop supplying the electrical current to the heating elements. Specifically, controller 820 may control (e.g. modulate) the power output by power TRIACS 816/818 to any level (e.g. 20%, 50%, etc.) within a range of 0% (completely OFF) to 100% (completely ON). This is accomplished by controlling the duty cycle of the control signal output to OPTO-TRIACs 812/814 during the heating cycle.

In one example, to turn the heating elements completely OFF, controller 820 stops supplying a control signal to OPTO-TRIACs 812/814 which controls the power TRIACS 816/818 to conduct at a duty cycle of 0% (completely OFF). In another example, to turn the heating elements completely ON, controller 820 supplies a continuous control signal to OPTO-TRIAC 812 or 814 which controls the power TRIAC 816 or 818 to conduct at a duty cycle of 100% (completely ON). In yet another example, to turn the heating elements partially ON (e.g. 50% power), controller 820 supplies a modulated (e.g. periodic) control signal to OPTO-TRIACs 812 or 814, which periodically controls the power TRIACS 816 or 818 to turn ON/OFF at a specified duty cycle (e.g. 50%).

The controller can control the power output by power TRIACS 816/818 to the heating elements by varying the duty cycle of the periodic control signal input to OPTO-TRIACs 812/814 (e.g. if 30% heating power is desired, then the duty cycle of the control signal is adjusted to 30%, etc.). This allows controller 820 to have complete control over the power applied to UE 804 and LE 806 (e.g., the heating elements may be controlled separately and independently, simultaneously, fully ON, fully OFF or partially ON). Such fine grained control of the water heating elements is beneficial to water heater efficiency, power source constraints, power grid constraints, etc.

As described above, the shutoff mechanism 824 may be implemented as a third power TRIAC TR3. In one example, TR3 may be triggered by a third OPTO-TRIAC (not shown) via resistor (not shown). TR3 is generally connected between L1 and power TRIACS 816/818 (e.g. power TR3 supplies power to power TRIACS 816/818), but alternatively could be connected between L2 and power TRIACS 816/818.

During normal operation, controller 820 controls power TR3 via the OPTO-TRIAC (not shown) to continuously conduct (e.g., L1 power is continuously applied to power TRIACs 816/818). If the level of heat and/or the rate of increase in heat detected by LTS 810 reaches a predetermined threshold, controller 820 may determine that power switching module circuit 800 has failed (e.g. one of the power TRIACs 816/818 is stuck in the conducting mode). In response to this determination, controller 820 controls TR3 via OPTO-TRIAC (not shown) to stop conducting (e.g., power is prevented from reaching power TRIACs 816/818), effectively shutting off power switching module circuit 800.

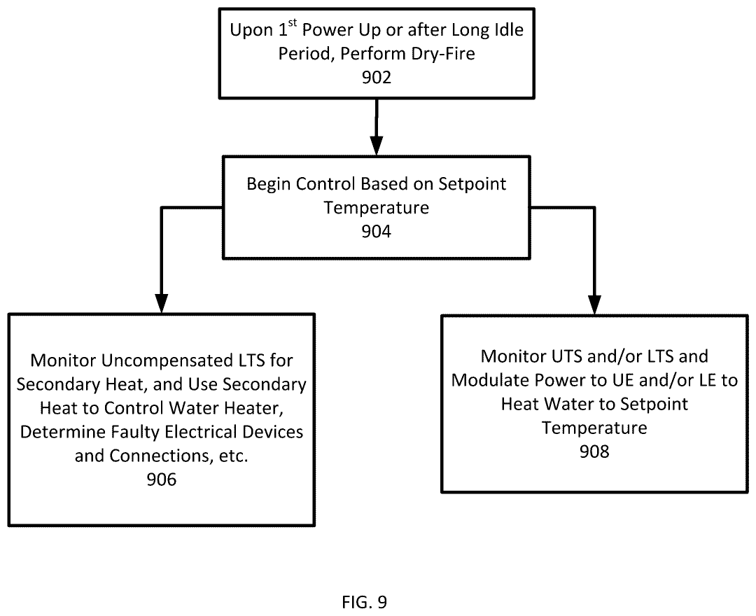

FIG. 9 shows a flowchart of the overall operation of the water heater. In step 902, if the water heater is powering up for the first time, or is powering up after a long idle time (e.g. weeks, months, etc.), controller 820 performs a process herein referred to as dry-fire. Dry-fire protection processing in step 902 generally protects against powering-up the heating elements when they are not fully immersed in water. As mentioned above, dry-fire may be performed at initial power up after installation of the water heater, and at other times when the water heater may be susceptible to dry-fire conditions such as after a power outage or after long periods of inactivity. If dry-fire protection processing is not performed, there is a risk that the heating elements will be powered up while the tank empty or only partially filled, thereby damaging the heating elements. In one example, dry-fire protection processing may be automatically initiated upon powering the water heater. In another example, dry-fire protection processing may be initiated upon user input (e.g. user making the initial set-point adjustment, etc.).

After dry-fire protection is performed, controller 820, in step 904, continues controlling the water heater based on SP (e.g. desired temperature) manually set by the user of the water heater or automatically set by a remote computer in embodiments where controller 820 is in communication with other computers through the communication port 206. In the manual example, a user turns rotatable knob 200 located on the upper cover to a desired temperature. Rotation of knob 200 adjusts the resistance of potentiometer 222 which is then received by controller 820 via input 826 and translated by controller 820 to the desired SP temperature. In the automatic example, controller 820 is connected to a communication device (not shown) via communication port 206. The communication device may be a transceiver that is wired or wirelessly connected to a communications network via WiFi, Cellular, or the like. The communications device may receive a desired SP from a remote computer (e.g. computer, smartphone, etc.) which is then relayed to controller 820 via communication port 206. In either example, controller 820 receives the SP and proceeds to steps 906/908.

When controlling the water heater, controller 820 generally performs two simultaneous processes 906 and 908. In step 908, controller 820 executes a heating cycle by modulating power provided to the UE and LE in an attempt to heat the water to the desired SP. This control is generally based on the detected temperatures from the UTS and/or LTS and the SP. In step 906, controller 820 monitors the LTS to determine heat caused by electrical components and electrical connections in the thermal path in FIG. 6, herein referred to as being included in “secondary heat,” because it is heat in the thermal path that is produced by the electrical devices/connections (not the water heat). This secondary heat is monitored to more accurately control the water heater and determine if there is a fault (e.g. faulty switches, poor thermal path conductivity, poor electrical connection, etc.) in the power switching module. In general, secondary heat produced by the electrical devices (e.g. TR1, TR2 and TR3) and electrical connections is affected based on various factors that include but are not limited to physical layout of the circuit board (e.g. TRIAC placement, sensor placement, etc.), physical properties of the circuit board (e.g. the type of metal, thickness of metal, type of dielectric, thickness of dielectric, etc.), power rating of TRIACs, and thermal path conductivity between the circuit board and the tank wall, physical placement of LTS relative to the electrical/electronic components and thermal conductivity between the LTS and the tank wall.

In general, since electronics 604 and electrical connections 608 rapidly heat up and cool off during cycling ON/OFF of the water heater (e.g. they have short time constants), and are directly attached to thermally conductive circuit board 402, they contribute significantly to the rate of change of the detected temperature. These factors, among others, may be taken into account when attempting to distinguish secondary heat from the primary heat conducting from the water. For example, controller 820 may be programmed with an algorithm that uses these factors and data to distinguish secondary heat from the primary heat radiating from the water in the thermal path. In another example, controller 820 may be programmed with an algorithm that determines secondary heat as difference between temperature readings at different time points. To ensure that primary heat is not contributing to this difference, the readings may be taken at time points when the water temperature is stable (not rising or falling). These readings may also be taken after the switch is turned ON (secondary heat rise), or after the switch is turned OFF (secondary heat drop). For example, secondary heat caused by the upper switch (e.g. TRIAC 818), herein referred to as TR2 can be determined as the difference between the LTS reading at different times. Likewise, secondary heat caused by the lower switch (e.g. TRIAC 816), herein referred to as TR1 can be determined as the difference between the LTS readings at different times.

During normal operation, for example, in step 908, controller 820 controls TR2 to modulate power applied to the UE which results in a steady rise of the upper tank temperature measurement 1230 as the water in the upper tank is heated. During this time, TR1 is turned OFF. Although TR1 is turned OFF, a steep rise occurs in the lower tank temperature, due to the secondary heat produced by TR2 located on the circuit board. The lower tank temperature measurement 1232, however, reaches a steady state due to the secondary heat being drawn away from the circuit board via the thermal path. During heating of the heating elements, controller 820 generally monitors both the UTS and LTS in step 908 and adjusts the power applied to the UE and LE accordingly.

In general, controller 820 controls the switches in a manner to modulate power applied to the heating elements. The duty cycle of the AC power may be modulated to provide power in the range of 0%-100% of the available AC power. The duty cycle may be chosen to produce a specific ratio of heat output between the UE and LE (e.g. heat the upper portion of the tank more than the lower portion, or vice versa), or to perform power scaling to control watt density of the heating elements to be within safe ranges to extend their operating life (e.g. operate the heating elements <100% of their capability), while still providing adequate heating performance for user experience.

The remaining figures are ordered to follow a typical sequence of water heater operation starting from installation. This sequence generally includes dry-fire detection followed by secondary heat determination. The determined secondary heat is used to then control the water heater to perform recovery and used to determine diagnostics (e.g. operation faults, etc.) of the water heater electrical/electronic components.

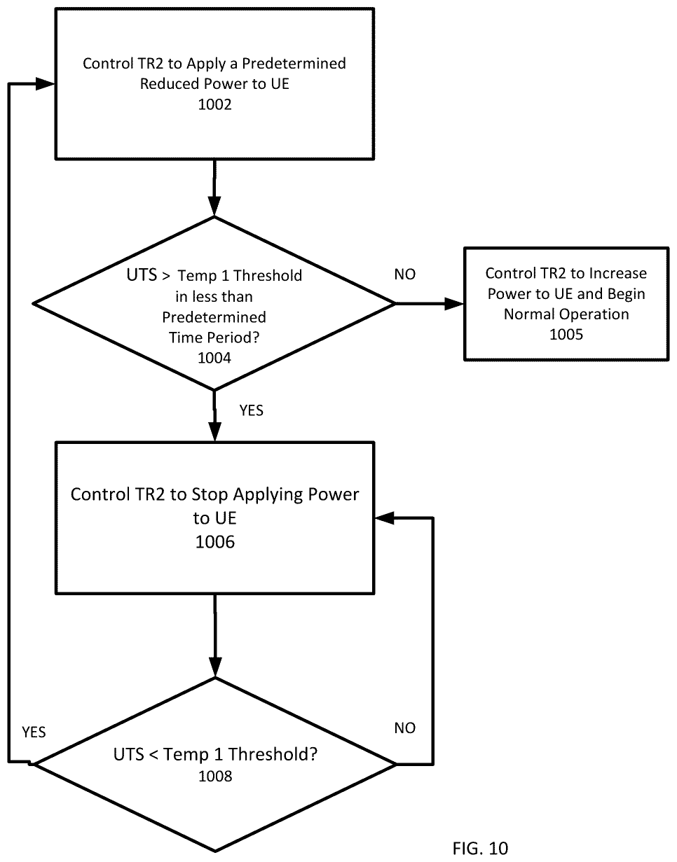

As mentioned above, prior to fully powering the water heater, the controller first performs dry-fire protection or detection to ensure that the tank is filled with water. This procedure is performed upon installation of the water heater, and after a long period of water heater inactivity. An example of dry-fire protection step is shown in more detail in FIG. 10. In step 1002, controller 820 controls TR2 to modulate power at a predetermined reduced power (e.g. 5%) to the UE. In step 1004, controller 820 monitors the UTS reading. If the UTS reading rises above a threshold over time (e.g. within a predetermined time period) in step 1004, then controller 820, in step 1006 turns OFF TR2 allowing the UE to cool down to a safe temperature before restarting the dry-fire detection process. Specifically, the controller will wait until the UTS drops to a value less than the threshold (step 1008) before attempting to repeat the process. In general, this dry-fire protection process is repeated until the UTS does not rise above the threshold over time in step 1004, at which point controller 820 determines that the tank passes dry-fire testing (e.g. it is determined that UE is immersed in water), and controller 820 controls TR2 to increase the power (e.g. 100% power) to the UE and begin normal operation (e.g. cold tank recovery)

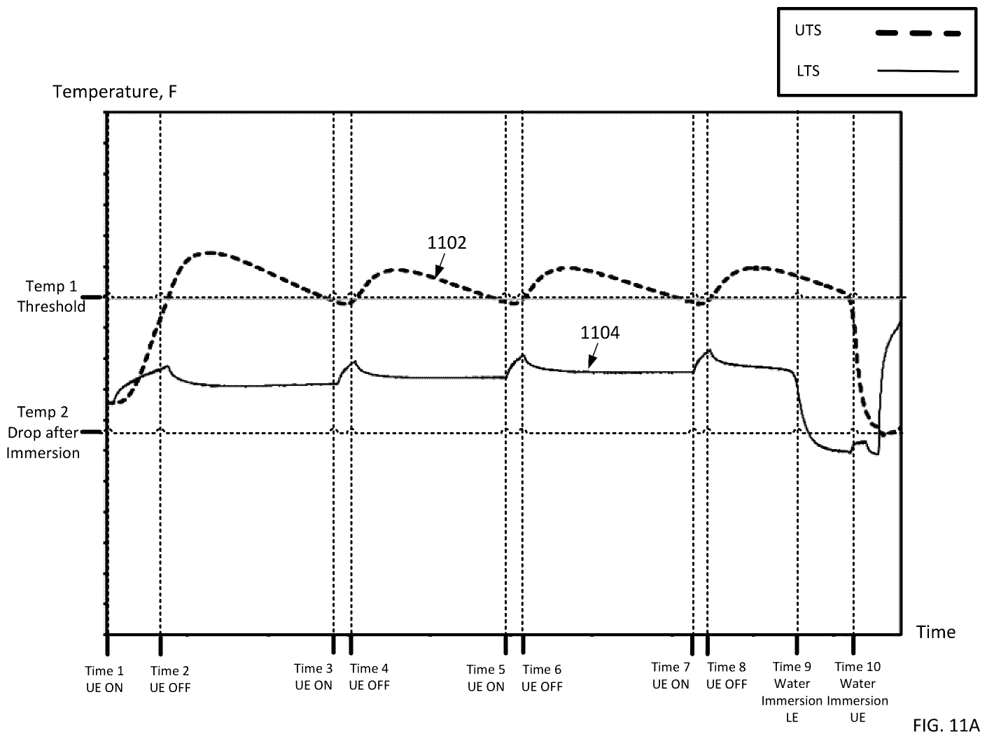

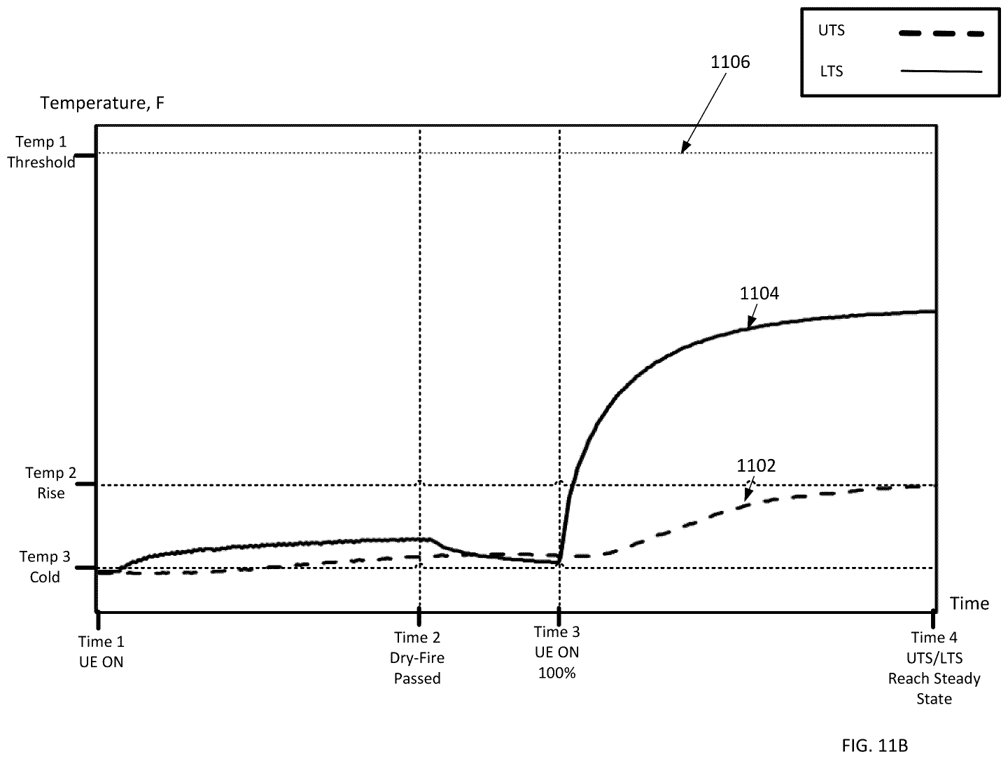

An example of a UTS time/temperature waveform of the stepwise dry-fire test described in FIG. 10 is shown in FIGS. 11A and 11B.

A first example of a dry-fire temperature plot is shown in FIG. 11A, which illustrates UTS 1102 and LTS 1104 temperature readings over a period of time when the tank is being filled with water. During a first dry-fire cycle, the UE is turned ON (e.g. at 5% power) at time 1 and then turned OFF at time 2 because UTS rises above a threshold (e.g. SP or some other predetermined threshold). Once the UE cools off and UTS drops below the threshold, UE is turned ON again (e.g. at 5% power) at time 3 and then turned off at time 4 because UTS once gain rises above the threshold. This process repeats itself because the UE is not immersed in water and UTS keeps rising too fast. However, the LE eventually becomes immersed in water at time 9, and then the UE becomes immersed in water at time 10, at which point the LTS and UTS drop drastically. Therefore, at time 10 when the UE is once again turned ON in the next dry-fire cycle, the UTS does not rise above the threshold, but remains rather flat at temp 2. This is because the heat produced by the UE is dissipated in the water. The controller therefore determines that the water heater has passed dry-fire and it is therefore safe to control TR2 to increase the power to the UE (e.g. 100% power) to begin normal operation (e.g. cold tank recovery).

A second example of a dry-fire temperature plot is shown in FIG. 11B, which illustrates UTS 1102 and LTS 1104 temperature readings over a period of time where the tank is already filled with water (e.g. LE and UE are already immersed in water from time 1). During the first dry-fire cycle, the UE is turned ON (e.g. at 5% power) at time 1. Although power is being applied to the UE, UTS 1102 does not rise above the threshold 1206 (e.g. SP or some other predetermined threshold), but remains rather flat up until time 2. This is because the heat is dissipated in the water. The controller therefore determines that the water heater has passed dry-fire at time 2, and it is therefore safe to control TR2 to increase the power to the UE (e.g. 100% power) to begin normal operation (e.g. cold tank recovery or commissioning) at time 3. Eventually, UTS 1102 and LTS 1104 reach steady states at time 4.

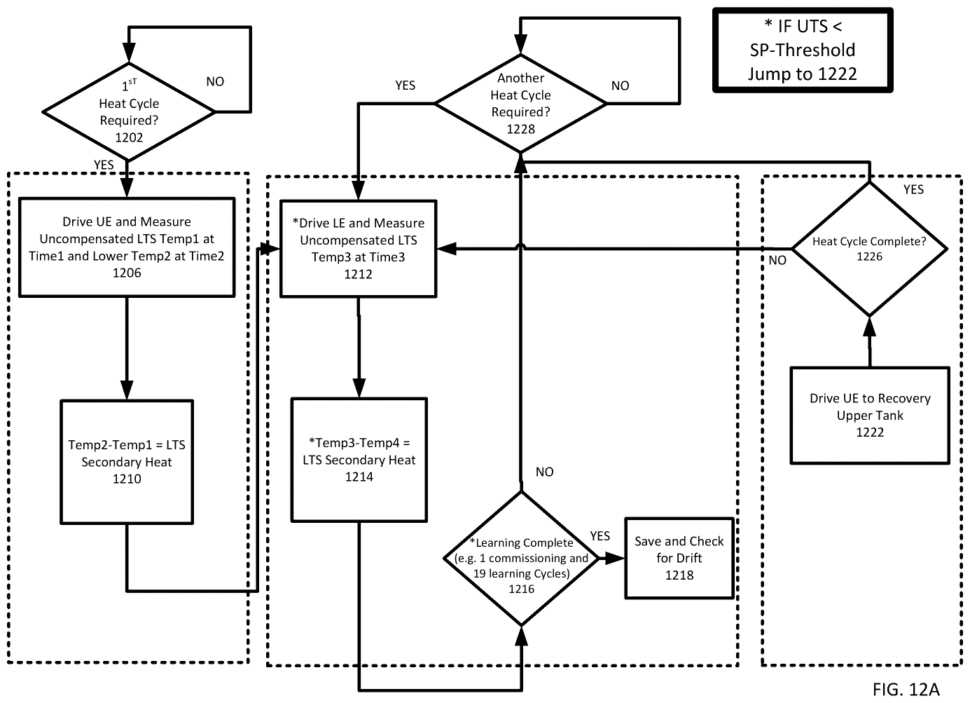

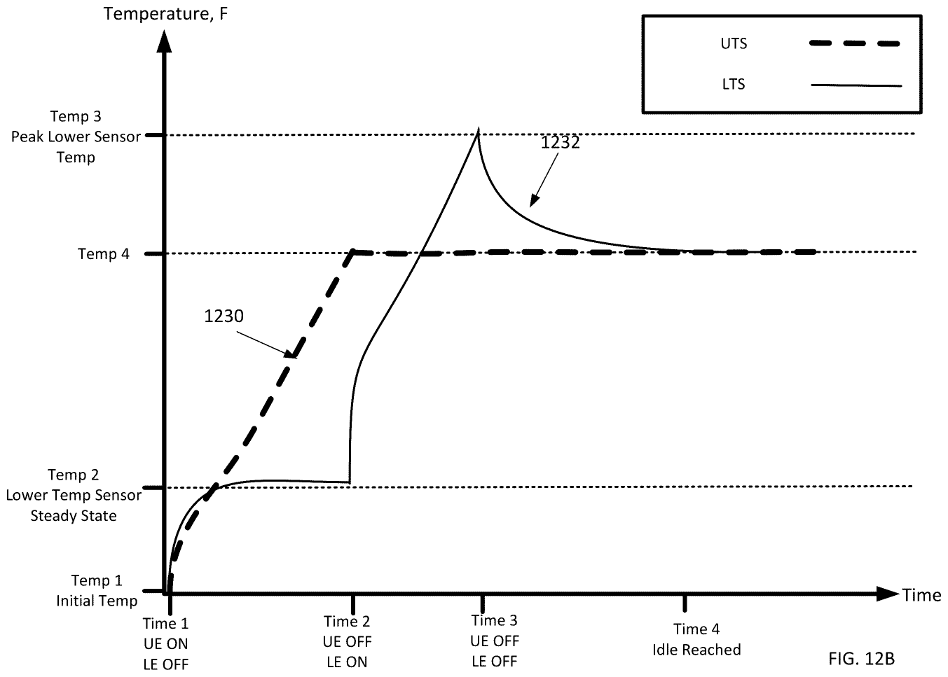

After dry-fire testing is complete, controller 820 performs a commissioning/learning procedure where the water heater begins to operate and secondary heat caused by the electronics and electrical connections is determined. This commissioning/learning procedure is shown in FIGS. 12A (secondary heat for LTS) and 12B (time/temp plot showing LTS and UTS readings).

In FIG. 12A, controller 820 determines (step 1202) if a heat cycle is required. If a heat cycle is required, then controller 820 (step 1206), using manufacturer default values for secondary heat, performs a commissioning step by driving the UE and measuring the uncompensated LTS reading 1232, Temp1 at Time 1, and Temp 2 and Time2 (see FIG. 12B) to more accurately determine the secondary heat. In step 1210, the secondary heat caused by driving TR2 is set as Temp2-Temp1. At step 1212, the controller turns off the UE and starts driving the LE, and measures the LTS reading Temp3 at Time 3. At Time3, the LE is turned off, and the controller monitors the drop of LTS reading 1232 after Time3. In step 1214, the secondary heat caused by driving TR1 is set as Temp3-Temp4 (ideally Temp4 is SP but may vary).

In step 1216, the controller determines if learning is complete, which could require the completion of the commissioning step which occurs during the 1^{st} heat cycle and a number of learning steps which occur in subsequent heat cycles. If learning is not complete, the controller determines another heat cycle is required in step 1228, and performs another learning step. If learning is complete, then the controller saves the secondary heat values and monitors them for drift over the life of the water heater. It is noted that if the commissioning step or one of the learning steps fails to produce a usable value for secondary heat, the learning process may replace these failed steps with additional learning steps to ensure an adequate data set for setting the baseline. It is also noted that if at any point during the learning process, the upper tank dips below a set threshold below SP, then the controller immediately jumps to step 1222 and begins recovering the upper tank. In step 1226, if the heat cycle is complete, step 1228 is repeated. However, in step 1226, if the heat cycle is not complete, step 1212 is repeated.

Once commissioning/learning is complete in step 1216, the process proceeds to step 1218 where the secondary heat caused by driving TR1 is set as a statistical value (e.g. average) of the secondary heat stored for each of the 20 commissioning/learning cycles. This provides an accurate baseline for future water heater control. This process may be repeated for each heat cycle thereafter which allows for the determined secondary heat to be compared against the saved statistical values in step 1218 to determine if drift occurs. If drift occurs, the controller will modify the statistical values so that the control of the heat cycle will remain accurate over the life of the water heater.

The secondary heat values determined in the flowchart of FIG. 12A are the secondary heats on the metal circuit board contributing to the LTS reading due to operation of the electronics (e.g. switches). During an operation of recovering a cold tank, as shown in FIG. 12B, the first heat cycle commences, and the controller starts driving the UE in at Time 1 to recover the upper tank. When the UTS (see 1230) reaches Temp 4 (e.g. SP-threshold) at Time 2, then the controller stops driving the UE and begins driving the LE. The controller also stops monitoring UTS and begins monitoring the LTS. When the LTS approaches Temp 4 (e.g. within 15° of Temp 4), the controller switches back to monitoring UTS and eventually stops driving the LE when the UTS rises (not shown) slightly (e.g. 0.5°) above Temp 4 at Time 3. The controller then measures a drop in the LTS from Time 3 to Time 4 as the circuit board cools off (see 1232). This drop (e.g. Temp 3-Temp 4) occurs because the secondary heat inflating the LTS reading eventually dissipates after TR1 is turned off. Thus, the secondary heat caused by TR2 is measured during the cool down period. This secondary heat value (e.g. Temp 3-Temp 4) may then be used to compensate the LTS reading for future heating cycles (e.g. the raw LTS reading is reduced by the secondary heat value to determine the true tank wall temperature).

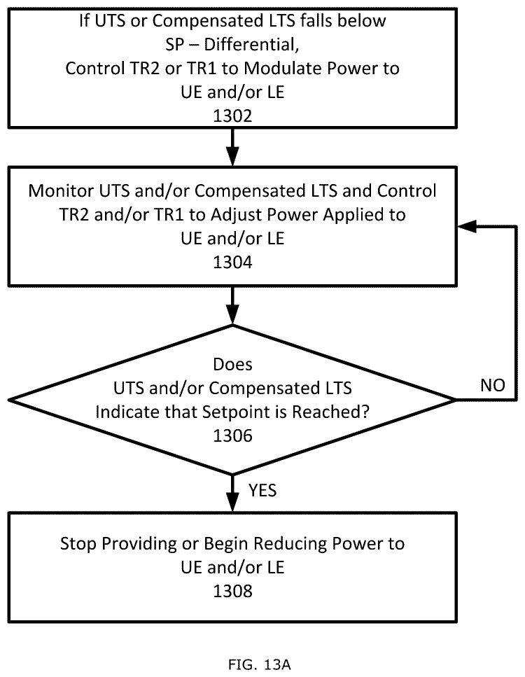

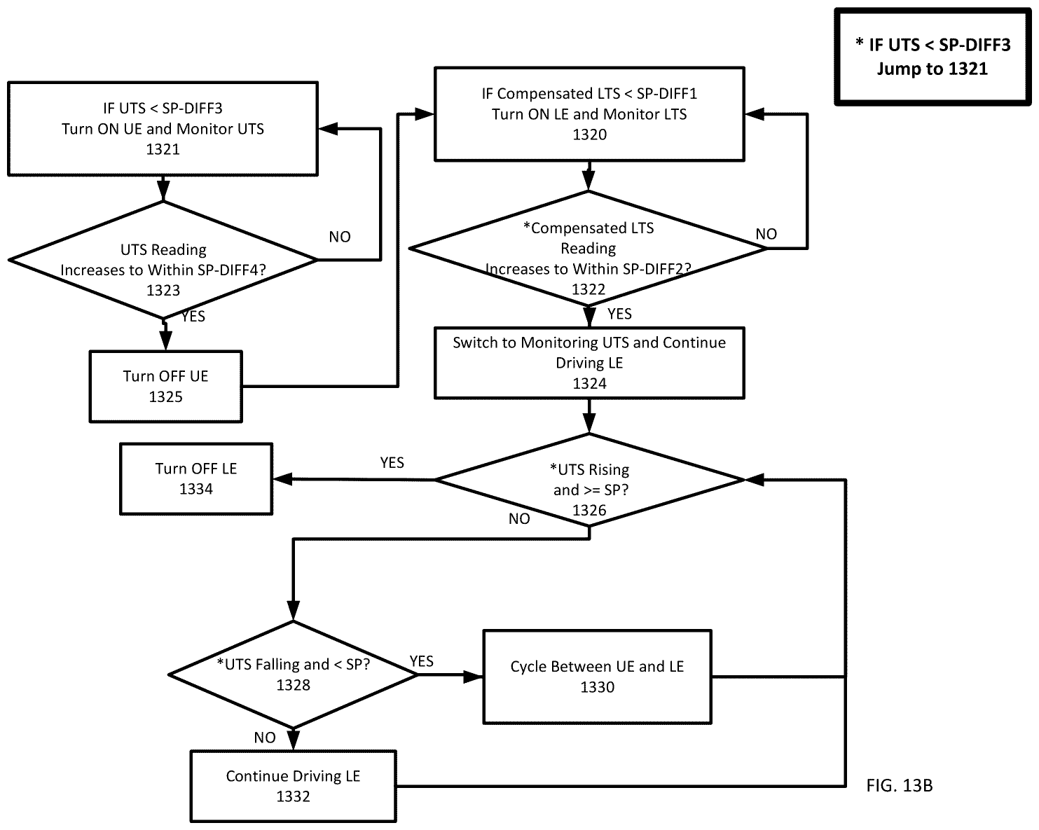

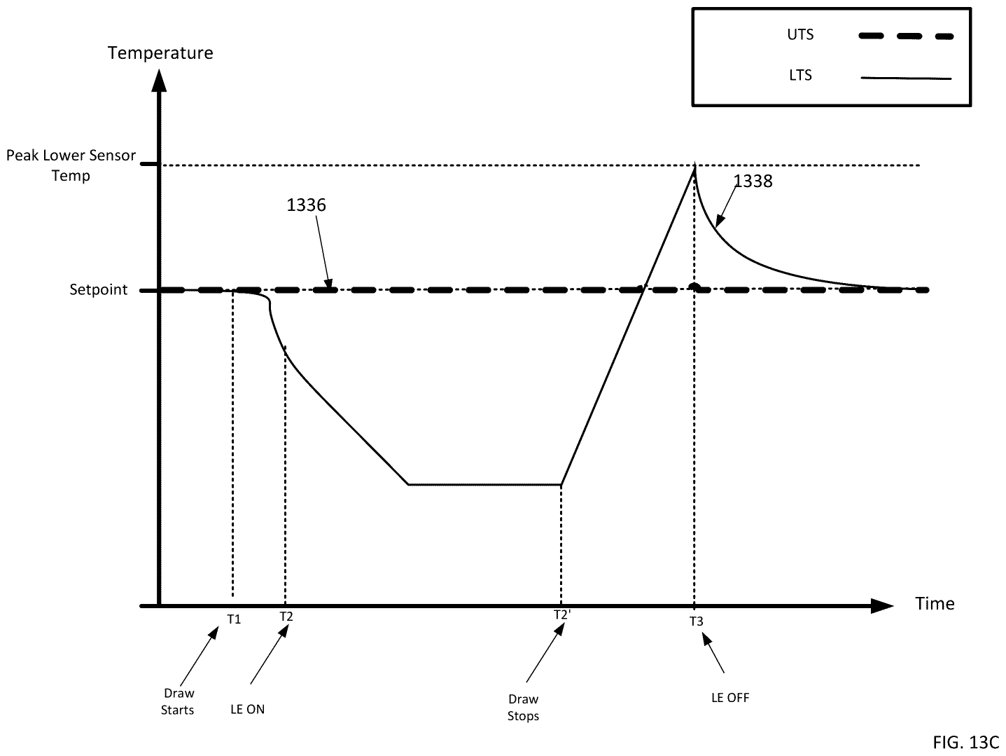

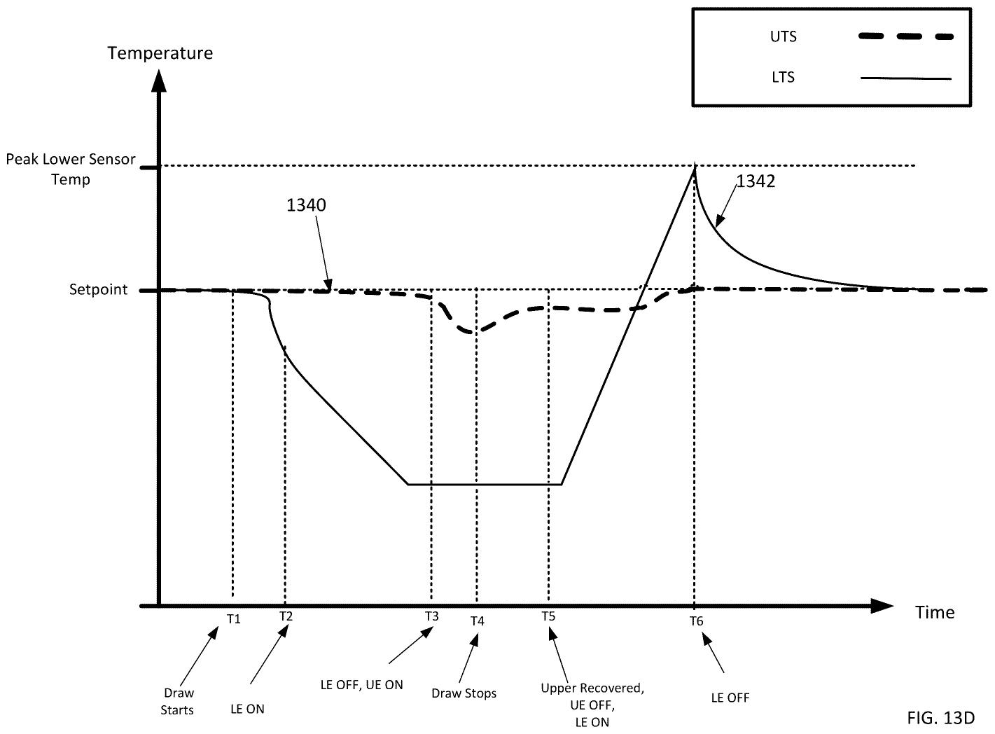

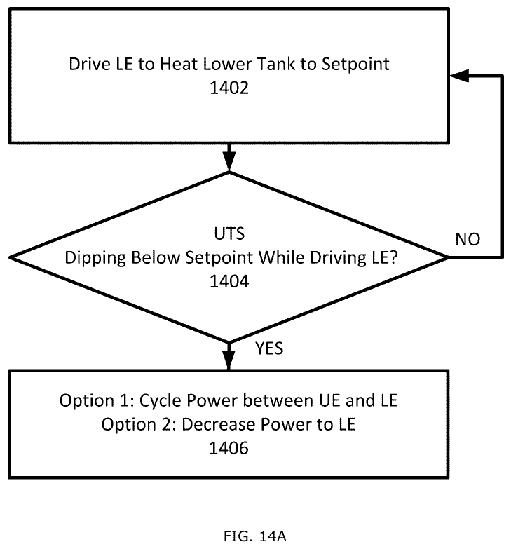

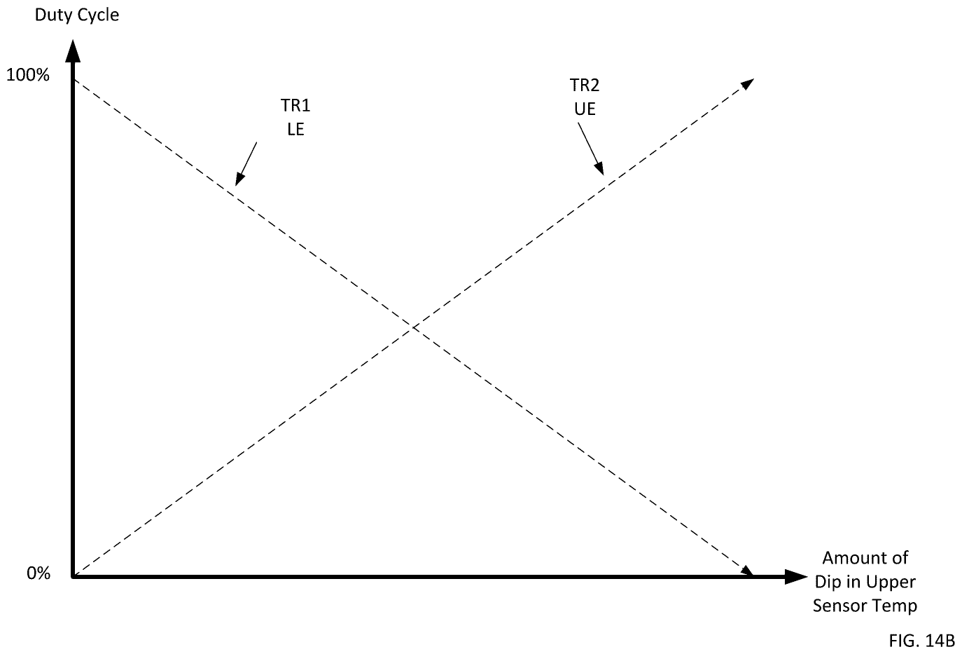

FIG. 12B described above shows a cold start/recovery of the water heater to reach Temp 4 (e.g. SP) upon its first heating cycle. Subsequent heating cycles start when the detected LTS temperature falls below set-point minus an LTS differential (DIFF1). This process is known as full recovery, which is shown in FIGS. 13A-13D.

FIG. 13A generally describes the full recovery process. In step 1302, when the UTS reading or compensated LTS reading falls below set-point (SP)-differential (e.g. a threshold number of degrees below SP), controller 820 controls TR2 and/or TR1 to modulate power to the UE and LE. Controller 820 then monitors (step 1304) the UTS and/or compensated LTS and adjusts the power applied to the UE and LE accordingly. In step 1306, when the UTS reading and/or the compensated LTS reading indicate that SP is reached, controller 820 stops or reduces the power being applied to the UE and LE. It is noted that control of the heating elements may be modified at the exact SP value or at a threshold slightly above or below the SP value.

A specific example of the full recovery process is shown in FIG. 13B, where in step 1320, controller 820 determines if the compensated LTS reading is less than SP-Differential1, and then turns on the LE. If the compensated LTS reading begins increasing in step 1322 to within SP-Differential2, controller 820 continues to drive the LE, but begins to monitor the UTS reading in step 1324. In step 1326, if the UTS reading begins to rise and becomes>=SP, then the LE is turned off step 1334, because full recovery is complete. If the UTS reading is not rising or is still below SP, however, the controller determines in step 1328 if UTS is dropping and <SP. If UTS is not dropping and <SP, then in step 1332, the controller continues driving the LE. However, if UTS begins to drop due to convection stirring (described in more detail in the next section) and drops to a temperature below SP, then in step 1330, the controller either decreases the power to the LE or cycles between powering the UE and LE in an attempt to stop UTS from dropping. This is because recovery of the upper portion of the tank takes precedent over recovery of the lower portion of the tank. In addition, if UTS drops to SP-Diff3, this indicates a deep draw is occurring. A deep draw includes a situation including a continuous addition of cold water into the tank due to heavy use, thereby depleting the hot water in the tank to the point where the UTS reading starts to drop below SP minus a differential (e.g. Diff3). The heating element can't overcome this continuous supply of cold water, so LTS stops dropping as the bottom of the tank and is stable at the temperature of the incoming cold water. At any time during the recovery process, if UTS drops to SP-Diff3 (e.g. deep draw is occurring), the controller immediately jumps to step 1321 to recover the upper tank. Specifically, in step 1321, the UE is turned ON. In step 1323, if the UTS reading increases to within SP-Diff4, then the UE is turned OFF and the process reverts back to step 1320.

Full recovery is generally triggered by a draw of water from the tank. During a shallow draw (see FIG. 13C), after the draw starts at T1, LTS reading 1338 begins to drop. At T2, LTS reading 1338 drops below a threshold and the LE is then turned ON. A “shallow draw,” which could be considered to be a normal draw, does not drain enough hot water from the tank to impact the temperature reading of the UTS. When the draw stops or diminishes enough at T2′, LTS reading 1338 stops dropping and begins increasing until reaching a peak at T3 (e.g. full recovery is complete). Generally, LTS reading 1338 at T3 is greater than SP due to the additional secondary heat affecting the temperature reading. The decision for when to turn OFF the LE at T3 is based on the UTS reading 1336 which will begin to rise slightly (not shown) after the bottom of the tank has fully recovered.

During the recovery shown in FIG. 13C, the UE was not turned ON, because UTS reading 1336 did not drop below SP. However, when there is a deep draw from the tank and the UTS reading dips below SP-threshold, the UE should be turned ON because the water at the upper part of the tank takes precedent over the water at the lower part of the tank. This is shown in the deep draw of FIG. 13D. After the draw starts at T1, LTS reading 1342 begins to drop. At T2, LTS reading 1342 drops below a threshold and the LE is then turned ON. Eventually incoming cold water and heat produced by LE reach equilibrium and stops LTS reading 1342 from dropping. However, UTS reading 1340 begins to drop at T3. At time T3, in order to correct the UTS reading drop, the controller switches to applying power to the UE and UTS is monitored. Generally, UTS takes precedent over LTS, because UTS indicates the temperature of the water being delivered to the user from the top of the tank, whereas LTS indicates the temperature of the water closest to the cold water inlet. It is therefore beneficial to ensure that UTS is at SP. In this example, when the UTS reading 1340 recovers at T5, the controller then switches again to applying power to the LE and monitoring UTS. Eventually, the LTS reading 1342 begins increasing until reaching a peak at T6. Heat from LE begins to heat the upper water and increase the UTS reading between T5 and T6. When the UTS reading reaches SP at T6, the controller then stops applying power to the LE.

Internal circulation of water in the tank (herein referred to as convection stirring) is due to a difference between the high thermal energy being applied to the water in the lower portion of the tank when the LE is ON at high power, and the low thermal energy being applied to the water in the upper portion of the tank when the UE is OFF. A column of hot water flowing up from the LE pushes up through the hot water layer above the UE, causing water in the upper portion of the tank to drop and mix with colder water just below the UE. This causes a dip in the UTS reading.

Unlike a deep draw, the UTS drop due to convection stirring occurs when water flow into the tank has stopped (e.g. the draw has stopped). In an example, once the UE is done heating water in the upper portion of the tank, the LE turns on. As the LE begins to generate hot water at the bottom portion of the tank, this hot water rises up and eventually has enough kinetic energy to displace hot water at the upper portion of the tank. Cold water mixes with the more buoyant hot water because of convection flow caused by heated water rising quickly from the lower portion of the tank.

Convection stirring is a problem that is noticeable for the end user. For example, the end user may initially make a small water draw and receive water at the desired SP. However, moments later the end user may initiate another draw but then receive colder water due to the dip that occurs in the water temperature. Therefore it is beneficial for the end user to reduce convection stirring. Generally, convection stirring can be reduced by reducing the difference between the thermal energy being applied to the water in the upper and lower portions of the tank. For example, the duty cycle of the LE can be reduced, and/or the duty cycle of the UE can be increased (e.g. 75% power to the LE and 25% power to the UE). The goal being to reduce the magnitude and duration of the dip in temperature of the UTS.

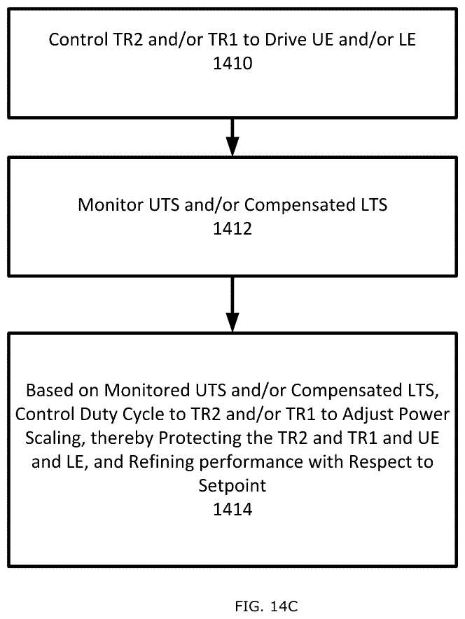

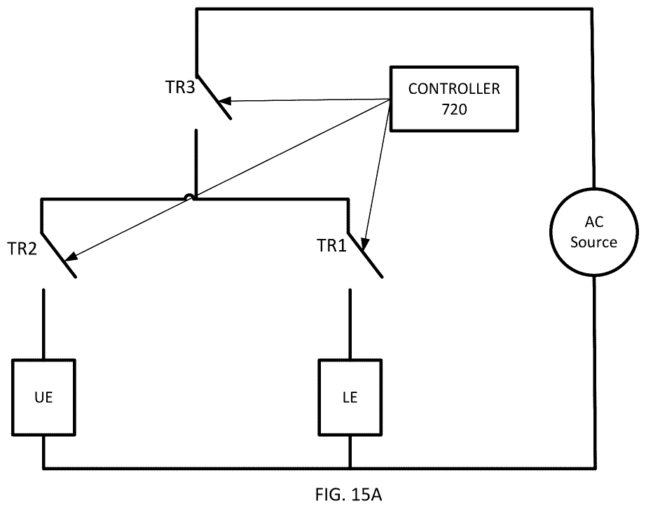

For example, as shown in FIG. 14A, when the LTS reading dips below SP, the LE is driven in step 1402 to recover the lower portion of the tank. However, during this recovery, if the UTS reading also dips below SP in step 1404, the controller determines that convection stirring is occurring and proceeds to step 1406 to either cycle power between the UE and LE or simply reduce power applied to the LE. An example of cycling power between the UE and LE is shown in FIG. 14B, whereas when the amount of dip in UTS reading increases, the power to the UE is increased by increasing the duty cycle to TR2, and the power to the LE is decreased by decreasing the duty cycle to TR1.

In order to scale power to the UE and LE, as shown in FIG. 14C, the controller generally drives the elements in step 1410, monitors the UTS reading and LTS reading in step 1412 and then based on the monitored UTS and LTS readings, controls the duty cycle to TR2 and TR1 in step 1414. Benefits of power scaling include protecting TRIACs TR1/TR2, protecting UE/LE and refining performance with respect to SP. Some of these benefits are described in later sections.

It is also noted that in another embodiment, the electronic switching module may not be needed to detect convection stirring. The readings from the UTS and LTS may be used to detect convection stirring. For example, during operation, the controller can simply drive the LE as normal, and compare the upper temperature to the lower temperature during this time. From this comparison, the controller can determine that water circulation within the tank is occurring (UTS is dropping) while driving the LE. The controller can then reduce the electrical power to the LE, or cycle electrical power between the UE and LE to compensate for the water circulation within the tank.

Regarding possible simultaneous operation of the UE and LE, the UE and LE are generally rated to draw a percentage amount of power for a given branch circuit. For example, if the branch circuit is rated at 30 amperes, a single heating element, when powered on at 100%, could draw up to 24 amperes (e.g. 80% of the branch circuit power). Naturally, during operation of the water heater both the UE and LE cannot be turned ON at even moderate power levels (e.g. >−60% of their capacity) at the same time, because they will draw more than 15 amperes each and exceed the branch circuit limit of 30 amperes.

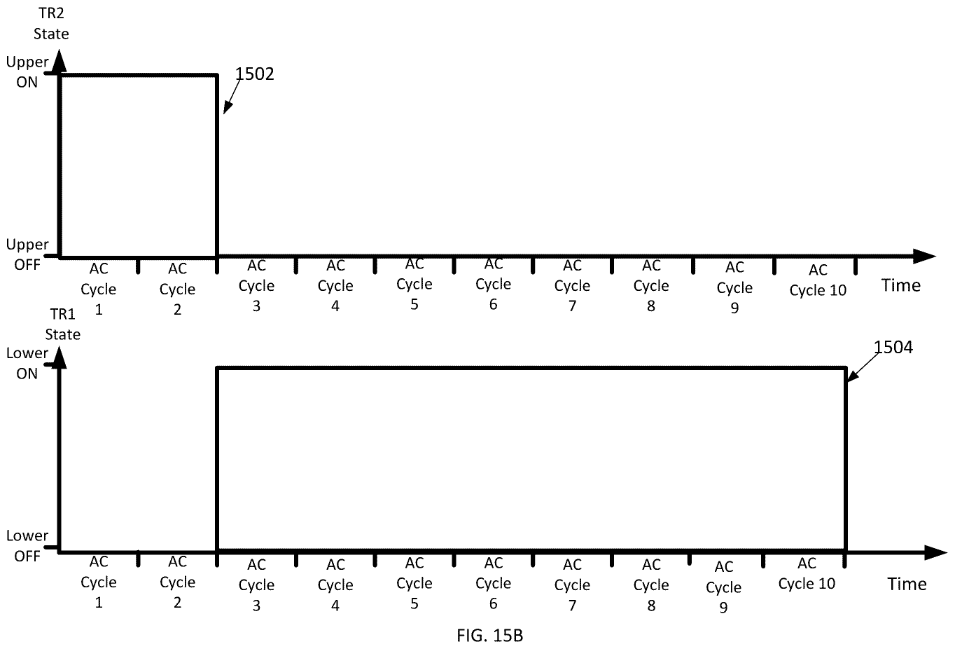

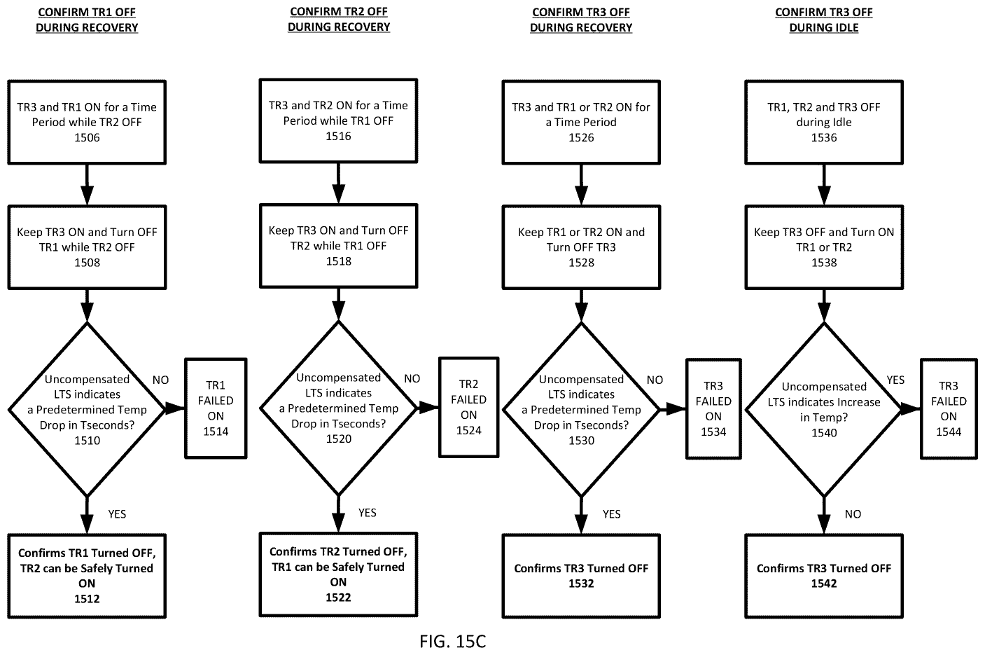

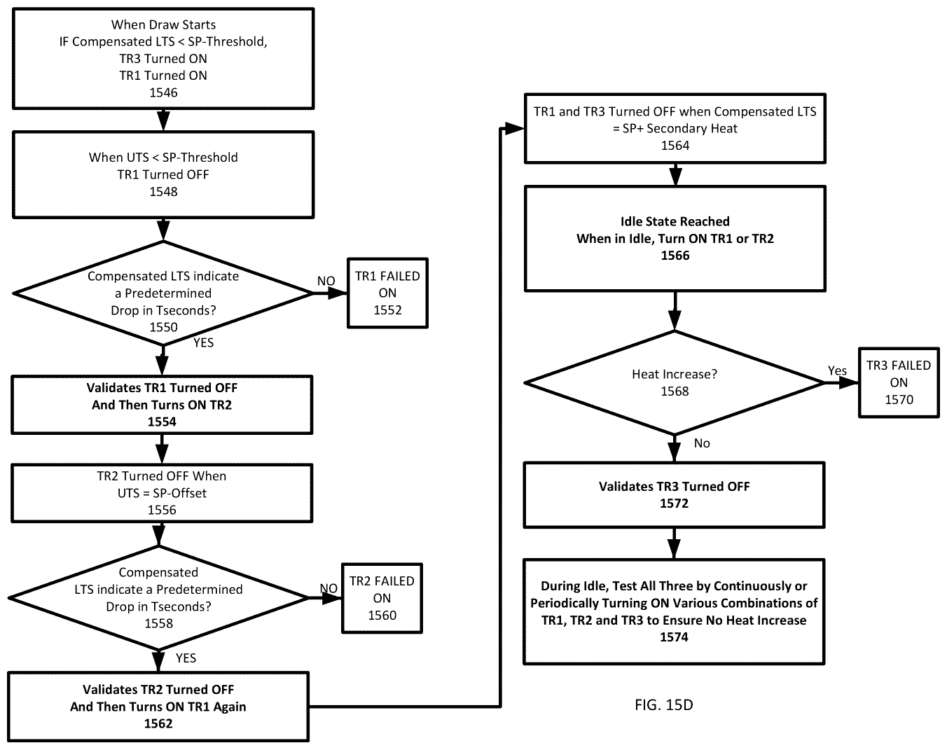

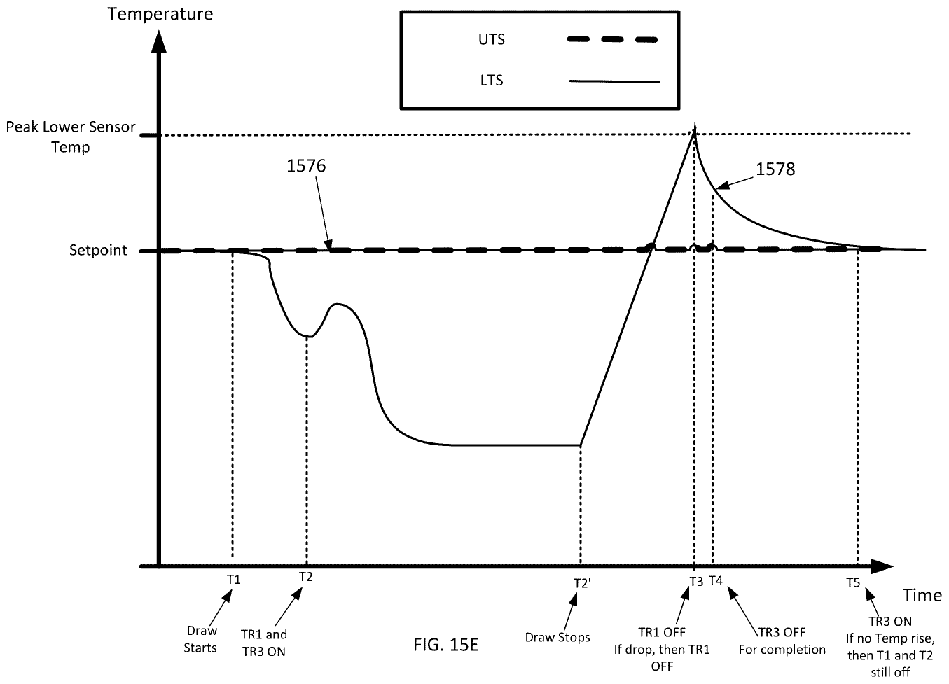

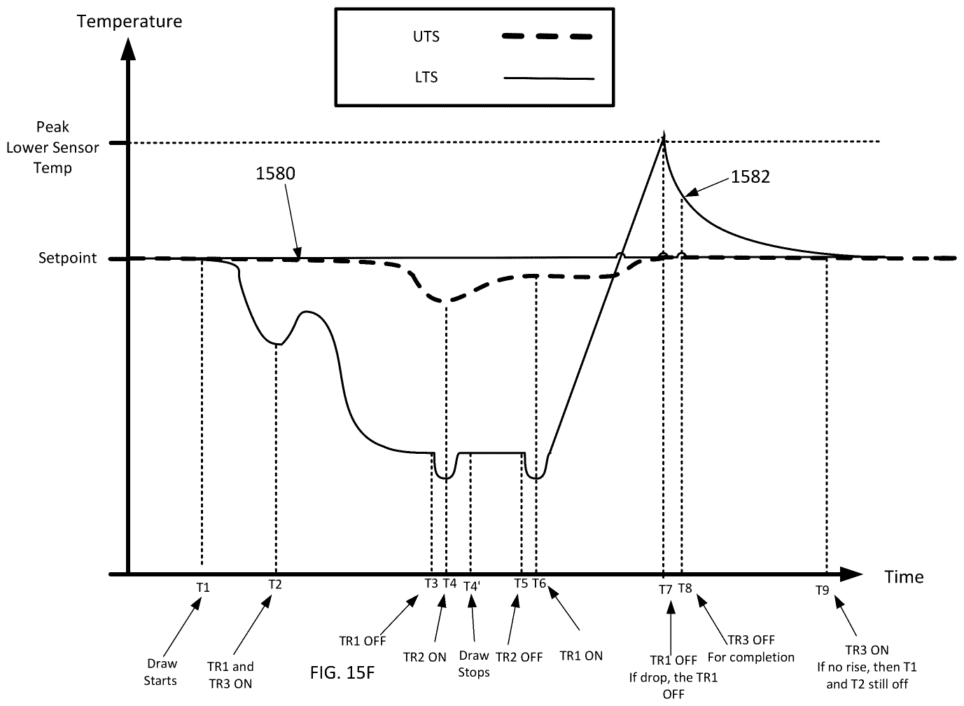

With this constraint in mind, the current system ensures that both the UE and LE are not turned ON simultaneously. This is called “non-simultaneous operation.” FIG. 15A shows a simplified wiring diagram where TR1 controls power to the LE, TR2 controls power to the UE, and safety switch TR3 controls power to both TR1 and TR2. Non-simultaneous operation is assured by checking if TR1 is OFF before turning on TR2 and vice versa. Confirmation of the switches being turned OFF is determined from a rise or drop in secondary heat based on their states of operation as described below.

A general example non-simultaneous operation of switches TR1 and TR2 is shown in FIG. 15B where during AC cycles 1-2, TR1 1504 is OFF, and TR2 1502 is ON. During AC cycles 3-10, TR1 1504 is ON and TR2 1502 is OFF. TR1 and TR2 are not both ON in any given AC cycle. This is the essence of non-simultaneous switch operation. Although this example shows TR1 ON with 80% duty cycle and TR2 ON with 20% duty cycle, any duty cycle, or frequency of switching between TR1 and TR2 can be achieved.

In order to assure non-simultaneous switch operation, controller 820 is configured to confirm switch states of TR1, TR2 and TR3. For example, prior to turning ON TR2, controller 820 confirms that TR1 is OFF, and vice versa.

In FIG. 15C, the first flowchart on the left confirms that TR1 is OFF by turning ON TR3 and TR1 while TR2 is OFF (step 1506), turning OFF TR1 while TR3 is maintained ON (step 1508), determining that TR1 failed ON (step 1514) if the LTS reading does not indicate a predetermined drop in Tseconds (step 1510), and confirming that TR1 is OFF and TR2 can safely be turned ON (step 1512) when the LTS reading indicates a predetermined drop in Tseconds (step 1510). When TR1 is actually turned OFF, TR1 should no longer produces secondary heat which causes the LTS reading to drop. If this drop does not occur, then TR1 is still ON and producing secondary heat (e.g. TR1 was controlled to turn OFF, but due to a fault, stayed ON).

In FIG. 15C, the second flowchart from the left confirms that TR2 is OFF by turning ON TR3 and TR2 while TR1 is OFF (step 1516), turning OFF TR2 while TR3 is maintained ON (step 1518), determining that TR2 failed ON (step 1524) if the LTS reading does not indicate a predetermined drop in Tseconds (step 1520), and confirming that TR2 is OFF and TR1 can safely be turned ON (step 1522) when the LTS reading indicates a predetermined drop in Tseconds (step 1520). When TR2 is actually turned OFF, TR2 should no longer produces secondary heat which causes the LTS reading to drop. If this drop does not occur, then TR2 is still ON and producing secondary heat (e.g. TR2 was controlled to turn OFF, but due to a fault, stayed ON).

In FIG. 15C, the third flowchart from the left confirms that TR3 is OFF by turning ON TR3 and either TR1 or TR2 (step 1526), turning OFF TR3 while TR1 or TR2 is maintained ON (step 1528), determining that TR3 failed ON (step 1534) if the LTS reading does not indicate a predetermined drop in Tseconds (step 1530), and confirming that TR3 is OFF and (step 1532) when LTS indicates a predetermined drop in Tseconds (step 1530). When TR3 is actually turned OFF, TR3 should no longer produces secondary heat which causes the LTS reading to drop. If this drop does not occur, then TR3 is still ON and producing secondary heat (e.g. TR3 was controlled to turn OFF, but due to a fault, stayed ON).

In FIG. 15C, the fourth flowchart from the left confirms that TR3 is OFF during idle (e.g. when the tank is at SP) by turning OFF TR1, TR2 and TR3 (step 1536), turning ON TR1 or TR2 while TR3 is maintained OFF (step 1538), determining that TR3 failed ON (step 1544) if the LTS reading indicates a rise in Tseconds (step 1540), and confirming that TR3 is OFF (step 1542) when the LTS reading indicates a rise in Tseconds (step 1542). When TR3 is turned OFF, turning ON TR1 or TR2 should not cause any rise in the LTS reading (e.g. TR3 cuts off power to both TR1 and TR2 as shown in the circuit). If a rise in LTS occurs, then TR3 is still ON and allowing current to flow to TR1 and TR2.

A specific example of non-simultaneous switch operation is described in the flowchart of FIG. 15D. In step 1546, when a draw starts and the compensated LTS reading drops below SP, TR3 and TR1 are turned ON.

In step 1548, if the UTS reading is below SP (e.g. convection stirring is occurring), TR1 is turned OFF. If, during step 1550, compensated LTS does not indicate a predetermined drop in Tseconds, then TR1 is determined to have failed ON (step 1552). If, however, during step 1550, compensated LTS indicates a predetermined drop in Tseconds, then TR1 is determined to have properly turned OFF, thereby allowing TR2 to safely turn ON (step 1554).

In step 1556, if UTS equals SP-Offset (e.g. convention stirring stopped), TR2 is turned OFF. If, during step 1558, compensated LTS does not indicate a predetermined drop in Tseconds, then TR2 is determined to have failed ON (step 1560). If, however, during step 1558, the compensated LTS reading indicates a predetermined drop in Tseconds, then TR2 is determined to have properly turned OFF, thereby allowing TR1 to safely turn ON (step 1562).

When recovery is completed, TR1 and TR3 are turned OFF (step 1564). During this idle state, the controller can turn ON TR1 or TR2 in step 1566. If during step 1568, the compensated LTS reading increases, then it is determined in step 1570 that TR3 failed ON. If, however, during step 1568, compensated LTS does not increase, it is determined in step 1572 that TR3 is OFF. In step 1544, TR1, TR2 and TR3 can be periodically tested using these methods. If they are properly turned OFF, then no heat rise in the compensated LTS reading should occur by turning on just one switch at a time.

An example of non-simultaneous operation for a shallow draw is shown in FIG. 15E. At time T1, the draw starts, and at time T2, TR1 and TR3 are turned ON to power the LE. This causes a temporary rise in secondary heat after T2 which eventually drops, flattens out and rises to reach an LTS reading of SP plus secondary heat at time T3, where TR1 is turned OFF, and time T4 where TR3 is turned OFF. Once in the idle state after time T5, TR3 can be turned ON. If the LTS reading does not increase, then TR1 and TR2 are confirmed OFF.

Another example of non-simultaneous operation for a deep draw that causes a drop in UTS is shown in FIG. 15F. At time T1, the draw starts, and at time T2, TR1 and TR3 are turned ON to power the LE. This causes a temporary rise in secondary heat after T2 which eventually drops and flattens. However, at T3, a dip in the UTS reading due to stirring triggers the controller to switch from powering the LE to powering the UE. Specifically, at time T3, TR1 is turned OFF. If the LTS reading drops quickly, then the controller is able to confirm that TR1 is OFF, which allows TR2 to be safely turned ON at T4. The draw ends soon after time T4 (e.g. time T4′) and eventually the UTS reading recovers to SP at T5 which triggers the controller to switch from powering the UE to power the LE to complete recovery of the lower portion of the tank. Specifically, at time T5, TR2 is turned OFF. If the LTS reading drops quickly, then the controller is able to confirm that TR2 is OFF, which allows TR1 to be turned ON safely at T6. After the LTS reading recovers at T7, TR1 is turned OFF again followed by TR3 at T8. During idle after time T9, TR3 can be turned ON again to test for a rise in the LTS reading. If no rise occurs, then TR1 and TR2 are confirmed to be OFF.

The main reason that the system would fail the non-simultaneous operation checks would be due to a failed ON switch (e.g. TR1 or TR2 is failed ON and will not shut OFF). Therefore, if during these non-simultaneous operation checks, it is determined that a switch (e.g. TR1) will not shut OFF, the controller will prevent the remaining switch (e.g. TR2) from turning ON, and output an alert to the user indicating a failed ON switch. This ensures that circuit is not overloaded, and the user knows that maintenance is required. In addition, the water heater can still function by modulating TR3 ON/OFF based on the LTS and UTS to supply power to the failed ON switch and the driven heating element.

It is noted that although non-simultaneous control of the switches is described above, the system is able to turn on TR1 and TR2 simultaneously if their power consumption is restricted to a safe level (e.g. 90% of the branch circuit capacity). Thus, if LE and UE are each capable of drawing 24 amperes, and the branch circuit is rated at 30 amperes, TR1/TR2 can be turned on simultaneously as long as they modulate the total power provided to UE/LE to be less than 27 amperes (e.g. UE/LE can each draw 13.5 amperes simultaneously).

In order to accurately utilize the secondary heat information to control the water heater functionality and identify faults, the control system may be programmed with initial factory settings including but not limited to secondary heat magnitude and secondary heat rate of change thresholds that are based on various factors, including but not limited to water heater size/shape, etc. Upon initial startup, the water heater uses these factory settings to determine secondary heat and control switching between heating elements and the power modulation of the heating elements.

However, it is noted that various factors including, but not limited to installation location (e.g. hot/cold climate, etc.) and water chemistry (e.g. hardness, etc.) affect water heater performance. Therefore, the factory settings may not be optimal for all installations. Therefore, during operation, the water heater may implement machine learning to gradually adjust the factory settings over a number of heating cycles to improve performance. For example, various factors including but not limited to rates of change in temperature in response to power consumption measured over various cycles may be used as training data in order to make future predictions or decisions on the use of more optimal control parameters (e.g. duty cycle, switching times, secondary heat thresholds, etc.). When learning is complete, the water heater uses the learned parameters for future control of the water heater.

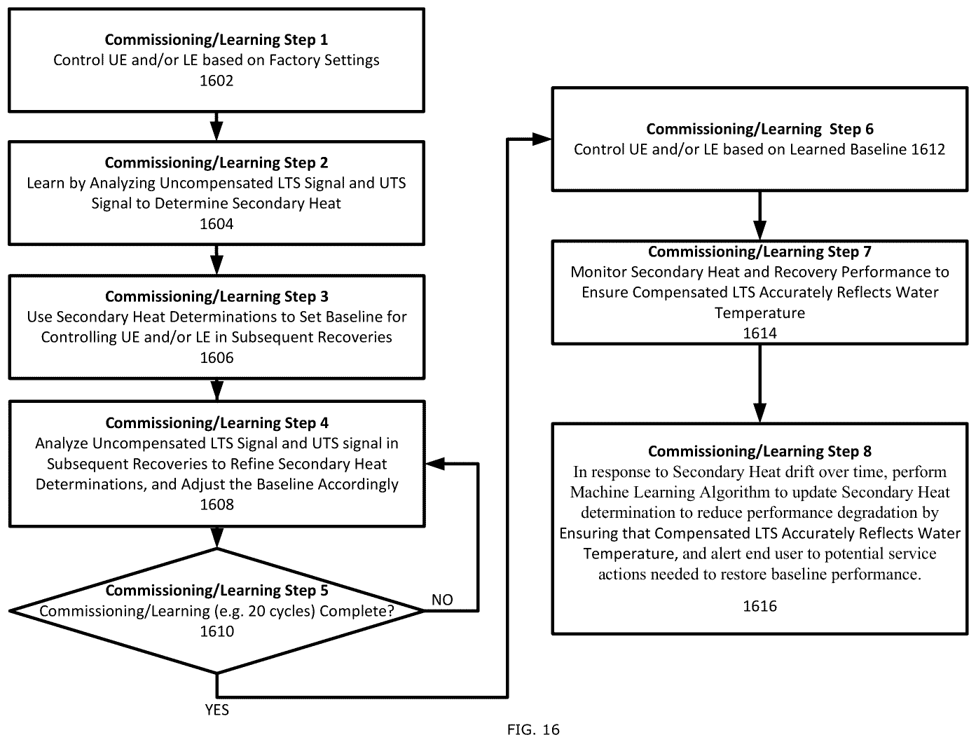

An example of machine learning is shown in FIG. 16 where the machine learning includes a commissioning step and multiple machine learning steps. In step 1602, when first installed and powered up, the water heater is controlled based on factor settings. In step 1604, the controller analyzes the LTS reading to determine secondary heat caused by TR2 and TR1. In steps 1606 and 1608, the controller uses secondary heat determinations from the initial startup and commissioning cycle, and a predetermined number of subsequent recoveries (e.g. 19 cycles) to set a baseline for LTS secondary heat. When commissioning/learning is determined to be complete in step 1610, the controller controls the heating elements based on the baseline (step 1612), monitors the secondary heat (step 1614) and implements machine learning algorithms in response to secondary heat drift (step 1616) that may occur over the life of the water heater. This allows the LTS secondary heat values to be determined at each heat cycle and then adjusted over the lifetime of the water heater if drift occurs. The controller is able to compute compensated LTS readings by cancelling out (e.g. subtracting) the contributions of the of the secondary heat from the LTS readings that accurately reflects the actual water temperature in order to make accurate decisions on when to turn ON/OFF the UE and LE, and to know what power at which to drive the UE and LE in order to perform recovery and the diagnostic methods described throughout this disclosure. For example, when controlling the heating elements based on the LTS, the controller takes into account that the LTS reading is greater than SP by a factor based on the secondary heat from the LTS reading. The effects of the secondary heat from the LTS reading are subtracted from the LTS reading to get the compensate LTS which is an accurate reading of the water temperature.

It is noted that FIG. 16 is just one example of machine learning. In general, during machine learning, factory settings are used during the initial commissioning step(s) to determine the initial secondary heat. The next N (e.g. 20) learning sessions then refine the initial secondary heat to determine an accurate baseline for secondary heat which is stored. After the secondary heat is refined it is used to control the water heater. The controller then monitors drift in secondary heat. As drift occurs, the secondary heat values can be adjusted to ensure proper operation (e.g. ensuring the compensated LTS accurately reflects the water temperature) of the water heater and the drift magnitude can be used to diagnose whether potential service actions would be beneficial to restore full operational performance of the water heater.

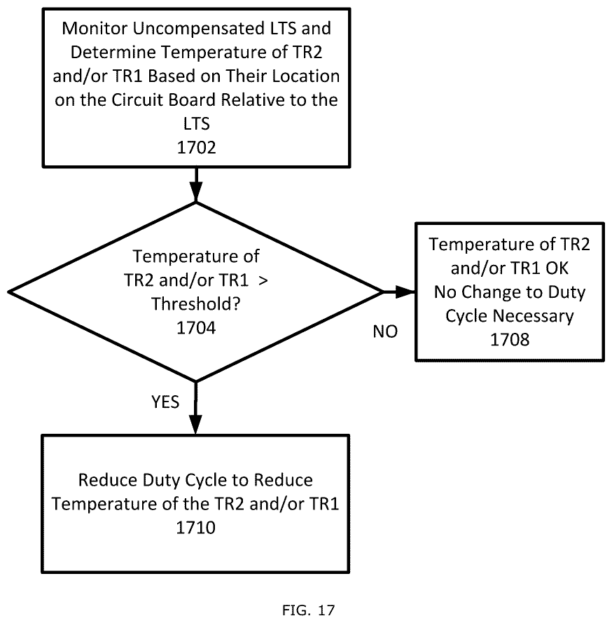

Regarding the protection of switches, TR1 and TR2 are electronic switches such as TRIACS that have power and temperature ratings that should not be exceeded. The controller is able to monitor the LTS reading to ensure that these ratings are not exceeded. For example, as shown in FIG. 17, the controller monitors the LTS reading and estimates the operating temperatures of each of the switches based on their location on the circuit board relative to the location of the LTS (step 1702). If the temperature of the switches does not exceed an allowable threshold, then the switches are determined to be operating safely and the duty cycle may be maintained (step 1708). If, however, the temperature of the switches exceed an allowable threshold, then the switches are determined to be operating outside of their allowable range, and a decrease in duty cycle (e.g. power scaling) is performed (step 1710) to reduce or limit the operating temperature in order to protect the switches from overheating. This is beneficial for protecting the switches from failure, while still allowing the water heater to operate.

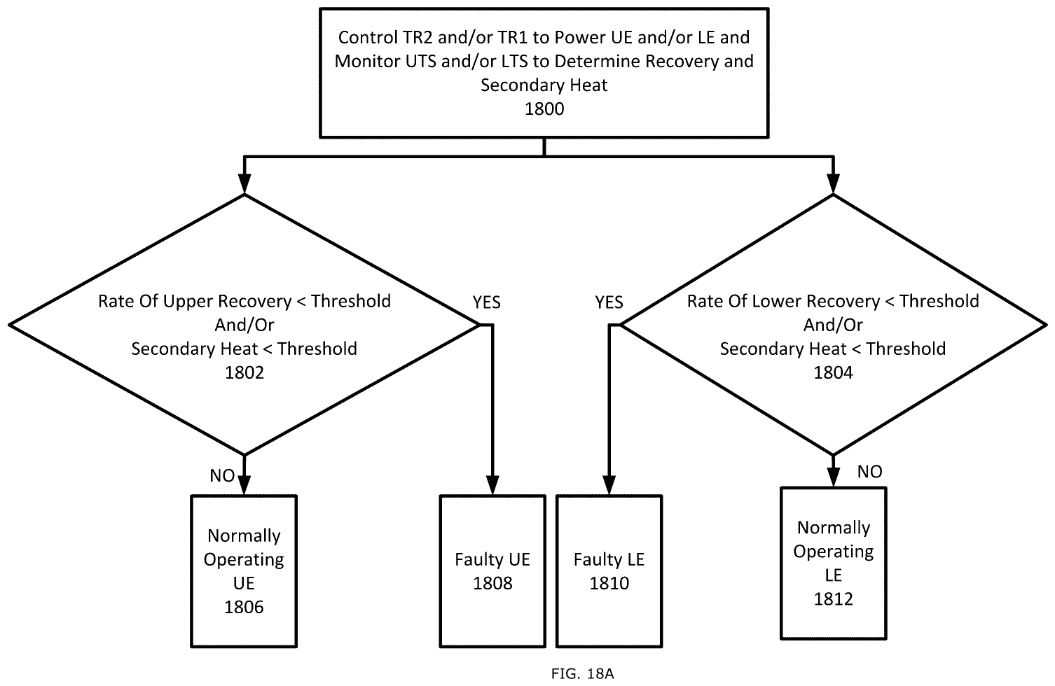

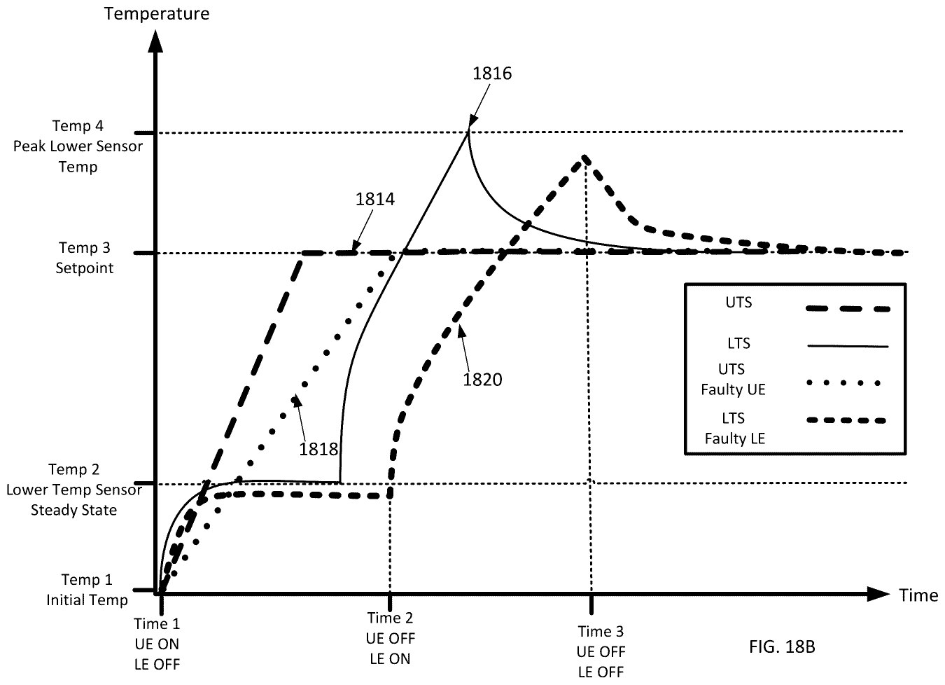

Heating elements are resistive elements that have an operational life. As time goes on, the resistance of the elements increases causing the element to be less effective at heating the water in the tank. Effectively, the heating elements consume less power and therefore produce less heat as they age which results in a decreased secondary heat. As a result, the switches do not conduct as much electrical power due to the increased resistance of the elements and therefore the switches do not get as hot as in past cycles. As shown in FIG. 18A, the controller is able to detect faulty heating elements (e.g. heating elements that are not heating to their designed temperature) by powering the heating elements in step 1800 and determine their performance in steps 1802 and 1804. Specifically, in step 1802, if the controller determines that the rate of upper tank recovery is less than a threshold, and/or the secondary heat (e.g. caused by TR2) is less than a threshold, this means that the power consumption of the UE has decreased, and therefore the UE is determined to the faulty in step 1808. If not, then the UE is determined to be normally operating in step 1806. Similarly, in step 1804, if the controller determines that the rate of lower tank recovery is less than a threshold, and/or the secondary heat (e.g. caused by TR1) is less than a threshold, this means that the power consumption of the LE has decreased, and therefore then the LE is determined to be faulty in step 1810. If not, then the LE is determined to be normally operating in step 1812.

A time versus temperature data plot example of a failing (e.g. increased resistance) heating elements is shown in FIG. 18B. When the heating elements are operating normally, the normal UTS reading is shown as 1814 and the normal LTS reading is shown as 1816. However, if the heating element are both failing, the abnormal UTS reading 1818 shows a delayed recovery time. Likewise, the abnormal LTS reading 1820 shows a delayed recovery time as well as a reduced secondary heat for both TR2 and TR1. The recovery times and peak values may differ slightly from those shown in FIG. 18B if just the UE is failing or just the LE is failing. Although not show in FIG. 18B, it is noted that if the UE completely fails (e.g. is open), then the UTS reading 1818 will not rise from Temp 1. Similarly, if the LE completely fails (e.g. is open), then the LTS reading 1820 will not rise from Temp 1.

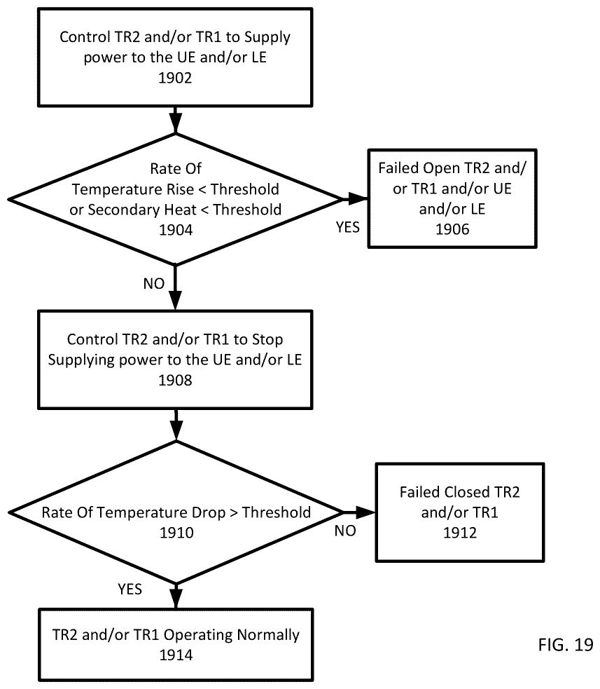

Regarding the detection of faulty switches, switches of the water heater control system can fail one of two ways. Failed ON means that the switch is stuck in the closed position. Failed OFF means that the switch is stuck in the open position. Detecting these failures is beneficial to ensuring proper operation and maintenance of the water heater. An example of switch failure detection is shown in FIG. 19 where the controller controls the switches to supply power to the heating elements in step 1902. If the rate of temperature rise is less than a threshold or the secondary heat is below a threshold in step 1904, then the switch or the heating element is determined to have failed OPEN in step 1906. If, not, however, the controller controls the switch to stop supplying power to the heating element in step 1908. If the rate of temperature drop is less than a threshold in step 1910, then the switch is determined to have failed CLOSED in step 1912. If, not, however, the switch is determined to be operating normally in step 1914.

When detecting faulty switches or heating elements in the open state as described above, limit switch operation should be taken into account to avoid false positives (e.g. incorrectly determining that a switch or a heating element is failed open). In one example, the controller can determine that the limit switch has opened when the UTS indicated an upper temperature above a limit threshold, and the LTS indicates that the electronic switches are not producing any secondary heat while it is being driven by the controller (e.g. no secondary heat is produced, because the limit switch has opened the circuit).

Regarding a faulty thermal path or faulty electrical connections, degrading thermal path (e.g. the circuit board is not firmly pressed against the tank wall), or a loose/corroded electrical connection (e.g. 220v power line is loose within the lug on the circuit board) is another problem that could arise. If such an issue is present, the secondary heat produced by the faulty device/connection generally increases resulting in an increased LTS reading. In this situation, the controller can compare the peak LTS measurement during two different heat cycles. For example, if this peak value increases by a certain amount between successive heat cycles, then controller determines that a degrading thermal path is present. In another example, the controller could compare the peak LTS measurement to a predetermined threshold of typical secondary heat. If the peak lower temperature measurement exceeds this predetermined threshold, the controller determines that a degrading thermal path is present. It is noted that a faulty electrical connection would produce similar results.

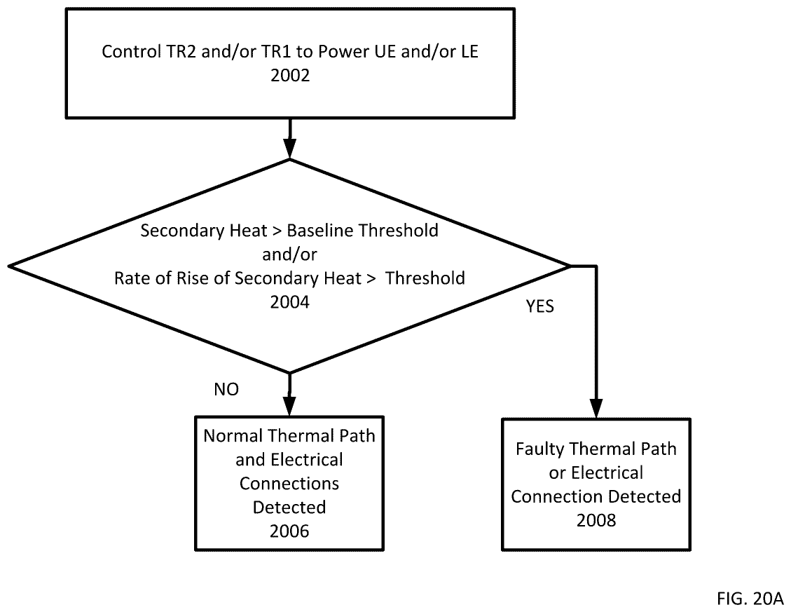

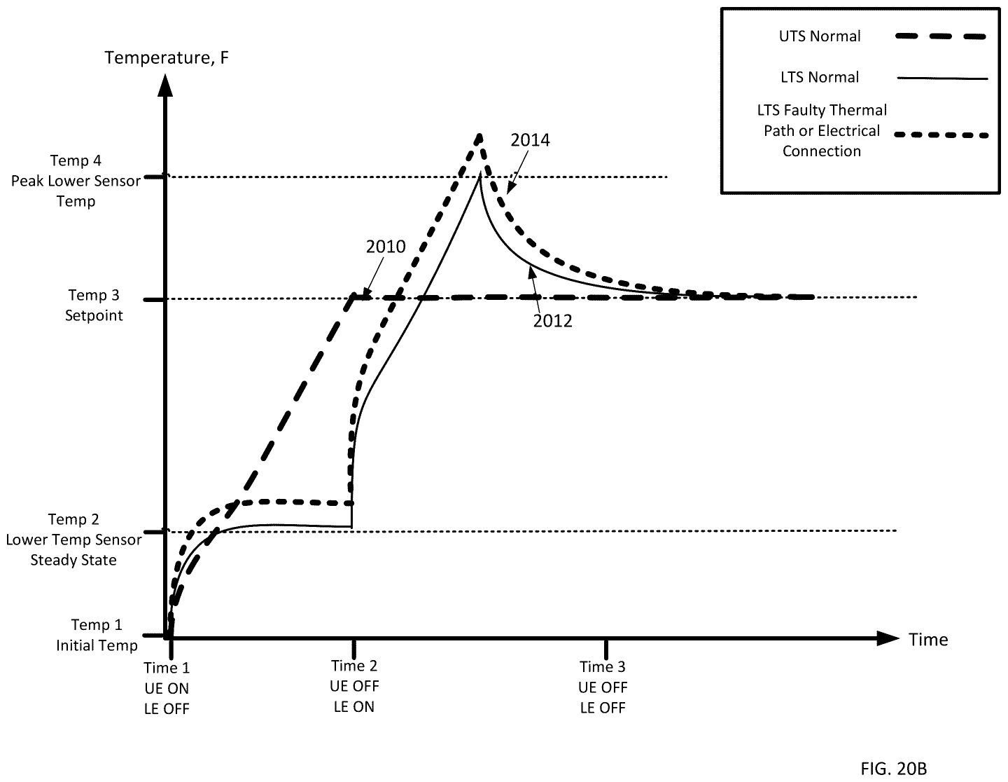

An example of detecting a faulty thermal path or electrical connection is shown in the flowchart of FIG. 20A, where in step 2002, the controller controls TR1 and TR2 to supply power to the heating elements. If in step 2004, the controller determines that the secondary heat is greater than the known baseline and/or the rate of rise of the secondary heat is greater than a threshold, a faulty thermal path or electrical connection is determined in step 2008. If not, however, then a normal thermal path and a normal electrical connection is determined in step 2006.

A time versus temperature example of a faulty thermal path or electrical connection is shown in FIG. 20B. When the thermal path and electrical connections are normal, the normal UTS reading is shown as 2010 and the normal LTS reading is shown as 2012. However, if there is a faulty thermal path or electrical connection, the abnormal LTS reading 2014 shows increased secondary heat. For example, if there is a faulty thermal path, heat produced by both TR1 and TR2 cannot dissipate efficiently and contributes to the increase in secondary heat shown by 2014. In another example, if there is a faulty electrical connection, the additional heat caused by the faulty electrical connections contributes to the increase in secondary heat shown by 2014.

In general, if a fault is detected in either of cases described above, numerous solutions could be implemented. In one example, an alert could be output to the user or a maintenance technician. In another example, operation of the water heater could be modified to compensate for the fault without turning OFF the elements completely. For example, if a degrading thermal path or heating element is detected, the power applied to these elements may be decreased to a level (e.g. 50%) that reduces their watt density thereby slowing down their deterioration and avoiding or at least prolonging their ultimate failure. The system can limp along at reduced performance. The theory being that a heating element operating at a reduced power is better than turning OFF the heating elements completely when a fault occurs.

The following are aspects of the invention:
1. A water heater comprising:
a tank configured to store water to be heated, the tank having a wall with an external surface and an internal surface defining an interior;
a circuit board mounted to the external surface of the tank, the circuit board including a thermal path for conducting heat through the circuit board, the thermal path of the circuit board being thermally coupled to the external surface of the tank;
a heating element mounted to the wall of the tank and extending into the interior of the tank;
an electronic switch mounted to the circuit board and electronically coupled to the heating element, the electronic switch being thermally coupled to the thermal path of the circuit board so that heat generated by the electronic switch is transferred along the thermal path from the electronic switch, through the thermal path of the circuit board, and to the wall of the tank; and
a temperature sensor thermally coupled to the circuit board,
wherein the temperature sensor is positioned to sense a temperature of the thermal path relating to a temperature of the electronic switch and relating to a temperature of water stored in the tank.
2. The water heater of aspect 1, wherein the circuit board is a thermally conductive circuit board.
3. The water heater of aspect 1, wherein the circuit board is releasably mounted to the external surface of the tank.
4. The water heater of aspect 3, further comprising a biased retainer positioned to releasably mount the circuit board to the external surface of the tank.
5. The water heater of aspect 1, further comprising plural heating elements and plural electronic switches, each of the heating elements being electronically coupled to at least one of the electronic switches.
6. The water heater of aspect 5, one of the heating elements being mounted to an upper portion of the wall of the tank, and another one of the heating elements being mounted to a lower portion of the wall of the tank.
7. The water heater of aspect 1, further comprising a controller electrically coupled to the electronic switch and the temperature sensor, the controller being configured to control the electronic switch based on temperature signals received from the temperature sensor.
8. The water heater of aspect 7, wherein the temperature signals received by the controller from the temperature sensor correspond to a sensed temperature of the thermal path.
9. The water heater of aspect 7, wherein the temperature signals received by the controller from the temperature sensor correspond to a sensed temperature of the electronic switch.
10. The water heater of aspect 1, further comprising a second temperature sensor thermally coupled to the wall of the tank and configured to sense a temperature corresponding to a temperature of the wall of the tank and relating to a temperature of water stored in the tank.
11. The water heater of aspect 1, the temperature sensor being mounted to the circuit board, thermally coupled to the electronic switch, and configured to sense a temperature corresponding to a temperature of the electronic switch.
12. The water heater of aspect 1, the temperature sensor being a dual purpose temperature sensor thermally coupled to sense a temperature corresponding to a temperature of the wall of the tank and relating to a temperature of water stored in the tank, and thermally coupled to the electronic switch to sense a temperature corresponding to a temperature of the electronic switch.
13. The water heater of aspect 1, the circuit board comprising a thermally conductive support layer, a circuit layer, and a dielectric layer interposed between the thermally conductive support layer and the circuit layer.
14. The water heater of aspect 13, the thermal path of the circuit board extending through the thermally conductive support layer, the circuit layer, and the dielectric layer.
15. The water heater of aspect 1 further comprising a thermal interface between the circuit board and the wall of the tank to maintain thermal coupling between the thermal path of the circuit board and the wall of the tank.
16. The water heater of aspect 15, the thermal interface being selected from the group consisting of thermal grease, heat paste, thermal gel, thermal tape, thermal putty, thermal gap filler, thermal polymer and thermal adhesive.
17. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch;
wherein the controller is configured to control the electronic switch to modulate electrical power supplied to the heating element based on the set-point temperature and inputs received from the temperature sensor.
18. The water heater of aspect 17, wherein the temperature sensor is a lower temperature sensor positioned to sense a temperature of a lower portion of the wall of the tank, the water heater further comprising an upper temperature sensor positioned to sense a temperature of an upper portion of the wall of the tank, wherein at least one of the lower temperature sensor and the upper temperature sensor comprises a thermistor.
19. The water heater of aspect 17, wherein the electronic switch comprises a TRIAC.
20. The water heater of aspect 18, wherein each of the lower temperature sensor and the upper temperature sensor comprises a thermistor.
21. The water heater of aspect 17, wherein the controller is further configured to control the duty cycle of the electronic switch to modulate the electrical power supplied to the heating element during a heating cycle of the water heater.
22. The water heater of aspect 17, wherein the controller is further configured to determine the temperature of the lower portion of the wall of the tank based on a thermal conductance relationship indicating a temperature offset between the temperature of the thermal path of the circuit board and the temperature of the lower portion of the wall of the tank.
23. The water heater of aspect 17, wherein the controller is further configured to determine that the thermal path is faulty by:
comparing the temperature of the thermal path to a temperature threshold, and in response to the comparison indicating that the temperature of the thermal path is greater than the temperature threshold, controlling the electronic switch to adjust the modulation of the electrical power supplied to the heating element, or disabling the electronic switch; or
comparing a first temperature of the thermal path during a first heating cycle to a second temperature of the thermal path during a second heating cycle, and in response to the comparison indicating that a difference between the first temperature and the second temperature is greater than a threshold, controlling the electronic switch to adjust the modulation of the electrical power supplied to the heating element, or disabling the electronic switch.
24. The water heater of aspect 17, wherein the temperature sensor is a dual purpose temperature sensor thermally coupled to the wall of the tank to sense a temperature corresponding to a temperature of the wall of the tank and relating to a temperature of water stored in the tank, and thermally coupled to the electronic switch to sense a temperature corresponding to a temperature of the electronic switch.
25. The water heater of aspect 17, further comprising a tank wall temperature sensor thermally coupled to the wall of the tank, and configured to sense a temperature of the wall of the tank.
26. A water heater comprising:
a tank configured to store water to be heated, the tank having a wall defining an interior;
a circuit board removably mounted to the wall of the tank, the circuit board including a thermal path for conducting heat through the circuit board, the thermal path of the circuit board being thermally coupled to the external surface of the tank;
a temperature sensor mounted to the circuit board, the temperature sensor being positioned to sense a temperature of the thermal path of the circuit board relating to a temperature of the wall of the tank; and
a retainer positioned to removably mount the circuit board to the wall of the tank, the retainer being configured to press the circuit board against the wall of the tank and to maintain thermal coupling of the circuit board to the wall of the tank through the thermal path of the circuit board.
27. The water heater of aspect 26, the circuit board comprising a thermally conductive layer, a circuit layer, and a dielectric layer interposed between the thermally conductive layer and the circuit layer, the thermal path of the circuit board extending through the thermally conductive layer, the circuit layer, and the dielectric layer.
28. The water heater of aspect 26, wherein the retainer comprises a spring biased to press the circuit board against the wall of the tank.
29. The water heater of aspect 26, further comprising:
a circuit board housing at least partially covering the circuit board; wherein the retainer contacts the circuit board housing to press the circuit board against the wall of the tank.
30. The water heater of aspect 29, wherein the circuit board is affixed to the circuit board housing.
31. The water heater of aspect 30, further comprising:
   an adhesive adhering the circuit board to the circuit board housing, or an ultrasonic weld staking the circuit board to the circuit board housing, or an over-molding of the circuit board to form the circuit board housing, or mounting the circuit board housing to the circuit board using a screw, or snap-fitting the circuit board housing to the circuit board.
32. The water heater of aspect 29, wherein the retainer includes a spring clip that mates with one or more surfaces of the circuit board housing.
33. The water heater of aspect 26, further comprising a thermal interface interposed between the circuit board and the wall of the tank.
34. The water heater of aspect 33, the thermal interface being selected from the group consisting of thermal grease, heat paste, thermal gel, thermal tape, thermal putty, thermal gap filler, thermal polymer and thermal adhesive.
35. A method for controlling a water heater to heat water to a set-point temperature, the water heater including a tank having a wall configured to store water to be heated, a heating element extending into an interior of the tank, an electronic switch electronically coupled to the heating element and mounted to a circuit board having a thermal path for conducting heat through the circuit board, a temperature sensor thermally coupled to the circuit board, and a controller coupled to the temperature sensor and the electronic switch, the method comprising:
monitoring, by the controller, inputs received from the temperature sensor indicating a temperature of the thermal path of the circuit board;
monitoring, by the controller, inputs received for the set-point temperature; and
controlling, by the controller, the electronic switch to modulate electrical power supplied to the heating element during a heating cycle based on the monitored inputs.
36. The method of aspect 35, further comprising:
modulating, by the controller, during the heating cycle, a duty cycle of the electronic switch to adjust the power supplied to the heating element.
37. The method of aspect 35, further comprising:
determining, by the controller, the temperature of the wall of the tank or the temperature of water stored in the tank based on a thermal conductance relationship indicating a temperature offset between the temperature of the circuit board and a temperature of the wall of the tank.
38. The method of aspect 35, further comprising:
determining, by the controller, that the electronic switch is faulty by:
   comparing the temperature of the thermal path to a temperature threshold, and in response to the comparison indicating that the temperature of the thermal path is greater than the temperature threshold, controlling the electronic switch to adjust the modulation of the electrical power supplied to the heating element, or disabling the electronic switch; or comparing a first temperature of the thermal path during a first heating cycle to a second temperature of the thermal path during a second heating cycle, and in response to the comparison indicating that a difference between the first temperature and the second temperature is greater than a threshold, controlling the electronic switch to the adjust the modulation of the electrical power supplied to the heating element, or disabling the electronic switch.
39. A circuit board assembly configured for mounting to a water heater tank, the circuit board assembly comprising:
a circuit board subassembly including a circuit board having a thermal path for conducting heat through the circuit board and electronic components mounted to a surface of the circuit board, at least one of the electronic components being thermally coupled to the thermal path of the circuit board; and
a retainer configured to be engaged to the water heater and coupled to the circuit board subassembly, the retainer having a first portion positioned to engage a surface of the water heater tank and a second portion positioned to bias against a surface of the circuit board subassembly;
wherein when the retainer is engaging the water heater tank and biasing the circuit board subassembly, the first portion of the retainer is positioned to resist separation of the retainer from the water heater tank, the second portion of the retainer is positioned to resist separation of the circuit board subassembly from the water heater tank, and the bias of the retainer urges the circuit board subassembly toward the water heater tank to maintain thermal coupling between the water heater tank and the thermal path of the circuit board of the circuit board subassembly.
40. The circuit board assembly of aspect 39, the circuit board subassembly further including a housing mounted to the circuit board and enclosing the electronic components, wherein the second portion of the retainer is positioned to bias against the housing of the circuit board subassembly.
41. The circuit board assembly of aspect 39, the circuit board of the circuit board subassembly comprising a thermally conductive layer, a circuit layer, and a dielectric layer interposed between the thermally conductive layer and the circuit layer.
42. The circuit board assembly of aspect 41, the thermal path of the circuit board extending through the thermally conductive layer, the circuit layer, and the dielectric layer.
43. The circuit board assembly of aspect 39, wherein the thermal path of the circuit board is exposed to an exterior surface of the circuit board subassembly.
44. The circuit board assembly of aspect 39, wherein the at least one of the electronic components thermally coupled to the thermal path of the circuit board includes a temperature sensor.
45. The circuit board assembly of aspect 44, the temperature sensor being positioned to sense a temperature of the thermal path, the thermal path being positioned for thermal coupling to the water heater tank when the retainer of the circuit board assembly is engaged to the water heater tank and to the circuit board subassembly.
46. The circuit board assembly of aspect 39, the second portion of the retainer including a spring providing a spring bias when the retainer is engaged to the water heater tank and to the circuit board subassembly.
47. A water heater comprising:
a tank configured to store water to be heated, the tank having a wall defining an interior;
a circuit board mounted to the wall of the tank, the circuit board including a thermal path for conducting heat through the circuit board, the thermal path of the circuit board being thermally coupled to the external surface of the tank;
a temperature sensor mounted to the circuit board, the temperature sensor being positioned to sense a temperature of the thermal path of the circuit board relating to a temperature of the wall of the tank; and
a retainer positioned to removably mount the circuit board to the wall of the tank, the retainer being configured to press the circuit board against the wall of the tank and to maintain thermal coupling of the circuit board to the wall of the tank through the thermal path of the circuit board.
48. A water heater configured to detect a dry-fire condition, the water heater comprising:
a tank configured to store water to be heated, the tank having a wall defining an interior;
a heating element mounted to the wall of the tank and extending into the interior of the tank;
an electronic switch electronically coupled to the heating element;
a temperature sensor positioned to sense a temperature of the tank; and
a controller coupled to the temperature sensor and the electronic switch, the controller being configured to:
   control the electronic switch to modulate electrical power supplied to the heating element at a first power level determined to not damage the heating element when the heating element is not submerged in water,
   determine that the heating element is not submerged in water stored in the tank when the temperature sensed by the temperature sensor exceeds a magnitude threshold or a rate of change threshold, and
   reduce the first power level and prevent further operation of the heating element at a second power level higher than the first power level when the temperature sensed by the temperature sensor exceeds the magnitude threshold or the rate of change threshold.
49. The water heater of aspect 48, the water heater having plural heating elements, including an upper heating element and a lower heating element, plural electronic switches each electronically coupled to one of the heating elements, and plural temperature sensors including an upper temperature sensor and a lower temperature sensor, the controller being further configured to:
   control the electronic switch electronically coupled to the upper heating element to increase the electric power supplied to the upper heating element to the second power level when the upper temperature sensed by the upper temperature sensor does not exceed the magnitude threshold or the rate of change threshold.
50. The water heater of aspect 49, wherein the controller is further configured to ensure that a difference between the upper temperature sensed by the upper temperature sensor and the lower temperature sensed by the lower temperature sensor does not exceed a threshold.
51. A method for detecting a dry-fire condition in a water heater, the method comprising:
modulating electrical power supplied to a heating element in the water heater at a first power level determined to not damage the heating element when the heating element is not submerged in water;
determining that the heating element is not submerged in water stored in a tank of the water heater when the temperature sensed by a temperature sensor sensing a temperature of the tank wall exceeds a magnitude threshold or a rate of change threshold; and
reducing the first power level and preventing further operation of the heating element at a second power level higher than the first power level when the temperature sensed by the temperature sensor exceeds the magnitude threshold or the rate of change threshold.
52. A water heater configured to heat water to a set-point temperature, the water heater comprising:
a tank configured to store water to be heated, the tank having a wall defining an interior;
a heating element mounted to the wall of the tank and extending into the interior of the tank, the heating element configured to generate primary heat;
a circuit board mounted to the wall of the tank, the circuit board including a thermal path extending through the circuit board and thermally coupled to receive the primary heat;
an electronic switch mounted to the circuit board and electronically coupled to the heating element, the electronic switch capable of generating secondary heat and being thermally coupled to transfer the secondary heat to the thermal path;
a temperature sensor positioned to sense a temperature of the thermal path of the circuit board; and
a controller coupled to the temperature sensor and the electronic switch, the controller being configured to:
   determine that the temperature sensed by the temperature sensor corresponds to the secondary heat generated by the electronic switch when the temperature rises or falls at a rate greater than a rate of change threshold, and
   control the electronic switch to modulate electrical power supplied to the heating element based on inputs received from the temperature sensor such that the water stored in the tank reaches the set-point temperature, thereby compensating for the secondary heat.
53. The water heater of aspect 52 comprising plural heating elements and plural electronic switches, each of the electronic switches being electronically coupled to one of the heating elements, the controller being further configured to determine secondary heat generated by one of the electronic switches.
54. The water heater of aspect 53, the controller being further configured to determine secondary heat generated by another one of the electronic switches over plural cycles to determine a baseline of operation.
55. A method of heating water to a set-point temperature, the method comprising:
determining that a temperature sensed by a temperature sensor sensing a temperature of a thermal path of a circuit board corresponds to a primary heat of the water plus a secondary heat generated by an electronic switch mounted to the circuit board and electronically coupled to the heating element, and
subtracting the secondary heat from the primary heat, thereby compensating for the secondary heat.
56. A water heater comprising:
a tank configured to store water to be heated, the tank having a wall defining an interior;
an upper heating element and a lower heating element each mounted to the wall of the tank and extending into the interior of the tank;
a circuit board mounted to the wall of the tank, the circuit board including a thermal path extending through the circuit board;
an upper heating element electronic switch and a lower heating element electronic switch each mounted to the circuit board, each of the upper heating element electronic switch and the lower heating element electronic switch being thermally coupled to the thermal path of the circuit board and electronically coupled to the upper heating element and the lower heating element, respectively;
a lower temperature sensor positioned to sense a thermal path temperature of the thermal path of the circuit board;
an upper temperature sensor positioned to sense an upper temperature of an upper portion of the tank; and
a controller coupled to the lower temperature sensor, the upper temperature sensor, the upper heating element electronic switch, and the lower heating element electronic switch, the controller being configured to:
   when the thermal path temperature is decreasing below a desired set-point, control the lower heating element electronic switch to turn ON the lower heating element and modulate electrical power supplied to the lower heating element, and when the upper temperature reaches a threshold at or above the set-point, control the lower heating element electronic switch to turn OFF the lower heating element, thereby completing recovery of the set-point.
57. The water heater of aspect 56, the controller being further configured to:
   when the upper temperature is decreasing below a desired set-point, control the lower heating element electronic switch to turn OFF the lower heating element and control the upper heating element electronic switch to turn ON the upper heating element and modulate electrical power supplied to the upper heating element, and
   when the upper temperature reaches the desired set-point, control the upper heating element electronic switch to turn OFF the upper heating element and control the lower heating element electronic switch to turn ON the lower heating element and modulate electrical power supplied to the lower heating element.
58. A method of heating water in a water heater having upper and lower heating elements, upper and lower heating element electronic switches thermally coupled to a thermal path of a circuit board and electronically coupled to the upper and lower heating elements, respectively, a lower temperature sensor to sense a thermal path temperature of the thermal path, an upper temperature sensor to sense an upper temperature of an upper portion of a tank of the water heater, and a controller coupled to the upper and lower temperature sensors and to the upper and lower heating element electronic switches, the method comprising:
controlling the lower heating element electronic switch to turn ON the lower heating element and modulate electrical power supplied to the lower heating element when the thermal path temperature is decreasing below a desired set-point; and
controlling the lower heating element electronic switch to turn OFF the lower heating element when the upper temperature reaches a threshold at or above the set-point, thereby completing recovery of the set-point.
59. The method of aspect 58, including:
   when the upper temperature is decreasing below a desired set-point, controlling the lower heating element electronic switch to turn OFF the lower heating element and controlling the upper heating element electronic switch to turn ON the upper heating element and modulate electrical power supplied to the lower heating element, and
   when the upper temperature reaches the desired set-point, controlling the upper heating element electronic switch to turn OFF the upper heating element and controlling the lower heating element electronic switch to turn ON the lower heating element and modulate electrical power supplied to the lower heating element.
60. A water heater comprising:
a tank configured to store water to be heated, the tank having a wall defining an interior;
an upper heating element and a lower heating element each mounted to the wall of the tank and extending into the interior of the tank;
an upper temperature sensor positioned to sense an upper temperature of an upper portion of the tank;
a lower temperature sensor positioned to sense a lower temperature of a lower portion of the tank; and
a controller coupled to the upper and lower temperature sensors and configured to:
   drive the lower heating element and compare the upper temperature to the lower temperature,
   determine, from the comparison of the upper temperature and the lower temperature, that water circulation within the tank is occurring while driving the lower heating element, and
   reduce electrical power to the lower heating element to reduce the water circulation within the tank, or
   cycle electrical power between the upper and lower heating elements to compensate for the water circulation within the tank.
61. A water heater comprising:
a tank configured to store water to be heated, the tank having a wall defining an interior;
an upper heating element and a lower heating element each mounted to the wall of the tank and extending into the interior of the tank;
a circuit board mounted to the wall of the tank, the circuit board including a thermal path extending through the circuit board;
electronic switches each mounted to the circuit board and each electronically coupled to one of the upper and lower heating elements;
an upper temperature sensor positioned to sense an upper temperature of an upper portion of the tank;
a lower temperature sensor positioned to sense a thermal path temperature of the thermal path of the circuit board; and
a controller coupled to the upper and lower temperature sensors and to the electronic switches, wherein the controller is configured to:
   monitor the upper temperature sensed by the upper temperature sensor,
   monitor the lower temperature sensed by the lower temperature sensor,
   compare the upper temperature to a threshold temperature, when the lower temperature is rising, determine, from the comparison of the upper temperature and the threshold temperature, that water circulation within the tank due to heating of the water with the lower heating element is lowering the upper temperature below the threshold temperature, and
   control the electronic switches to reduce electrical power to the lower heating element to reduce the water circulation within the tank, or
   control the electronic switches to cycle electrical power between the upper and lower heating elements to compensate for the water circulation within the tank.
62. A method of reducing the effect of water circulation on the temperature of water delivered from a water heater, the water heater having upper and lower heating elements, upper and lower heating element electronic switches electronically coupled to the upper and lower heating elements, respectively, upper and lower temperature sensors, and a controller coupled to the upper and lower temperature sensors and to the upper and lower heating element electronic switches, the method comprising:
monitoring an upper temperature sensed by the upper temperature sensor;
monitoring a lower temperature sensed by the lower temperature sensor;
comparing the upper temperature to a threshold temperature;
when the lower temperature is rising, determining, from the comparison of the upper temperature and the threshold temperature, that water circulation within the water heater due to heating of the water with the lower heating element is lowering the upper temperature below the threshold temperature; and
controlling the lower heating element electronic switch to reduce electrical power to the lower heating element to reduce the water circulation within the tank, or
controlling the upper and lower heating element electronic switches to cycle electrical power between the upper and lower heating elements to compensate for the water circulation within the tank.
63. A water heater comprising:
a tank configured to store water to be heated, the tank having a wall defining an interior;
first and second heating elements mounted to the wall of the tank and extending into the interior of the tank;
a circuit board mounted to the wall of the tank, the circuit board including a thermal path extending through the circuit board;
first and second electronic switches each mounted to the circuit board, thermally coupled to the thermal path of the circuit board, and electronically coupled to the first and second heating elements, respectively;
a temperature sensor positioned to sense a temperature of the thermal path of the circuit board; and
a controller coupled to the temperature sensor and to the first and second electronic switches, the controller being configured to:
   control the first electronic switch to modulate electrical power supplied to the first heating element,
   determine whether the temperature of the thermal path sensed by the temperature sensor decreases a predetermined amount within a predetermined time after stopping the supply of electrical power to the first heating element, and
   when the temperature of the thermal path sensed by the temperature sensor decreases the predetermined amount within the predetermined time after stopping the supply of electrical power to the first heating element, validate that the first electronic switch is turned OFF, and control the second electronic switch to modulate electrical power supplied to the second heating element, thereby ensuring non-simultaneous supply of electrical power to the first and second heating elements.
64. The water heater of aspect 63, the controller being further configured to:
   determine whether the temperature of the thermal path sensed by the temperature sensor decreases a predetermined amount within a predetermined time after stopping the supply of electrical power to the second heating element, and
   when the temperature of the thermal path sensed by the temperature sensor decreases the predetermined amount within the predetermined time after stopping the supply of electrical power to the second heating element, validate that the second electronic switch is turned OFF, and control the first electronic switch to modulate electrical power supplied to the first heating element, thereby ensuring non-simultaneous supply of electrical power to the second and first heating elements.
65. The water heater of aspect 63, further comprising a third electronic switch electronically coupled to the first and second electronic switches, the controller being further configured to:
   control the first and second electronic switches to turn OFF; and
   control the third switch to supply electrical power to the first and second electronic switches until it is validated that the first electronic switch and the second electronic switch is turned OFF when the temperature of the thermal path sensed by the temperature sensor decreases a predetermined amount within a predetermined time after controlling the first and second electronic switches to turn OFF, thereby ensuring non-simultaneous supply of electrical power to the first and second heating elements.
66. The water heater of aspect 65, the controller being further configured to:
   control the first electronic switch to modulate electrical power supplied to the first heating element or the second electronic switch to modulate electrical power supplied to the second heating element while the third electronic switch is turned ON, determine whether the temperature of the thermal path sensed by the temperature sensor decreases a predetermined amount within a predetermined time after the third electronic switch is turned OFF, and
   when the temperature of the thermal path sensed by the temperature sensor decreases the predetermined amount within the predetermined time after the third electronic switch is turned OFF, validate that the third electronic switch is turned OFF.
67. A method of heating water in a water heater having first and second heating elements, a circuit board including a thermal path extending through the circuit board, first and second electronic switches each mounted to the circuit board, thermally coupled to the thermal path of the circuit board, and electronically coupled to the first and second heating elements, respectively, a temperature sensor positioned to sense a temperature of the thermal path of the circuit board, and a controller coupled to the temperature sensor and to the first and second electronic switches, the method comprising:
controlling the first electronic switch to modulate electrical power supplied to the first heating element;
determining whether the temperature of the thermal path sensed by the temperature sensor decreases a predetermined amount within a predetermined time after stopping the supply of electrical power to the first heating element; and
when the temperature of the thermal path sensed by the temperature sensor decreases the predetermined amount within the predetermined time after stopping the supply of electrical power to the first heating element, validating that the first electronic switch is turned OFF, and controlling the second electronic switch to modulate electrical power supplied to the second heating element, thereby ensuring non-simultaneous supply of electrical power to the first and second heating elements.
68. A water heater configured to heat water, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, wherein the controller is configured to:
   control the electronic switch to supply electrical power to the heating element,
   monitor secondary heat generated by the electronic switch based on the control of the electronic switch,
   determine a baseline based on the monitored secondary heat,
   compare the baseline to factory settings to ensure proper operation, thereby commissioning the water heater, and
   control the electronic switch to modulate electrical power supplied to the heating element based on the baseline.
69. A method of commissioning a water heater to heat water, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
   controlling the electronic switch to supply electrical power to the heating element;
   monitoring secondary heat generated by the electronic switch based on the control of the electronic switch;
   determining a baseline based on the monitored secondary heat;
   compare the baseline to factory settings to ensure proper operation, thereby commissioning the water heater; and
   controlling the electronic switch to modulate electrical power supplied to the heating element based on the baseline.
70. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, wherein the controller is configured to:
   control the electronic switch to modulate electrical power supplied to the heating element based on inputs received from the temperature sensor, the set-point temperature, and factory settings,
   monitor a performance of the water heater over a plurality of heating cycles based on the control of the electronic switch, perform machine learning over the plurality of heating cycles based on the monitored performance to adjust the factory settings, and
   control the electronic switch to modulate electrical power supplied to the heating element based on the adjusted factory settings.
71. The water heater of aspect 70, the controller being further configured to:
   monitor recovery performance of the water heater over a plurality of heating cycles based on the control of the electronic switch for recovery to the set-point temperature;
   perform machine learning over the plurality of heating cycles based on the monitored recovery performance to learn and refine secondary heat caused by the electronic switch; and
   control the electronic switch to modulate electrical power supplied to the heating element based on the refined secondary heat.
72. A method of adjusting a water heater to heat water to a set-point temperature, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element based on inputs received from the temperature sensor, the set-point temperature, and factory settings;
monitoring a performance of the water heater over a plurality of heating cycles based on the control of the electronic switch;
performing machine learning over the plurality of heating cycles based on the monitored performance to adjust the factory settings; and
controlling the electronic switch to modulate electrical power supplied to the heating element based on the adjusted factory settings.
73. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, the controller being configured to:
control the electronic switch to modulate electrical power supplied to the heating element based on inputs received from the temperature sensor and the set-point temperature, and maintain the power supplied to the heating element via the electronic
switch at a power level that ensures that the temperature of the thermal path does not exceed a threshold.
74. The water heater of aspect 73, the controller being further configured to adjust the duty cycle of the power supplied to the heating element.
75. The water heater of aspect 73, the controller being further configured to monitor secondary heat generated by the electronic switch.
76. A method of adjusting a water heater to heat water to a set-point temperature, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element based on inputs received from the temperature sensor and the set-point temperature, and
maintaining the power supplied to the heating element via the electronic switch at a power level that ensures that the temperature of the thermal path does not exceed a threshold.
77. A water heater configured to detect an underperforming or faulty heating element, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a thermal path temperature of the thermal path of the circuit board; and
a controller coupled to the temperature sensor and the electronic switch, the controller being configured to:
   control the electronic switch to modulate electrical power supplied to the heating element, and
   determine that the heating element is operating at a reduced capacity due to deterioration of the heating element when the thermal path temperature increases at a rate that is less than a predetermined rate of change threshold.
78. The water heater of aspect 77, the controller being further configured to:
   monitor secondary heat generated by the electronic switch, and determine that the heating element is operating at a reduced capacity based on a change in the secondary heat generated by the electronic switch.
79. A method of detecting an underperforming or faulty heating element in a water heater, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
   controlling the electronic switch to modulate electrical power supplied to the heating element; and
   determining that the heating element is operating at a reduced capacity due to deterioration of the heating element when the thermal path temperature increases at a rate that is less than a predetermined rate of change threshold; or
   determining that the heating element is operating at a reduced capacity due to deterioration of the heating element when a time that the thermal path temperature takes to reach a predetermined magnitude level is greater than a predetermined time threshold.
80. A water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board, thermally coupled to the thermal path of the circuit board, and electronically coupled to the heating element;
a temperature sensor positioned to sense a temperature of the thermal path of the circuit board; and
a controller coupled to the temperature sensor and the electronic switch, the controller being configured to:
   control the electronic switch to modulate electrical power supplied to the heating element,
   determine that the electronic switch is failed open or the heating element has failed when the temperature of the thermal path sensed by the temperature sensor does not increase a predetermined amount within a predetermined time after controlling the electronic switch to supply the electrical power to the heating element, thereby detecting failed operation of the electronic switch or the heating element, and
   determine that the electronic switch is failed closed when the temperature of the thermal path sensed by the temperature sensor does not decrease the predetermined amount within the predetermined time after stopping controlling the electronic switch to supply the electrical power to the heating element, thereby detecting failed operation of the electronic switch.
81. The water heater of aspect 80, the predetermined amount by which the temperature sensor increases or decreases being a predetermined temperature magnitude.
82. The water heater of aspect 80, the predetermined amount by which the temperature sensor increases or decreases being a predetermined rate of temperature change.
83. A method of detecting an underperforming or faulty electronic switch in a water heater, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
   controlling the electronic switch to modulate electrical power supplied to the heating element,
   determining that the electronic switch is failed open or the heating element has failed when the temperature of the thermal path sensed by the temperature sensor does not increase a predetermined amount within a predetermined time after controlling the electronic switch to supply the electrical power to the heating element, thereby detecting failed operation of the electronic switch or the heating element, and
   determining that the electronic switch is failed closed when the temperature of the thermal path sensed by the temperature sensor does not decrease the predetermined amount within the predetermined time after stopping controlling the electronic switch to supply the electrical power to the heating element, thereby detecting failed operation of the electronic switch.
84. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, the controller being configured to:
   control the electronic switch to modulate electrical power supplied to the heating element, and
   determine that the thermal path is deteriorated when the sensed temperature of the thermal path exceeds a magnitude threshold or a rate of change threshold.
85. The water heater of aspect 84, the controller being further configured to monitor secondary heat and determine that the thermal path is deteriorated when the secondary heat exceeds a magnitude threshold or a rate of change threshold.
86. A method of detecting underperformance in a water heater, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element, and
determining that the thermal path is deteriorated when the sensed temperature of the thermal path exceeds a magnitude threshold or a rate of change threshold.
87. A water heater comprising:
a tank configured to store water to be heated, the tank having a wall defining an interior;
a circuit board mounted to the wall of the tank, the circuit board including a thermal path for conducting heat through the circuit board, the thermal path of the circuit board being thermally coupled to the wall of the tank such that primary heat from water in the tank is transferred from the wall of the tank to the thermal path;
a heating element mounted to the wall of the tank and extending into the interior of the tank;
an electronic switch mounted to the circuit board and electronically coupled to the heating element, the electronic switch being thermally coupled to the thermal path of the circuit board such that secondary heat generated by the electronic switch is transferred from the electronic switch through the thermal path of the circuit board, and to the wall of the tank;
a temperature sensor thermally coupled to the thermal path of circuit board, the temperature sensor being positioned to sense a temperature of the thermal path including the primary heat and the secondary heat; and
a controller electronically coupled to the temperature sensor, the controller being configured to receive the temperature of the thermal path from the temperature sensor and to differentiate the secondary heat from the primary heat.
88. The water heater of aspect 87, the controller being further configured to differentiate the secondary heat from the primary heat based on a rate of change in the sensed temperature.
89. The water heater of aspect 88, wherein the controller is further configured to:
identify the heat as primary heat when the rate of change of the sensed temperature is less than a rate of change threshold, and identify the heat as secondary heat when the rate of change of the sensed temperature is greater than the rate of change threshold.
90. The water heater of aspect 88, wherein the controller is further configured to determine the rate of change immediately after the heating element is turned ON, or immediately after the heating element is turned OFF.
91. The water heater of aspect 87, the controller being further configured to differentiate the secondary heat from the primary heat based on whether or not a predetermined change in temperature occurs within a predetermined period of time.
92. The water heater of aspect 87, the controller being further configured to differentiate the secondary heat from the primary heat based on whether or not a predetermined period of time elapses before a predetermined change in temperature occurs.
93. The water heater of claim 56, the controller being further configured to:
   when the lower temperature sensor reaches a threshold at or below the set-point, and
   when the upper temperature sensor increases at or above the set-point temperature, or when the upper temperature sensor reaches a threshold above the set-point,
   then turn off the lower heating element.

As described in the flowcharts of FIGS. 9-20B, the water heater control system of the present disclosure provides a solution for solid-state control of an electric water heater. The solution efficiently controls the water heater to reach the desired SP temperature, conducts the heat produced by the solid-state switches away from the switches and to the water tank, and distinguishes between the heat of the water and secondary heat produced by the switching elements and electrical connections.

It will be understood that the terms and expressions used herein have the ordinary meaning as is accorded to such terms and expressions with respect to their corresponding respective areas of inquiry and study except where specific meanings have otherwise been set forth herein. For example, the term “coupled” as used herein refers to any logical, optical, physical or electrical connection, link or the like by which signals or light produced or supplied by one system element are imparted to another coupled element. Unless described otherwise, coupled elements or devices are not necessarily directly coupled or connected to one another and may be separated by intermediate components, elements or communication media that may modify, manipulate or carry the signals. Also, the term “coupled” can refer to direct or indirect mechanical or thermal connectedness. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount. The term “substantially” as used herein means the parameter value or the like

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

In the above detailed description, numerous specific details were set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed:

1. A water heater comprising:
a tank configured to store water to be heated, the tank having a wall with an external surface and an internal surface defining an interior;
a circuit board mounted to the external surface of the tank, the circuit board including a thermal path for conducting heat through the circuit board, the thermal path of the circuit board being thermally coupled to the external surface of the tank;
a heating element mounted to the wall of the tank and extending into the interior of the tank;
an electronic switch mounted to the circuit board and electronically coupled to the heating element, the electronic switch being thermally coupled to the thermal path of the circuit board so that heat generated by the electronic switch is transferred along the thermal path from the electronic switch, through the thermal path of the circuit board, and to the wall of the tank; and
a temperature sensor thermally coupled to the circuit board,
wherein the temperature sensor is positioned to sense a temperature of the thermal path relating to a temperature of the electronic switch and relating to a temperature of water stored in the tank.

2. The water heater of claim 1, wherein the circuit board is a thermally conductive circuit board.

3. The water heater of claim 1, wherein the circuit board is releasably mounted to the external surface of the tank.

4. The water heater of claim 3, further comprising a biased retainer positioned to releasably mount the circuit board to the external surface of the tank.

5. The water heater of claim 1, further comprising plural heating elements and plural electronic switches, each of the heating elements being electronically coupled to at least one of the electronic switches.

6. The water heater of claim 5, one of the heating elements being mounted to an upper portion of the wall of the tank, and another one of the heating elements being mounted to a lower portion of the wall of the tank.

7. The water heater of claim 1, further comprising a controller electrically coupled to the electronic switch and the temperature sensor, the controller being configured to control the electronic switch based on temperature signals received from the temperature sensor.

8. The water heater of claim 7, wherein the temperature signals received by the controller from the temperature sensor correspond to a sensed temperature of the thermal path.

9. The water heater of claim 7, wherein the temperature signals received by the controller from the temperature sensor correspond to a sensed temperature of the electronic switch.

10. The water heater of claim 1, further comprising a second temperature sensor thermally coupled to the wall of the tank and configured to sense a temperature corresponding to a temperature of the wall of the tank and relating to a temperature of water stored in the tank.

11. The water heater of claim 1, the temperature sensor being mounted to the circuit board, thermally coupled to the electronic switch, and configured to sense a temperature corresponding to a temperature of the electronic switch.

12. The water heater of claim 1, the temperature sensor being a dual purpose temperature sensor thermally coupled to sense a temperature corresponding to a temperature of the wall of the tank and relating to a temperature of water stored in the tank, and thermally coupled to the electronic switch to sense a temperature corresponding to a temperature of the electronic switch.

13. The water heater of claim 1, the circuit board comprising a thermally conductive support layer, a circuit layer, and a dielectric layer interposed between the thermally conductive support layer and the circuit layer.

14. The water heater of claim 13, the thermal path of the circuit board extending through the thermally conductive support layer, the circuit layer, and the dielectric layer.

15. The water heater of claim 1 further comprising a thermal interface between the circuit board and the wall of the tank to maintain thermal coupling between the thermal path of the circuit board and the wall of the tank.

16. The water heater of claim 15, the thermal interface being selected from the group consisting of thermal grease, heat paste, thermal gel, thermal tape, thermal putty, thermal gap filler, thermal polymer and thermal adhesive.

17. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch;
wherein the controller is configured to control the electronic switch to modulate electrical power supplied to the heating element based on the set-point temperature and inputs received from the temperature sensor.

18. The water heater of claim 17, wherein the temperature sensor is a lower temperature sensor positioned to sense a temperature of a lower portion of the wall of the tank, the water heater further comprising an upper temperature sensor positioned to sense a temperature of an upper portion of the wall of the tank, wherein at least one of the lower temperature sensor and the upper temperature sensor comprises a thermistor.

19. The water heater of claim 17, wherein the electronic switch comprises a TRIAC.

20. The water heater of claim 18, wherein each of the lower temperature sensor and the upper temperature sensor comprises a thermistor.

21. The water heater of claim 17, wherein the controller is further configured to control the duty cycle of the electronic switch to modulate the electrical power supplied to the heating element during a heating cycle of the water heater.

22. The water heater of claim 17, wherein the controller is further configured to determine the temperature of the lower portion of the wall of the tank based on a thermal conductance relationship indicating a temperature offset between the temperature of the thermal path of the circuit board and the temperature of the lower portion of the wall of the tank.

23. The water heater of claim 17, wherein the controller is further configured to determine that the thermal path is faulty by:
comparing the temperature of the thermal path to a temperature threshold, and in response to the comparison indicating that the temperature of the thermal path is greater than the temperature threshold, controlling the electronic switch to adjust the modulation of the electrical power supplied to the heating element, or disabling the electronic switch; or
comparing a first temperature of the thermal path during a first heating cycle to a second temperature of the thermal path during a second heating cycle, and in response to the comparison indicating that a difference between the first temperature and the second temperature is greater than a threshold, controlling the electronic switch to adjust the modulation of the electrical power supplied to the heating element, or disabling the electronic switch.

24. The water heater of claim 17, wherein the temperature sensor is a dual purpose temperature sensor thermally coupled to the wall of the tank to sense a temperature corresponding to a temperature of the wall of the tank and relating to a temperature of water stored in the tank, and thermally coupled to the electronic switch to sense a temperature corresponding to a temperature of the electronic switch.

25. The water heater of claim 17, further comprising a tank wall temperature sensor thermally coupled to the wall of the tank, and configured to sense a temperature of the wall of the tank.

26. A water heater comprising:
a tank configured to store water to be heated, the tank having a wall defining an interior;
a circuit board removably mounted to the wall of the tank, the circuit board including a thermal path for conducting heat through the circuit board, the thermal path of the circuit board being thermally coupled to the external surface of the tank;
a temperature sensor mounted to the circuit board, the temperature sensor being positioned to sense a temperature of the thermal path of the circuit board relating to a temperature of the wall of the tank; and
a retainer positioned to removably mount the circuit board to the wall of the tank, the retainer being configured to press the circuit board against the wall of the tank and to maintain thermal coupling of the circuit board to the wall of the tank through the thermal path of the circuit board.

27. The water heater of claim 26, the circuit board comprising a thermally conductive layer, a circuit layer, and a dielectric layer interposed between the thermally conductive layer and the circuit layer, the thermal path of the circuit board extending through the thermally conductive layer, the circuit layer, and the dielectric layer.

28. The water heater of claim 26, wherein the retainer comprises a spring biased to press the circuit board against the wall of the tank.

29. The water heater of claim 26, further comprising:
a circuit board housing at least partially covering the circuit board;
wherein the retainer contacts the circuit board housing to press the circuit board against the wall of the tank.

30. The water heater of claim 29, wherein the circuit board is affixed to the circuit board housing.

31. The water heater of claim 30, further comprising:
an adhesive adhering the circuit board to the circuit board housing, or an ultrasonic weld staking the circuit board to the circuit board housing, or an over-molding of the circuit board to form the circuit board housing, or mounting the circuit board housing to the circuit board using a screw, or snap-fitting the circuit board housing to the circuit board.

32. The water heater of claim 29, wherein the retainer includes a spring clip that mates with one or more surfaces of the circuit board housing.

33. The water heater of claim 26, further comprising a thermal interface interposed between the circuit board and the wall of the tank.

34. The water heater of claim 33, the thermal interface being selected from the group consisting of thermal grease, heat paste, thermal gel, thermal tape, thermal putty, thermal gap filler, thermal polymer and thermal adhesive.

35. A method for controlling a water heater to heat water to a set-point temperature, the water heater including a tank having a wall configured to store water to be heated, a heating element extending into an interior of the tank, an electronic switch electronically coupled to the heating element and mounted to a circuit board having a thermal path for conducting heat through the circuit board, a temperature sensor thermally coupled to the circuit board, and a controller coupled to the temperature sensor and the electronic switch, the method comprising:
monitoring, by the controller, inputs received from the temperature sensor indicating a temperature of the thermal path of the circuit board;
monitoring, by the controller, inputs received for the set-point temperature; and
controlling, by the controller, the electronic switch to modulate electrical power supplied to the heating element during a heating cycle based on the monitored inputs.

36. The method of claim 35, further comprising:
modulating, by the controller, during the heating cycle, a duty cycle of the electronic switch to adjust the power supplied to the heating element.

37. The method of claim 35, further comprising:
determining, by the controller, the temperature of the wall of the tank or the temperature of water stored in the tank based on a thermal conductance relationship indicating a temperature offset between the temperature of the circuit board and a temperature of the wall of the tank.

38. The method of claim 35, further comprising:
determining, by the controller, that the electronic switch is faulty by:
comparing the temperature of the thermal path to a temperature threshold, and in response to the comparison indicating that the temperature of the thermal path is greater than the temperature threshold, controlling the electronic switch to adjust the modulation of the electrical power supplied to the heating element, or disabling the electronic switch; or
comparing a first temperature of the thermal path during a first heating cycle to a second temperature of the thermal path during a second heating cycle, and in response to the comparison indicating that a difference between the first temperature and the second temperature is greater than a threshold, controlling the electronic switch to the adjust the modulation of the electrical power supplied to the heating element, or disabling the electronic switch.

39. A circuit board assembly configured for mounting to a water heater tank, the circuit board assembly comprising:
a circuit board subassembly including a circuit board having a thermal path for conducting heat through the circuit board and electronic components mounted to a surface of the circuit board, at least one of the electronic components being thermally coupled to the thermal path of the circuit board; and
a retainer configured to be engaged to the water heater and coupled to the circuit board subassembly, the retainer having a first portion positioned to engage a surface of the water heater tank and a second portion positioned to bias against a surface of the circuit board subassembly;
wherein when the retainer is engaging the water heater tank and biasing the circuit board subassembly, the first portion of the retainer is positioned to resist separation of the retainer from the water heater tank, the second portion of the retainer is positioned to resist separation of the circuit board subassembly from the water heater tank, and the bias of the retainer urges the circuit board subassembly toward the water heater tank to maintain thermal coupling between the water heater tank and the thermal path of the circuit board of the circuit board subassembly.

40. The circuit board assembly of claim 39, the circuit board subassembly further including a housing mounted to the circuit board and enclosing the electronic components, wherein the second portion of the retainer is positioned to bias against the housing of the circuit board subassembly.

41. The circuit board assembly of claim 39, the circuit board of the circuit board subassembly comprising a thermally conductive layer, a circuit layer, and a dielectric layer interposed between the thermally conductive layer and the circuit layer.

42. The circuit board assembly of claim 41, the thermal path of the circuit board extending through the thermally conductive layer, the circuit layer, and the dielectric layer.

43. The circuit board assembly of claim 39, wherein the thermal path of the circuit board is exposed to an exterior surface of the circuit board subassembly.

44. The circuit board assembly of claim 39, wherein the at least one of the electronic components thermally coupled to the thermal path of the circuit board includes a temperature sensor.

45. The circuit board assembly of claim 44, the temperature sensor being positioned to sense a temperature of the thermal path, the thermal path being positioned for thermal coupling to the water heater tank when the retainer of the circuit board assembly is engaged to the water heater tank and to the circuit board subassembly.

46. The circuit board assembly of claim 39, the second portion of the retainer including a spring providing a spring bias when the retainer is engaged to the water heater tank and to the circuit board subassembly.

47. A water heater comprising:
a tank configured to store water to be heated, the tank having a wall defining an interior;
a circuit board mounted to the wall of the tank, the circuit board including a thermal path for conducting heat through the circuit board, the thermal path of the circuit board being thermally coupled to the external surface of the tank;
a temperature sensor mounted to the circuit board, the temperature sensor being positioned to sense a temperature of the thermal path of the circuit board relating to a temperature of the wall of the tank; and
a retainer positioned to removably mount the circuit board to the wall of the tank, the retainer being configured to press the circuit board against the wall of the tank and to maintain thermal coupling of the circuit board to the wall of the tank through the thermal path of the circuit board.

48. A water heater configured to detect a dry-fire condition, the water heater comprising:
a tank configured to store water to be heated, the tank having a wall defining an interior;
a heating element mounted to the wall of the tank and extending into the interior of the tank;
an electronic switch electronically coupled to the heating element;
a temperature sensor positioned to sense a temperature of the tank; and
a controller coupled to the temperature sensor and the electronic switch, the controller being configured to:
control the electronic switch to modulate electrical power supplied to the heating element at a first power level determined to not damage the heating element when the heating element is not submerged in water,
determine that the heating element is not submerged in water stored in the tank when the temperature sensed by the temperature sensor exceeds a magnitude threshold or a rate of change threshold, and
reduce the first power level and prevent further operation of the heating element at a second power level higher than the first power level when the temperature sensed by the temperature sensor exceeds the magnitude threshold or the rate of change threshold.

49. The water heater of claim 48, the water heater having plural heating elements, including an upper heating element and a lower heating element, plural electronic switches each electronically coupled to one of the heating elements, and plural temperature sensors including an upper temperature sensor and a lower temperature sensor, the controller being further configured to:
control the electronic switch electronically coupled to the upper heating element to increase the electric power supplied to the upper heating element to the second power level when the upper temperature sensed by the upper temperature sensor does not exceed the magnitude threshold or the rate of change threshold.

50. The water heater of claim 49, wherein the controller is further configured to ensure that a difference between the upper temperature sensed by the upper temperature sensor and the lower temperature sensed by the lower temperature sensor does not exceed a threshold.

51. A method for detecting a dry-fire condition in a water heater, the method comprising:
modulating electrical power supplied to a heating element in the water heater at a first power level determined to not damage the heating element when the heating element is not submerged in water;
determining that the heating element is not submerged in water stored in a tank of the water heater when the temperature sensed by a temperature sensor sensing a temperature of the tank wall exceeds a magnitude threshold or a rate of change threshold; and
reducing the first power level and preventing further operation of the heating element at a second power level higher than the first power level when the temperature sensed by the temperature sensor exceeds the magnitude threshold or the rate of change threshold.

52. A water heater configured to heat water to a set-point temperature, the water heater comprising:
a tank configured to store water to be heated, the tank having a wall defining an interior;
a heating element mounted to the wall of the tank and extending into the interior of the tank, the heating element configured to generate primary heat;
a circuit board mounted to the wall of the tank, the circuit board including a thermal path extending through the circuit board and thermally coupled to receive the primary heat;
an electronic switch mounted to the circuit board and electronically coupled to the heating element, the electronic switch capable of generating secondary heat and being thermally coupled to transfer the secondary heat to the thermal path;
a temperature sensor positioned to sense a temperature of the thermal path of the circuit board; and
a controller coupled to the temperature sensor and the electronic switch, the controller being configured to:
determine that the temperature sensed by the temperature sensor corresponds to the secondary heat generated by the electronic switch when the temperature rises or falls at a rate greater than a rate of change threshold, and
control the electronic switch to modulate electrical power supplied to the heating element based on inputs received from the temperature sensor such that the water stored in the tank reaches the set-point temperature, thereby compensating for the secondary heat.

53. The water heater of claim 52 comprising plural heating elements and plural electronic switches, each of the electronic switches being electronically coupled to one of the heating elements, the controller being further configured to determine secondary heat generated by one of the electronic switches.

54. The water heater of claim 53, the controller being further configured to determine secondary heat generated by another one of the electronic switches over plural cycles to determine a baseline of operation.

55. A method of heating water to a set-point temperature, the method comprising:
determining that a temperature sensed by a temperature sensor sensing a temperature of a thermal path of a circuit board corresponds to a primary heat of the water plus a secondary heat generated by an electronic switch mounted to the circuit board and electronically coupled to the heating element, and
subtracting the secondary heat from the primary heat, thereby compensating for the secondary heat.

56. A water heater comprising:
a tank configured to store water to be heated, the tank having a wall defining an interior;
an upper heating element and a lower heating element each mounted to the wall of the tank and extending into the interior of the tank;
a circuit board mounted to the wall of the tank, the circuit board including a thermal path extending through the circuit board;
an upper heating element electronic switch and a lower heating element electronic switch each mounted to the circuit board, each of the upper heating element electronic switch and the lower heating element electronic switch being thermally coupled to the thermal path of the circuit board and electronically coupled to the upper heating element and the lower heating element, respectively;
a lower temperature sensor positioned to sense a thermal path temperature of the thermal path of the circuit board;
an upper temperature sensor positioned to sense an upper temperature of an upper portion of the tank; and
a controller coupled to the lower temperature sensor, the upper temperature sensor, the upper heating element electronic switch, and the lower heating element electronic switch, the controller being configured to:
when the thermal path temperature is decreasing below a desired set-point, control the lower heating element electronic switch to turn ON the lower heating element and modulate electrical power supplied to the lower heating element, and
when the upper temperature reaches a threshold at or above the set-point, control the lower heating element electronic switch to turn OFF the lower heating element, thereby completing recovery of the set-point.

57. The water heater of claim 56, the controller being further configured to:
when the upper temperature is decreasing below a desired set-point, control the lower heating element electronic switch to turn OFF the lower heating element and control the upper heating element electronic switch to turn ON the upper heating element and modulate electrical power supplied to the upper heating element, and
when the upper temperature reaches the desired set-point, control the upper heating element electronic switch to turn OFF the upper heating element and control the lower heating element electronic switch to turn ON the lower heating element and modulate electrical power supplied to the lower heating element.

58. A method of heating water in a water heater having upper and lower heating elements, upper and lower heating element electronic switches thermally coupled to a thermal path of a circuit board and electronically coupled to the upper and lower heating elements, respectively, a lower temperature sensor to sense a thermal path temperature of the thermal path, an upper temperature sensor to sense an upper temperature of an upper portion of a tank of the water heater, and a controller coupled to the upper and lower temperature sensors and to the upper and lower heating element electronic switches, the method comprising:
controlling the lower heating element electronic switch to turn ON the lower heating element and modulate electrical power supplied to the lower heating element when the thermal path temperature is decreasing below a desired set-point; and
controlling the lower heating element electronic switch to turn OFF the lower heating element when the upper temperature reaches a threshold at or above the set-point, thereby completing recovery of the set-point.

59. The method of claim 58, including:
when the upper temperature is decreasing below a desired set-point, controlling the lower heating element electronic switch to turn OFF the lower heating element and controlling the upper heating element electronic switch to turn ON the upper heating element and modulate electrical power supplied to the lower heating element, and
when the upper temperature reaches the desired set-point, controlling the upper heating element electronic switch to turn OFF the upper heating element and controlling the lower heating element electronic switch to turn ON the lower heating element and modulate electrical power supplied to the lower heating element.

60. A water heater comprising:
a tank configured to store water to be heated, the tank having a wall defining an interior;
an upper heating element and a lower heating element each mounted to the wall of the tank and extending into the interior of the tank;
an upper temperature sensor positioned to sense an upper temperature of an upper portion of the tank;
a lower temperature sensor positioned to sense a lower temperature of a lower portion of the tank; and
a controller coupled to the upper and lower temperature sensors and configured to:
drive the lower heating element and compare the upper temperature to the lower temperature,
determine, from the comparison of the upper temperature and the lower temperature, that water circulation within the tank is occurring while driving the lower heating element, and
reduce electrical power to the lower heating element to reduce the water circulation within the tank, or
cycle electrical power between the upper and lower heating elements to compensate for the water circulation within the tank.

61. A water heater comprising:
a tank configured to store water to be heated, the tank having a wall defining an interior;
an upper heating element and a lower heating element each mounted to the wall of the tank and extending into the interior of the tank;
a circuit board mounted to the wall of the tank, the circuit board including a thermal path extending through the circuit board;
electronic switches each mounted to the circuit board and each electronically coupled to one of the upper and lower heating elements;
an upper temperature sensor positioned to sense an upper temperature of an upper portion of the tank;
a lower temperature sensor positioned to sense a thermal path temperature of the thermal path of the circuit board; and
a controller coupled to the upper and lower temperature sensors and to the electronic switches, wherein the controller is configured to:
monitor the upper temperature sensed by the upper temperature sensor,
monitor the lower temperature sensed by the lower temperature sensor,
compare the upper temperature to a threshold temperature,
when the lower temperature is rising, determine, from the comparison of the upper temperature and the threshold temperature, that water circulation within the tank due to heating of the water with the lower heating element is lowering the upper temperature below the threshold temperature, and
control the electronic switches to reduce electrical power to the lower heating element to reduce the water circulation within the tank, or
control the electronic switches to cycle electrical power between the upper and lower heating elements to compensate for the water circulation within the tank.

62. A method of reducing the effect of water circulation on the temperature of water delivered from a water heater, the water heater having upper and lower heating elements, upper and lower heating element electronic switches electronically coupled to the upper and lower heating elements, respectively, upper and lower temperature sensors, and a controller coupled to the upper and lower temperature sensors and to the upper and lower heating element electronic switches, the method comprising:
monitoring an upper temperature sensed by the upper temperature sensor;
monitoring a lower temperature sensed by the lower temperature sensor;
comparing the upper temperature to a threshold temperature;
when the lower temperature is rising, determining, from the comparison of the upper temperature and the threshold temperature, that water circulation within the water heater due to heating of the water with the lower heating element is lowering the upper temperature below the threshold temperature; and
controlling the lower heating element electronic switch to reduce electrical power to the lower heating element to reduce the water circulation within the tank, or
controlling the upper and lower heating element electronic switches to cycle electrical power between the upper and lower heating elements to compensate for the water circulation within the tank.

63. A water heater comprising:
a tank configured to store water to be heated, the tank having a wall defining an interior;
first and second heating elements mounted to the wall of the tank and extending into the interior of the tank;
a circuit board mounted to the wall of the tank, the circuit board including a thermal path extending through the circuit board;
first and second electronic switches each mounted to the circuit board, thermally coupled to the thermal path of the circuit board, and electronically coupled to the first and second heating elements, respectively;
a temperature sensor positioned to sense a temperature of the thermal path of the circuit board; and
a controller coupled to the temperature sensor and to the first and second electronic switches, the controller being configured to:
control the first electronic switch to modulate electrical power supplied to the first heating element,
determine whether the temperature of the thermal path sensed by the temperature sensor decreases a predetermined amount within a predetermined time after stopping the supply of electrical power to the first heating element, and
when the temperature of the thermal path sensed by the temperature sensor decreases the predetermined amount within the predetermined time after stopping the supply of electrical power to the first heating element, validate that the first electronic switch is turned OFF, and control the second electronic switch to modulate electrical power supplied to the second heating element, thereby ensuring non-simultaneous supply of electrical power to the first and second heating elements.

64. The water heater of claim 63, the controller being further configured to:
determine whether the temperature of the thermal path sensed by the temperature sensor decreases a predetermined amount within a predetermined time after stopping the supply of electrical power to the second heating element, and
when the temperature of the thermal path sensed by the temperature sensor decreases the predetermined amount within the predetermined time after stopping the supply of electrical power to the second heating element, validate that the second electronic switch is turned OFF, and control the first electronic switch to modulate electrical power supplied to the first heating element, thereby ensuring non-simultaneous supply of electrical power to the second and first heating elements.

65. The water heater of claim 63, further comprising a third electronic switch electronically coupled to the first and second electronic switches, the controller being further configured to:
control the first and second electronic switches to turn OFF; and
control the third switch to supply electrical power to the first and second electronic switches until it is validated that the first electronic switch and the second electronic switch is turned OFF when the temperature of the thermal path sensed by the temperature sensor decreases a predetermined amount within a predetermined time after controlling the first and second electronic switches to turn OFF, thereby ensuring non-simultaneous supply of electrical power to the first and second heating elements.

66. The water heater of claim 65, the controller being further configured to:
control the first electronic switch to modulate electrical power supplied to the first heating element or the second electronic switch to modulate electrical power supplied to the second heating element while the third electronic switch is turned ON,
determine whether the temperature of the thermal path sensed by the temperature sensor decreases a predetermined amount within a predetermined time after the third electronic switch is turned OFF, and
when the temperature of the thermal path sensed by the temperature sensor decreases the predetermined amount within the predetermined time after the third electronic switch is turned OFF, validate that the third electronic switch is turned OFF.

67. A method of heating water in a water heater having first and second heating elements, a circuit board including a thermal path extending through the circuit board, first and second electronic switches each mounted to the circuit board, thermally coupled to the thermal path of the circuit board, and electronically coupled to the first and second heating elements, respectively, a temperature sensor positioned to sense a temperature of the thermal path of the circuit board, and a controller coupled to the temperature sensor and to the first and second electronic switches, the method comprising:
controlling the first electronic switch to modulate electrical power supplied to the first heating element;
determining whether the temperature of the thermal path sensed by the temperature sensor decreases a predetermined amount within a predetermined time after stopping the supply of electrical power to the first heating element; and
when the temperature of the thermal path sensed by the temperature sensor decreases the predetermined amount within the predetermined time after stopping the supply of electrical power to the first heating element, validating that the first electronic switch is turned OFF, and controlling the second electronic switch to modulate electrical power supplied to the second heating element, thereby ensuring non-simultaneous supply of electrical power to the first and second heating elements.

68. A water heater configured to heat water, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, wherein the controller is configured to:
control the electronic switch to supply electrical power to the heating element,
monitor secondary heat generated by the electronic switch based on the control of the electronic switch,
determine a baseline based on the monitored secondary heat,
compare the baseline to factory settings to ensure proper operation, thereby commissioning the water heater, and
control the electronic switch to modulate electrical power supplied to the heating element based on the baseline.

69. A method of commissioning a water heater to heat water, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to supply electrical power to the heating element;
monitoring secondary heat generated by the electronic switch based on the control of the electronic switch;
determining a baseline based on the monitored secondary heat;
compare the baseline to factory settings to ensure proper operation, thereby commissioning the water heater; and
controlling the electronic switch to modulate electrical power supplied to the heating element based on the baseline.

70. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, wherein the controller is configured to:
control the electronic switch to modulate electrical power supplied to the heating element based on inputs received from the temperature sensor, the set-point temperature, and factory settings,
monitor a performance of the water heater over a plurality of heating cycles based on the control of the electronic switch, perform machine learning over the plurality of heating cycles based on the monitored performance to adjust the factory settings, and
control the electronic switch to modulate electrical power supplied to the heating element based on the adjusted factory settings.

71. The water heater of claim 70, the controller being further configured to:
monitor recovery performance of the water heater over a plurality of heating cycles based on the control of the electronic switch for recovery to the set-point temperature;
perform machine learning over the plurality of heating cycles based on the monitored recovery performance to learn and refine secondary heat caused by the electronic switch; and
control the electronic switch to modulate electrical power supplied to the heating element based on the refined secondary heat.

72. A method of adjusting a water heater to heat water to a set-point temperature, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element based on inputs received from the temperature sensor, the set-point temperature, and factory settings;
monitoring a performance of the water heater over a plurality of heating cycles based on the control of the electronic switch;
performing machine learning over the plurality of heating cycles based on the monitored performance to adjust the factory settings; and
controlling the electronic switch to modulate electrical power supplied to the heating element based on the adjusted factory settings.

73. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, the controller being configured to:
control the electronic switch to modulate electrical power supplied to the heating element based on inputs received from the temperature sensor and the set-point temperature, and
maintain the power supplied to the heating element via the electronic switch at a power level that ensures that the temperature of the thermal path does not exceed a threshold.

74. The water heater of claim 73, the controller being further configured to adjust the duty cycle of the power supplied to the heating element.

75. The water heater of claim 73, the controller being further configured to monitor secondary heat generated by the electronic switch.

76. A method of adjusting a water heater to heat water to a set-point temperature, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element based on inputs received from the temperature sensor and the set-point temperature, and
maintaining the power supplied to the heating element via the electronic switch at a power level that ensures that the temperature of the thermal path does not exceed a threshold.

77. A water heater configured to detect an underperforming or faulty heating element, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a thermal path temperature of the thermal path of the circuit board; and
a controller coupled to the temperature sensor and the electronic switch, the controller being configured to:
control the electronic switch to modulate electrical power supplied to the heating element, and
determine that the heating element is operating at a reduced capacity due to deterioration of the heating element when the thermal path temperature increases at a rate that is less than a predetermined rate of change threshold.

78. The water heater of claim 77, the controller being further configured to:
monitor secondary heat generated by the electronic switch, and determine that the heating element is operating at a reduced capacity based on a change in the secondary heat generated by the electronic switch.

79. A method of detecting an underperforming or faulty heating element in a water heater, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element; and
determining that the heating element is operating at a reduced capacity due to deterioration of the heating element when the thermal path temperature increases at a rate that is less than a predetermined rate of change threshold; or
determining that the heating element is operating at a reduced capacity due to deterioration of the heating element when a time that the thermal path temperature takes to reach a predetermined magnitude level is greater than a predetermined time threshold.

80. A water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board, thermally coupled to the thermal path of the circuit board, and electronically coupled to the heating element;
a temperature sensor positioned to sense a temperature of the thermal path of the circuit board; and
a controller coupled to the temperature sensor and the electronic switch, the controller being configured to:
control the electronic switch to modulate electrical power supplied to the heating element,
determine that the electronic switch is failed open or the heating element has failed when the temperature of the thermal path sensed by the temperature sensor does not increase a predetermined amount within a predetermined time after controlling the electronic switch to supply the electrical power to the heating element, thereby detecting failed operation of the electronic switch or the heating element, and
determine that the electronic switch is failed closed when the temperature of the thermal path sensed by the temperature sensor does not decrease the predetermined amount within the predetermined time after stopping controlling the electronic switch to supply the electrical power to the heating element, thereby detecting failed operation of the electronic switch.

81. The water heater of claim 80, the predetermined amount by which the temperature sensor increases or decreases being a predetermined temperature magnitude.

82. The water heater of claim 80, the predetermined amount by which the temperature sensor increases or decreases being a predetermined rate of temperature change.

83. A method of detecting an underperforming or faulty electronic switch in a water heater, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element,
determining that the electronic switch is failed open or the heating element has failed when the temperature of the thermal path sensed by the temperature sensor does not increase a predetermined amount within a predetermined time after controlling the electronic switch to supply the electrical power to the heating element, thereby detecting failed operation of the electronic switch or the heating element, and
determining that the electronic switch is failed closed when the temperature of the thermal path sensed by the temperature sensor does not decrease the predetermined amount within the predetermined time after stopping controlling the electronic switch to supply the electrical power to the heating element, thereby detecting failed operation of the electronic switch.

84. A water heater configured to heat water to a set-point temperature, the water heater comprising:
a tank configured to store water to be heated, the tank having a wall defining an interior;
a heating element mounted to the wall of the tank and extending into the interior of the tank;
a circuit board mounted to the wall of the tank, the circuit board including a thermal path extending through the circuit board;
an electronic switch mounted to the circuit board and electronically coupled to the heating element;
a temperature sensor positioned to sense a temperature of the thermal path of the circuit board; and
a controller coupled to the temperature sensor and the electronic switch, the controller being configured to:
control the electronic switch to modulate electrical power supplied to the heating element, and
determine that the thermal path is deteriorated when the sensed temperature of the thermal path exceeds a magnitude threshold or a rate of change threshold.

85. The water heater of claim 84, the controller being further configured to monitor secondary heat and determine that the thermal path is deteriorated when the secondary heat exceeds a magnitude threshold or a rate of change threshold.

86. A method of detecting underperformance in a water heater, the water heater having a heating element, a circuit board including a thermal path extending through the circuit board, an electronic switch mounted to the circuit board and electronically coupled to the heating element, a temperature sensor positioned to sense a temperature of the thermal path of the circuit board, and a controller coupled to the temperature sensor and the electronic switch, the method comprising:
controlling the electronic switch to modulate electrical power supplied to the heating element, and
determining that the thermal path is deteriorated when the sensed temperature of the thermal path exceeds a magnitude threshold or a rate of change threshold.

87. A water heater comprising:
a tank configured to store water to be heated, the tank having a wall defining an interior;
a circuit board mounted to the wall of the tank, the circuit board including a thermal path for conducting heat through the circuit board, the thermal path of the circuit board being thermally coupled to the wall of the tank such that primary heat from water in the tank is transferred from the wall of the tank to the thermal path;
a heating element mounted to the wall of the tank and extending into the interior of the tank;
an electronic switch mounted to the circuit board and electronically coupled to the heating element, the electronic switch being thermally coupled to the thermal path of the circuit board such that secondary heat generated by the electronic switch is transferred from the electronic switch through the thermal path of the circuit board, and to the wall of the tank;
a temperature sensor thermally coupled to the thermal path of circuit board, the temperature sensor being positioned to sense a temperature of the thermal path including the primary heat and the secondary heat; and
a controller electronically coupled to the temperature sensor, the controller being configured to receive the temperature of the thermal path from the temperature sensor and to differentiate the secondary heat from the primary heat.

88. The water heater of claim 87, the controller being further configured to differentiate the secondary heat from the primary heat based on a rate of change in the sensed temperature.

89. The water heater of claim 88, wherein the controller is further configured to:
identify the heat as primary heat when the rate of change of the sensed temperature is less than a rate of change threshold, and
identify the heat as secondary heat when the rate of change of the sensed temperature is greater than the rate of change threshold.

90. The water heater of claim 88, wherein the controller is further configured to determine the rate of change immediately after the heating element is turned ON, or immediately after the heating element is turned OFF.

91. The water heater of claim 87, the controller being further configured to differentiate the secondary heat from the primary heat based on whether or not a predetermined change in temperature occurs within a predetermined period of time.

92. The water heater of claim 87, the controller being further configured to differentiate the secondary heat from the primary heat based on whether or not a predetermined period of time elapses before a predetermined change in temperature occurs.

93. The water heater of claim 56, the controller being further configured to:
when the lower temperature sensor reaches a threshold at or below the set-point, and
when the upper temperature sensor increases at or above the set-point temperature, or when the upper temperature sensor reaches a threshold above the set-point,
then turn off the lower heating element.
